(19) United States
(12) Patent Application Publication
(10) Pub. No.: US 2013/0329008 A1
(43) Pub. Date: Dec. 12, 2013

(54) ENCODING APPARATUS, ENCODING METHOD, DECODING APPARATUS, AND DECODING METHOD

(71) Applicants: Yoshitomo Takahashi, Kanagawa (JP); Shinobu Hattori, Tokyo (JP)

(72) Inventors: Yoshitomo Takahashi, Kanagawa (JP); Shinobu Hattori, Tokyo (JP)

(73) Assignee: Sony Corporation, Tokyo (JP)

(21) Appl. No.: 13/884,026

(22) PCT Filed: Nov. 18, 2011
(86) PCT No.: PCT/JP11/76699

§ 371 Date: May 8, 2013

(30) Foreign Application Priority Data
Nov. 22, 2010 (JP) 2010-259943
Aug. 31, 2011 (JP) 2011-188816

(51) Int. Cl. H04N 13/00

(52) U.S. Cl. CPC H04N 13/0048
USPC 348/43

(57) ABSTRACT

There is provided an encoding apparatus including a setting unit configured to perform setting in a manner that encoding parameter used when encoding a color image of a multiview 3D image and a depth image of the multiview 3D image is shared in the color image and the depth image, and an encoding unit configured to encode the color image of the multiview 3D image and the depth image of the multiview 3D image by using the encoding parameter set by the setting unit.

### TECHNICAL FIELD

The present technology relates to an encoding apparatus, an encoding method, a decoding apparatus, and a decoding method, and more particularly, to an encoding apparatus, an encoding method, a decoding apparatus, and a decoding method, which are capable of improving coding efficiency of a multiview 3D image.

### BACKGROUND ART

Recently, as a method of encoding a multiview 3D image configured by a multiview color image and a depth image representing a disparity of the color image, a method of separately encoding a color image and a depth image has been proposed (see, for example, Patent Literature 1).

FIG. 1 is a block diagram illustrating an example of a configuration of an image processing system for encoding and decoding a multiview 3D image in this way.

The image processing system 10 of FIG. 1 includes a color image encoding apparatus 11, a depth image encoding apparatus 12, a multiplexing apparatus 13, a separating apparatus 14, a color image decoding apparatus 15, and a depth image decoding apparatus 16.

The color image encoding apparatus 11 of the image processing system 10 encodes a color image among multiview 3D images input to the image processing system 10 in accordance with a coding scheme, such as a multiview video coding (MVC) scheme, an advanced video coding (AVC) scheme, or the like. The color image encoding apparatus 11 supplies the multiplexing apparatus 13 with a bitstream obtained as a result of the encoding as a color image bitstream.

The depth image encoding apparatus 12 encodes a depth image among the multiview 3D images input to the image processing system 10 in accordance with a coding scheme, such as an MVC scheme, an AVC scheme, or the like. The depth image encoding apparatus 12 supplies the multiplexing apparatus 13 with a bitstream obtained as a result of the encoding as a depth image bitstream.

The multiplexing apparatus 13 multiplexes the color image bitstream supplied from the color image encoding apparatus 11 and the depth image bitstream supplied from the depth image encoding apparatus 12, and supplies a resultant multiplexed bitstream to the separating apparatus 14.

The separating apparatus 14 separates the multiplexed bitstream supplied from the multiplexing apparatus 13, and obtains the color image bitstream and the depth image bitstream. The separating apparatus 14 supplies the color image bitstream to the color image decoding apparatus 15, and supplies the depth image bitstream to the depth image decoding apparatus 16.

The color image decoding apparatus 15 decodes the color image bitstream supplied from the separating apparatus 14 in accordance with a scheme corresponding to the MVC scheme, the AVC scheme, or the like, and outputs a resultant multiview color image.

The depth image decoding apparatus 16 decodes the depth image bitstream supplied from the separating apparatus 14 in accordance with a scheme corresponding to the MVC scheme, the AVC scheme, or the like, and outputs a resultant multiview depth image.

### CITATION LIST

### Non-Patent Literature

Non-Patent Literature 1: INTERNATIONAL ORGANISATION FOR STANDARDISATION ORGANISATION INTERNATIONALE DE NORMALISATION ISO/IEC JTC1/SC29/WG11 CODING OF MOVING PICTURES AND AUDIO, Guangzhou, China, October 2010

### SUMMARY OF INVENTION

### Technical Problem

In the above-described method, since the color image and the depth image are independently encoded, coding parameters, such as a motion vector, cannot be shared between the color image and the depth image. Thus, coding efficiency is poor.

The present technology has been made in consideration of such circumstances, and is directed to improve coding efficiency of a multiview 3D image.

### Solution to Problem

An encoding apparatus according to a first aspect of the present invention includes a setting unit configured to perform setting in a manner that encoding parameter used when encoding a color image of a multiview 3D image and a depth image of the multiview 3D image is shared in the color image and the depth image, and an encoding unit configured to encode the color image of the multiview 3D image and the depth image of the multiview 3D image by using the encoding parameter set by the setting unit.

The encoding method according to the first aspect of the present technology corresponds to the encoding apparatus according to the first aspect of the present technology.

According to the first aspect of the present invention, encoding parameter used when encoding a color image of a multiview 3D image and a depth image of the multiview 3D image is set to be shared in the color image and the depth image. Using the encoding parameter, the color image of the multiview 3D image and the depth image of the multiview 3D image are encoded.

According to the second aspect of the present invention, there is provided a decoding apparatus including a reception unit configured to receive encoding parameter, which is set to be shared in a multiview color image and a multiview depth image, and is used when encoding the color image of the multiview 3D image and the depth image of the multiview 3D image, and an encoding stream in which the color image of the multiview 3D image and the depth image of the multiview 3D image are encoded, and a decoding unit configured to decode the encoding stream received by the reception unit by using the encoding parameter received by the reception unit.

According to the second aspect of the present technology, encoding parameter, which is set to be shared in a multiview color image and a multiview depth image and is used when encoding the color image of the multiview 3D image and the depth image of the multiview 3D image, and an encoding stream in which the color image of the multiview 3D image and the depth image of the multiview 3D image are encoded, are received, and the encoding stream is decoded by using the received encoding parameter.

Also, the encoding apparatus according to the first aspect and the decoding apparatus according to the second aspect can be realized by executing a program on a computer.

Also, the program executed on the computer in order to realize the encoding apparatus according to the first aspect and the decoding apparatus according to the second aspect can be provided by transmission through a transmission medium or can be provided by recoding on a recording medium.

Also, the encoding apparatus according to the first aspect and the decoding apparatus according to the second aspect may be independent apparatuses, or may be an internal block constituting one apparatus.

### Advantageous Effects of Invention

According to the first aspect of the present technology, the coding efficiency of the multiview 3D image can be improved.

Also, according to the second aspect of the present technology, it is possible to decode the encoding data of the multiview 3D image obtained by encoding, whose coding efficiency is improved.

### BRIEF DESCRIPTION OF DRAWINGS

FIG. 1 is a block diagram illustrating an example of a configuration of a conventional image processing system.

FIG. 2 is a block diagram illustrating a configuration example of a first embodiment of an encoding apparatus to which the present technology is applied.

FIG. 3 is a block diagram illustrating an example of a configuration of an image multiplexing unit of FIG. 2.

FIG. 4 is a conceptual diagram describing an example of multiplexing processing of the image multiplexing unit of FIG. 3.

FIG. 5 is a diagram describing an example of multiplexing processing on a YUV444 image.

FIG. 6 is a diagram describing an example of multiplexing processing on a YUV422 image.

FIG. 7 is a diagram describing an example of multiplexing processing on a YUV420 image.

FIG. 8 is a diagram illustrating an example of a description of multiplexing information.

FIG. 9 is a diagram illustrating an example of a description of multiplexing information when multiplexing processing is performed as described in FIGS. 4 to 7.

FIG. 10 is a flow chart describing encoding processing of the encoding apparatus of FIG. 2.

FIG. 11 is a flow chart describing details of the multiplexing processing of FIG. 10.

FIG. 12 is a block diagram illustrating an example of a configuration of a decoding apparatus.

FIG. 13 is a block diagram illustrating an example of a configuration of an image separation unit of FIG. 12.

FIG. 14 is a flow chart describing decoding processing of the decoding apparatus of FIG. 12.

FIG. 15 is a flow chart describing details of the separation processing of FIG. 14.

FIG. 16 is a block diagram illustrating an example of a configuration of a second embodiment of an encoding apparatus to which the present technology is applied.

FIG. 17 is a block diagram illustrating an example of a configuration of an image multiplexing unit of FIG. 16.

FIG. 18 is a diagram describing multiplexing processing of the screen multiplexing unit of FIG. 17.

FIG. 19 is a block diagram illustrating an example of a configuration of a decoding unit.

FIG. 20 is a block diagram illustrating an example of a configuration of an intra-screen prediction unit of FIG. 19.

FIG. 21 is a block diagram illustrating an example of a configuration of a motion compensation unit of FIG. 19.

FIG. 22 is a block diagram illustrating an example of a configuration of a lossless encoding unit of FIG. 19.

FIG. 23 is a diagram describing a significant coefficient flag when an optimal prediction mode is an optimal intra prediction mode.

FIG. 24 is a diagram describing a significant coefficient flag when an optimal prediction mode is an optimal inter prediction mode.

FIG. 25 is a diagram illustrating an example of a syntax related to coefficients.

FIG. 26 is a diagram illustrating an example of a syntax related to coefficients.

FIG. 27 is a diagram illustrating an example of a syntax related to coefficients.

FIG. 28 is a diagram illustrating an example of a syntax related to coefficients.

FIG. 29 is a flow chart describing encoding processing of the encoding apparatus of FIG. 16.

FIG. 30 is a flow chart describing details of multiplexing processing of FIG. 29.

FIG. 31 is a flow chart describing details of multiplexed image encoding processing of FIG. 29.

FIG. 32 is a flow chart describing details of the multiplexed image encoding processing of FIG. 29.

FIG. 33 is a flow chart describing details of intra-screen prediction processing of FIG. 31.

FIG. 34 is a flow chart describing details of motion compensation processing of FIG. 19.

FIG. 35 is a flow chart describing details of lossless encoding processing of FIG. 31.

FIG. 36 is a block diagram illustrating an example of a configuration of a decoding apparatus corresponding to the encoding apparatus of FIG. 16.

FIG. 37 is a block diagram illustrating an example of a configuration of a decoding unit.

FIG. 38 is a block diagram illustrating an example of a configuration of a lossless decoding unit of FIG. 37.

FIG. 39 is a block diagram illustrating an example of a configuration of an intra-screen prediction unit of FIG. 37.

FIG. 40 is a block diagram illustrating an example of a configuration of a motion compensation unit of FIG. 37.

FIG. 41 is a block diagram illustrating an example of a configuration of an image separation unit of FIG. 36.

FIG. 42 is a flow chart describing decoding processing of the decoding apparatus of FIG. 36.

FIG. 43 is a flow chart describing details of multiplexed image decoding processing of FIG. 42.

FIG. 44 is a flow chart describing details of lossless decoding processing of FIG. 43.

FIG. 45 is a flow chart describing details of separation processing of FIG. 42.

FIG. 46 is a block diagram illustrating an example of a configuration of a third embodiment of an encoding apparatus to which the present technology is applied.

FIG. 47 is a block diagram illustrating an example of a configuration of an encoding unit of FIG. 46.

FIG. 48 is a block diagram illustrating an example of a configuration of a depth encoding unit of FIG. 47.

FIG. 49 is a block diagram illustrating an example of a configuration of a generation unit of FIG. 46.

FIG. 50 is a diagram illustrating an example of a configuration of a multiview image encoding stream.

FIG. 51 is a diagram illustrating an example of type information.

FIG. 52 is a diagram illustrating an example of a syntax of SPS for depth image.

FIG. 53 is a diagram illustrating an example of a syntax of a slice header of a non-base image.

FIG. 54 is a diagram illustrating an example of a syntax of a slice header of a depth image.

FIG. 55 is a diagram illustrating an example of a syntax of an encoding stream.

FIG. 56 is a diagram illustrating an example of a syntax of luma-method significant coefficient information.

FIG. 57 is a diagram illustrating an example of a syntax of color-difference-method significant coefficient information.

FIG. 58 is a flow chart describing encoding processing of the encoding apparatus of FIG. 46.

FIG. 59 is a flow chart describing details of depth image encoding processing.

FIG. 60 is a flow chart describing details of depth image encoding processing.

FIG. 61 is a flow chart describing details of generation processing of FIG. 58.

FIG. 62 is a block diagram illustrating an example of a configuration of a decoding apparatus corresponding to the encoding apparatus of FIG. 46.

FIG. 63 is a block diagram illustrating an example of a configuration of a separation unit of FIG. 62.

FIG. 64 is a block diagram illustrating an example of a configuration of a decoding unit of FIG. 62.

FIG. 65 is a block diagram illustrating an example of a configuration of a depth decoding unit of FIG. 64.

FIG. 66 is a flow chart describing decoding processing of the decoding apparatus of FIG. 62.

FIG. 67 is a flow chart describing details of the separation processing of FIG. 66.

FIG. 68 is a flow chart describing details of depth decoding processing.

FIG. 69 is a diagram describing a decodable multiview image encoding stream.

FIG. 70 is a block diagram illustrating an example of a configuration of an embodiment of a computer.

FIG. 71 is a block diagram illustrating an example of a configuration of a television apparatus to which the present technology is applied.

FIG. 72 is a block diagram illustrating an example of a configuration of a mobile phone to which the present technology is applied.

FIG. 73 is a block diagram illustrating an example of a configuration of a recording/reproducing apparatus to which the present technology is applied.

FIG. 74 is a block diagram illustrating an example of a configuration of an image pickup apparatus to which the present technology is applied.

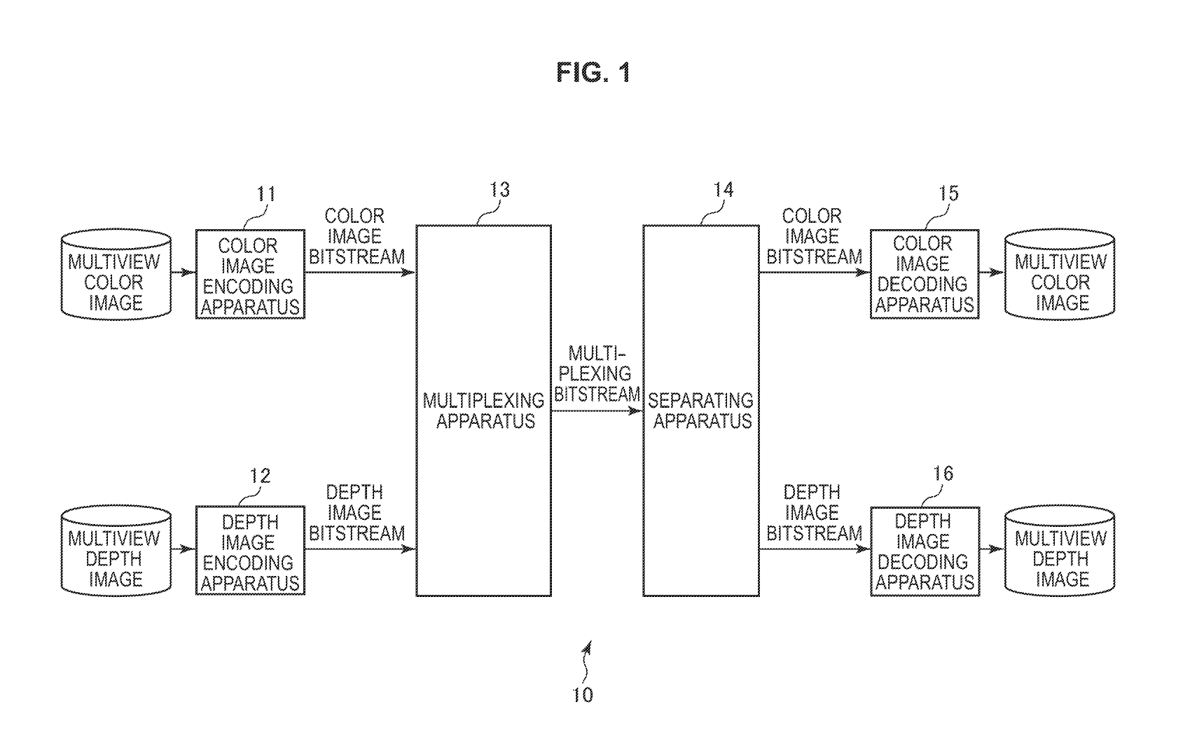

### DESCRIPTION OF EMBODIMENTS

### First Embodiment

[Configuration Example of First Embodiment of Encoding Apparatus]

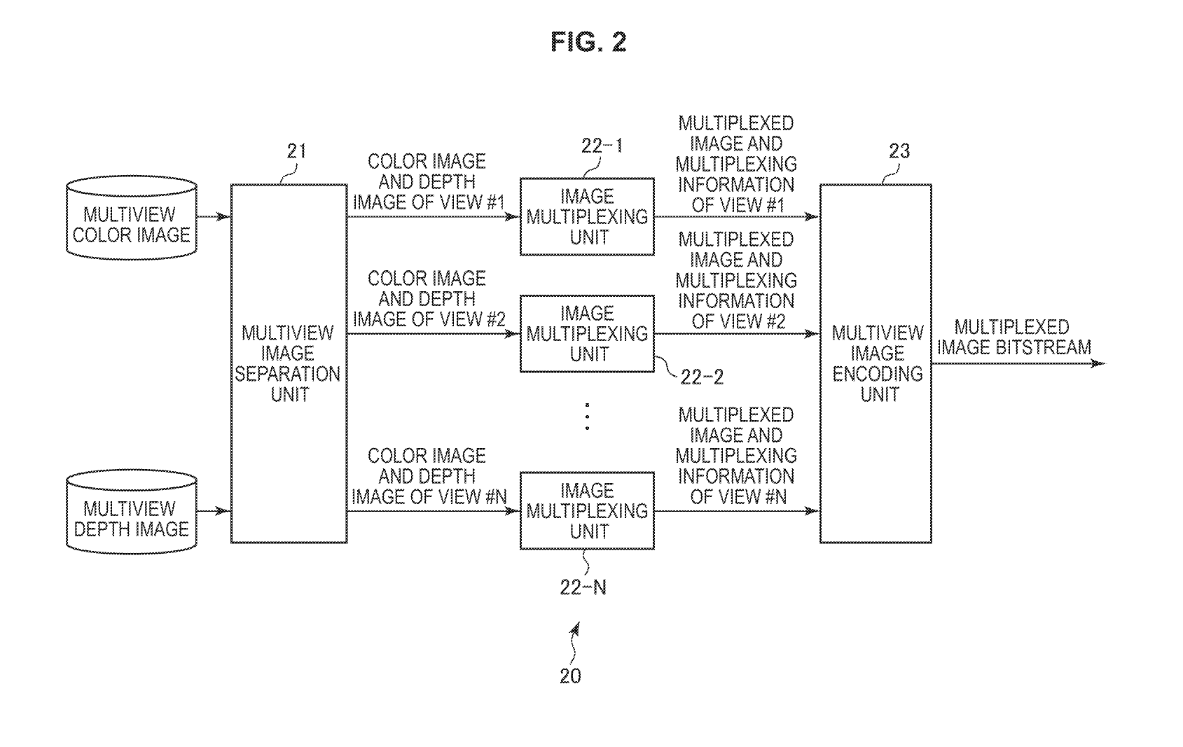

FIG. 2 is a block diagram illustrating an example of a configuration of a first embodiment of an encoding apparatus to which the present technology is applied.

The encoding apparatus 20 of FIG. 2 includes a multiview image separation unit 21, image multiplexing units 22-1 to 22-N (N is the number of views of a multiview 3D image, and in the present embodiment, N is an integer equal to or greater than 3), and a multiview image encoding unit 23. The encoding apparatus 20 encodes a multiview color image and a depth image configuring a multiview 3D image at each view.

Specifically, the multiview image separation unit 21 of the encoding apparatus 20 separates the multiview 3D image configured by the multiview color image and the depth image input to the encoding apparatus 20, and obtains the color image and the depth image of each view.

Also, the multiview image separation unit 21 supplies the color image and the depth image of each view to the image multiplexing units 22-1 to 22-N at each view. Specifically, the multiview image separation unit 21 supplies the color image and the depth image of view #1 being the first view to the image multiplexing unit 22-1. Subsequently, in the similar manner, the multiview image separation unit 21 supplies the color images and the depth images of views #2 to #N being the second to Nth views to the image multiplexing units 22-2 to 22-N at each view, respectively.

Each of the image multiplexing units 22-1 to 22-N performs multiplexing processing to multiplex the color image and the depth image supplied from the multiview image separation unit 21 into a single-screen image. Each of the image multiplexing units 22-1 to 22-N supplies the multiview image encoding unit 23 with the multiplexed image being the single-screen image of each view, which is obtained as a result of the multiplexing process, and multiplexing information being information related to the multiplexing process.

Also, in the following, when there is no particular need to distinguish the image multiplexing units 22-1 to 22-N, they will be collectively referred to as an image multiplexing unit 22.

The multiview image encoding unit 23 encodes the multiplexed image of each view and the multiplexing information, which are supplied from the image multiplexing unit 22, in accordance with a coding scheme, such as an MVC scheme or an AVC scheme. The multiview image encoding unit 23 functions as a transmitting unit, and outputs (transmits) the bitstream of each view, which is obtained as a result of the encoding, as the multiplexed image bitstream. Also, in the bitstream, coding parameter used for the encoding is added as a header.

[Configuration Example of Image Multiplexing Unit]

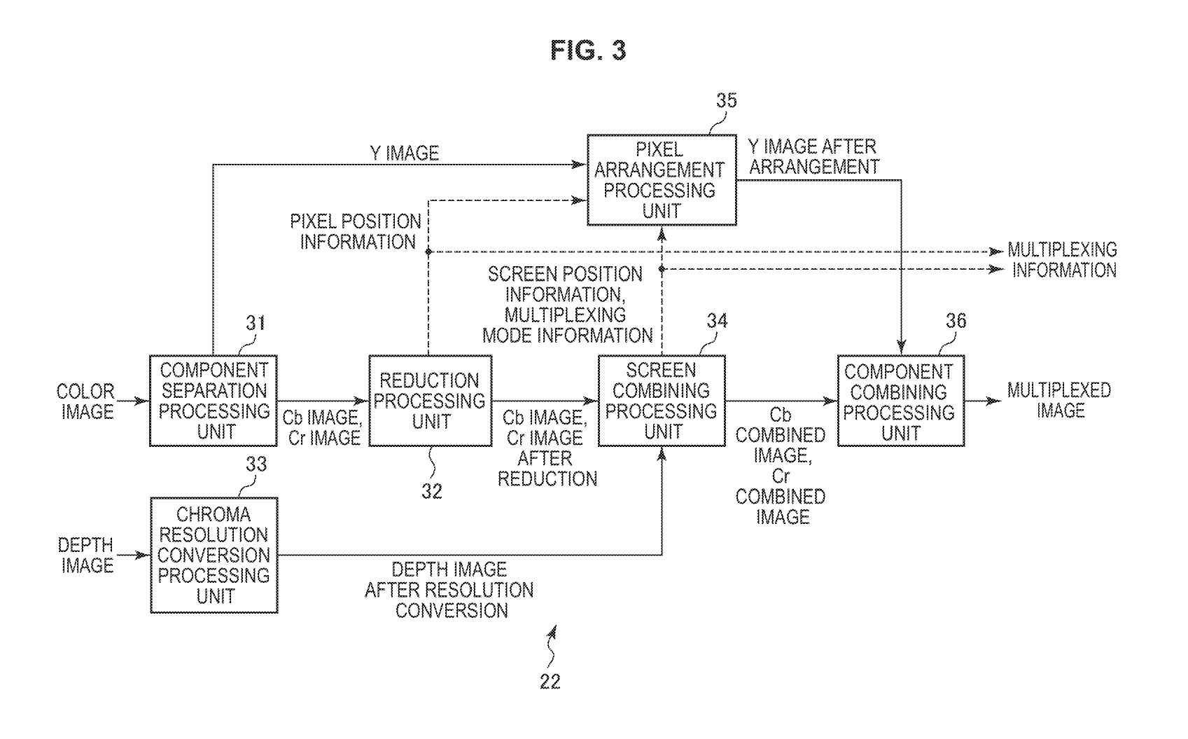

FIG. 3 is a block diagram illustrating an example of a configuration of the image multiplexing unit 22 of FIG. 2.

The image multiplexing unit 22 of FIG. 3 includes a component separation processing unit 31, a reduction processing unit 32, a chroma resolution conversion processing unit 33, a screen combining processing unit 34, a pixel arrangement processing unit 35, and a component combining processing unit 36. Also, in FIG. 3, a solid line indicates an image, and a dashed line indicates information.

The component separation processing unit 31 of the image multiplexing unit 22 separates a component of a color image of a predetermined view supplied from the multiview image separation unit 21 of FIG. 2, and obtains Y component, which is luma component of the color image, and Cb component and Cr component, which are chroma components of the color image. The component separation processing unit 31 supplies the Y component of the color image to the pixel arrangement processing unit 35 as a Y image. Also, the component separation processing unit 31 supplies the Cb component and the Cr component of the color image to the reduction processing unit 32 as a Cb image and a Cr image.

The reduction processing unit 32 reduces a horizontal or vertical resolution of the Cb image and the Cr image, which are supplied from the component separation processing unit 31, by ½ times. The reduction processing unit 32 supplies the after-reduction Cb image and Cr image to the screen combining processing unit 34. Also, the reduction processing unit 32 supplies the pixel arrangement processing unit 35 with pixel position information representing whether a before-reduction position of each pixel of the after-reduction Cb image and Cr image is a position of an odd-numbered pixel or a position of an odd-numbered pixel. Furthermore, the reduction processing unit 32 supplies the multiview image encoding unit 23 of FIG. 2 with the pixel position information as multiplexing information.

The chroma resolution conversion processing unit 33 performs conversion such that the resolution of the depth image of a predetermined view, which is supplied from the multiview image separation unit 21 of FIG. 2, becomes equal to the resolution of the Cb image and the Cr image. Also, in the present embodiment, the depth image input to the encoding apparatus 20 is assumed to have the same resolution as the Y image. The chroma resolution conversion processing unit 33 supplies the screen combining processing unit 34 with the after-resolution-conversion depth image.

The screen combining processing unit 34 multiplexes the after-reduction Cb image and Cr image supplied from the reduction processing unit 32 and the after-resolution-conversion depth image supplied from the chroma resolution conversion processing unit 33. Specifically, the screen combining processing unit 34 combines the image of the half area of the after-resolution-conversion depth image and the after-reduction Cb image, and sets the one-screen combined image of the same resolution as the resultant Cb image as the Cb combined image. Also, the screen combining processing unit 34 combines the image of the half area of the after-resolution-conversion depth image and the after-reduction Cr image, and sets the one-screen combined image of the same resolution as the resultant Cr image as the Cr combined image. The screen combining processing unit 34 supplies the component combining processing unit 36 with the Cb combined image and the Cr combined image.

Also, the screen combining processing unit 34 supplies the pixel arrangement processing unit 35 with screen position information representing a position of the after-reduction Cb image within the Cb combined image and a position of the after-reduction Cr image within the Cr combined image, and multiplexing scheme information representing a multiplexing scheme. Also, as the multiplexing scheme, there are a side-by-side scheme of arranging and combining a multiplexing target image in a left half area and a right half area of the screen, an over/under scheme of arranging and combining a multiplexing target image in an upper half area and a lower half area of the screen, and the like. Furthermore, the screen combining processing unit 34 supplies the multiview image encoding unit 23 of FIG. 2 with the screen position information and the multiplexing mode information as multiplexing information.

The pixel arrangement processing unit 35 arranges pixels of the Y image supplied from the component separation processing unit 31, based on the pixel position information supplied from the reduction processing unit 32 and the screen position information and the multiplexing mode information supplied from the screen combining processing unit 34. Specifically, the pixel arrangement processing unit 35 arranges each pixel of the Y image such that the position of each pixel of the Y image corresponds to the before-resolution-conversion position of each pixel of the Cb combined image and the Cr combined image, based the pixel position information, the screen position information, and the multiplexing mode information. The pixel arrangement processing unit 35 supplies the component combining processing unit 36 with the after-arrangement Y image.

The component combining processing unit 36 generates the multiplexed image by combining the after-arrangement Y image supplied from the pixel arrangement processing unit 35 and the Cb combined image and the Cr combined image supplied from the screen combining processing unit 34 as the Y component, the Cb component, and the Cr component of the multiplexed image, respectively. The component combining processing unit 36 supplies the multiview image encoding unit 23 of FIG. 2 with the multiplexed image.

[Description of Multiplexing]

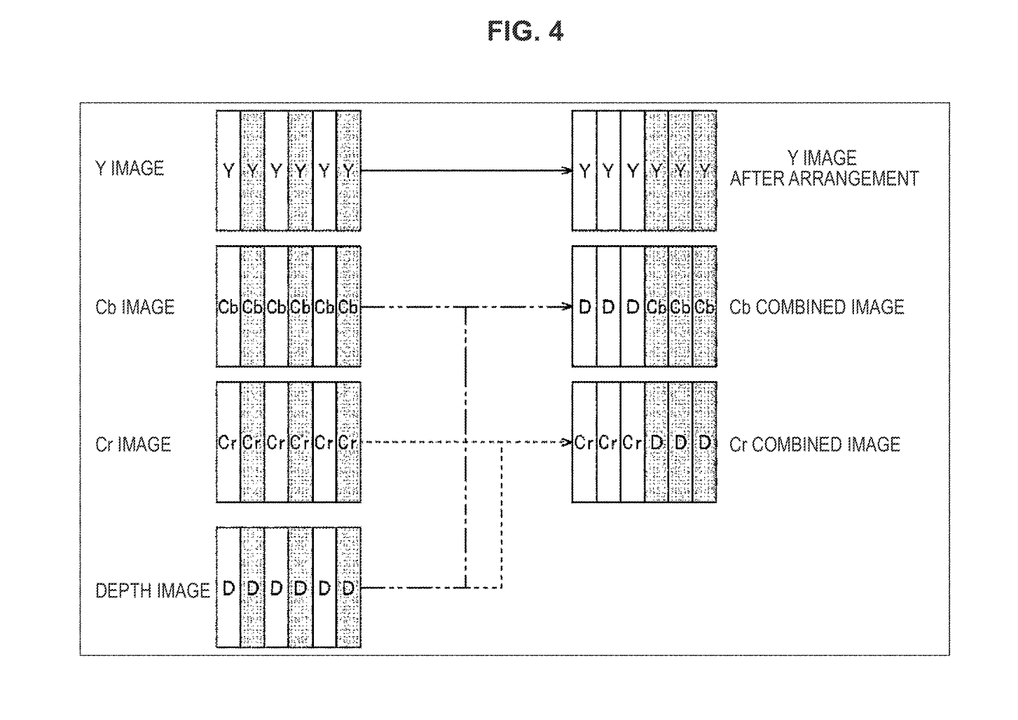

FIGS. 4 to 7 are diagrams describing an example of the multiplexing processing by the image multiplexing unit 22 of FIG. 3.

FIG. 4 is a conceptual diagram describing an example of the multiplexing processing by the image multiplexing unit 22 of FIG. 3.

Also, in FIG. 4, a white rectangle indicates a line of an even-numbered pixel, and a gray rectangle indicates a line of an odd-numbered pixel.

As illustrated in FIG. 4, in the Cb image obtained by the component separation processing unit 31, for example, only the odd-numbered pixels are left by the reduction processing unit 32 and the horizontal resolution is reduced by ½ times. On the other hand, in the Cr image obtained by the component separation processing unit 31, for example, only the even-numbered pixels are left by the reduction processing unit 32 and the horizontal resolution is reduced by ½ times. Also, the depth image is converted to have the same resolution as the Cb image and the Cr image by the chroma resolution conversion processing unit 33.

The synthesis is performed by the screen combining processing unit 34, for example, in such a manner that the even-numbered pixels of the after-resolution-conversion depth image are disposed in the left half area of the Cb combined image, and the Cb image configured by only the after-reduction odd-numbered pixels is disposed in the right half of the Cb combined image. Also, the synthesis is performed by the screen combining processing unit 34, for example, in such a manner that the odd-numbered pixels of the after-resolution-conversion depth image are disposed in the right half area of the Cr combined image, and the Cr image configured by only the after-reduction even-numbered pixels is disposed in the right half of the Cr combined image.

Also, the pixels of the Y image are arranged by the pixel arrangement processing unit 35, such that the even-numbered pixels of the Y image are disposed in the left half, based on positions of the even-numbered pixels, which are before-reduction positions of the respective pixels of the after-reduction Cr image, and the left half, which is positions within the Cr combined image where the after-reduction Cr image is disposed. Furthermore, the pixels of the Y image are arranged by the pixel arrangement processing unit 35, such that the odd-numbered pixels of the Y image are disposed in the right half, based on positions of odd-numbered pixels, which are before-reduction positions of the respective pixels of the after-reduction Cb image, and the right half, which is positions within the Cb combined image where the after-reduction Cb image is disposed.

The multiplexed image is generated by the component combining processing unit 36 in such a manner that the after-arrangement Y image, Cb combined image, and Cr combined image are combined as components.

By performing the multiplexing in the above manner, the Y component and the Cr component of the even-numbered pixel of the color image and the even-numbered pixel of the after-resolution-conversion depth image are disposed in the left half of the multiplexed image, and the Y component and the Cb component of the odd-numbered pixel of the color image and the odd-numbered pixel of the after-resolution-conversion depth image are disposed in the right half.

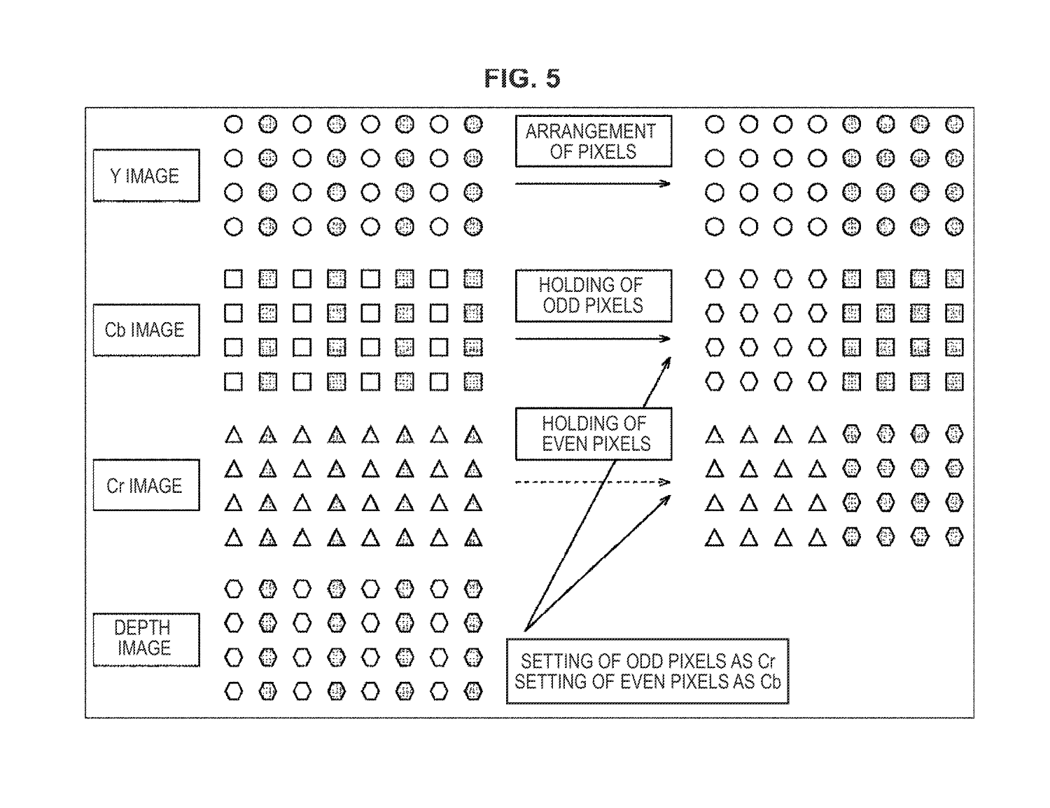

FIG. 5 is a diagram describing an example of multiplexing processing when the color image of each view is a so-called YUV444 image.

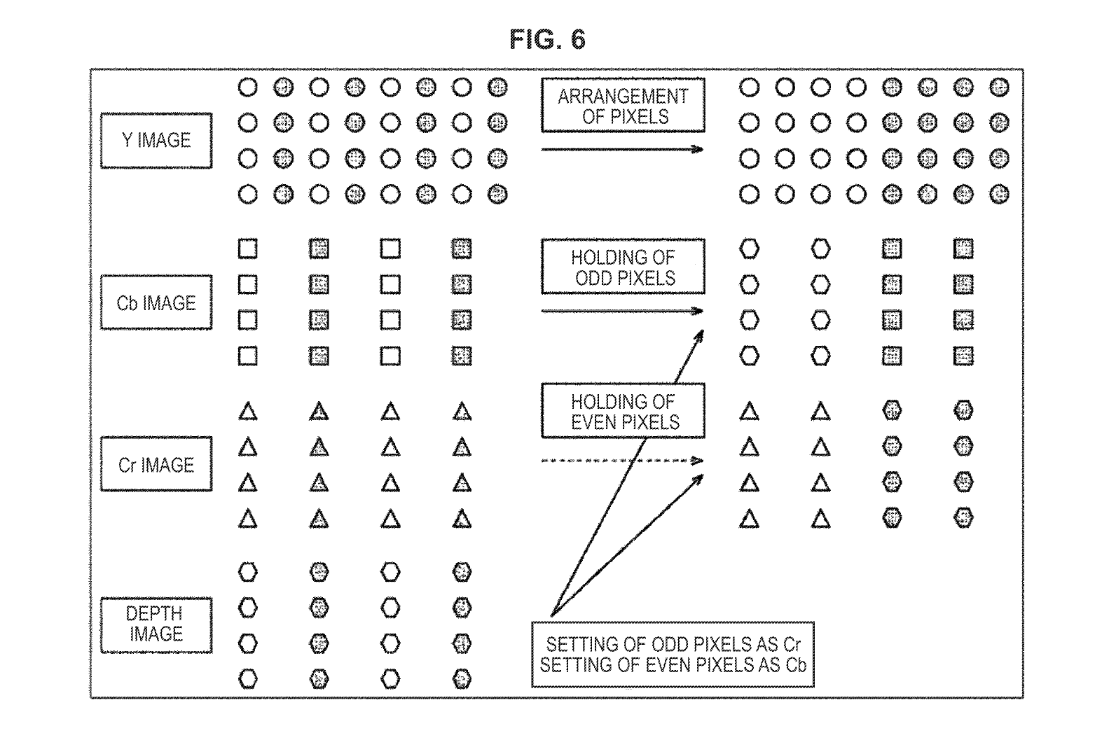

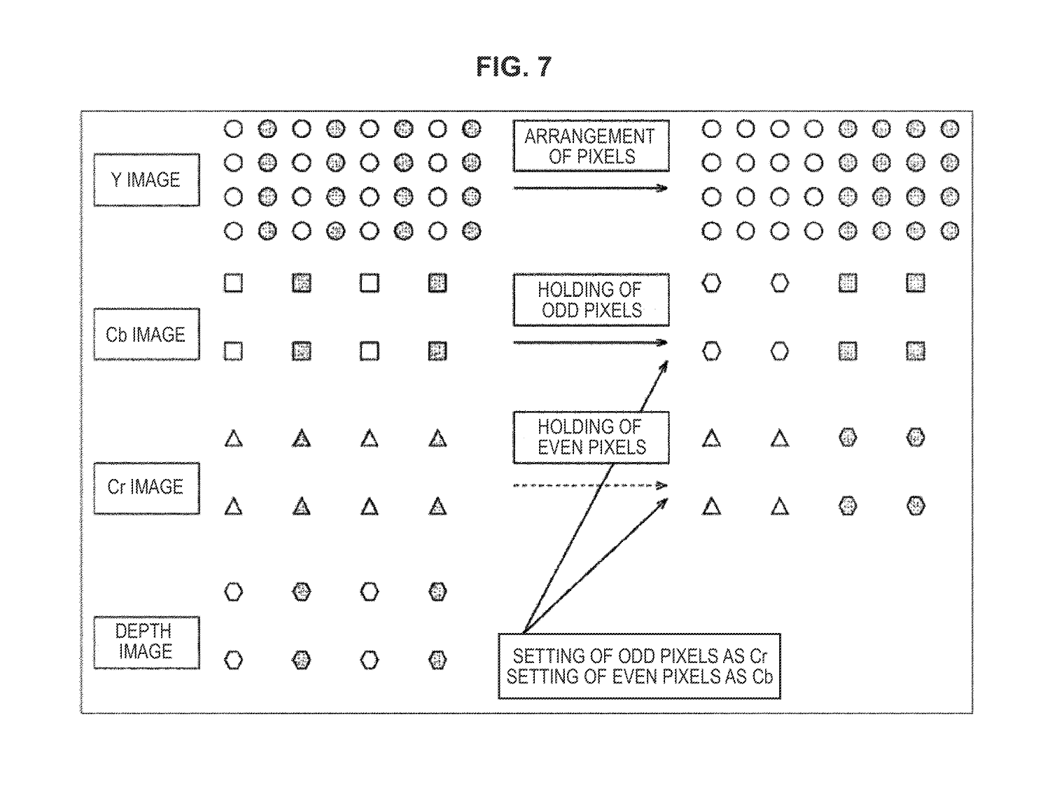

Also, in FIG. 5, a white circle, rectangle, triangle, and hexagon represent even-numbered pixels, and a gray circle, rectangle, triangle, and hexagon represent odd-numbered pixels. This is the same as in FIGS. 6 and 7, which are to be described below.

In the example of FIG. 5, since the color image is the so-called YUV444 image, the resolutions of the Y component, the Cb component, and the Cr component of the color image are all equal to one another.

In this case, as illustrated in FIG. 5, in the Cb image of the color image, for example, only the odd-numbered pixels are left and the horizontal resolution is reduced by ½ times, as described in FIG. 4. On the other hand, in the Cr image of the color image, for example, only the even-numbered pixels are left and the horizontal resolution is reduced by ½ times. Also, in the present embodiment, since the resolution of the depth image input to the encoding apparatus 20 is equal to the resolution of the Y image, it is the same resolution as the Cb image and the Cr image in the case of FIG. 5, and the resolution of the depth image is not changed.

As described in FIG. 4, the synthesis is performed, for example, in such a manner that the even-numbered pixels of the after-resolution-conversion depth image are disposed in the left half area of the Cb combined image, and the Cb image configured by only the after-reduction odd-numbered pixels are disposed in the right half of the Cb combined image. Also, the synthesis is performed, for example, in such a manner that the odd-numbered pixels of the after-resolution-conversion depth image are disposed in the right half area of the Cr combined image, and the Cr image configured by only the after-reduction even-numbered pixels is disposed in the right half of the Cr combined image.

Also, as described in FIG. 4, the pixels of the Y image are arranged such that the even-numbered pixels of the Y image are disposed in the left half, based on positions of the even-numbered pixels, which are before-reduction positions of the respective pixels of the after-reduction Cr image, and the left half, which is positions within the Cr combined image where the after-reduction Cr image is disposed. Furthermore, the pixels of the Y image are arranged such that the odd-numbered pixels of the Y image are disposed in the right half, based on positions of the odd-numbered pixels, which are before-reduction positions of the respective pixels of the after-reduction Cb image, and the right half, which is positions within the Cb combined image where the after-reduction Cb image is disposed.

The multiplexed image is generated in such a manner that the after-arrangement Y image, Cb combined image, and Cr combined image are combined as components. Also, the horizontal and vertical resolutions of the after-arrangement Y image, Cb combined image, and Cr combined image are equal to one another, and the multiplexed image is the so-called YUV444 image.

FIG. 6 is a diagram describing an example of multiplexing processing when the color image of each view is a so-called YUV422 image.

In the example of FIG. 6, since the color image is the so-called YUV422 image, the horizontal resolutions of the Cb component and the Cr component of the color image are ½ times the horizontal resolution of the Y component. Therefore, the horizontal resolution of the depth image is reduced by ½ times.

In this case, since the multiplexing is identical to the case of FIG. 5, except that the horizontal resolutions of the Cb image, the Cr image, and the after-resolution-conversion depth image are ½ times the horizontal resolution of the Y image, a description thereof will be omitted. Also, the horizontal resolutions of the Cb combined image and the Cr combined image are ½ times the horizontal resolution of the after-arrangement Y image, and the multiplexed image is the so-called YUV422 image.

FIG. 7 is a diagram describing an example of multiplexing processing when the color image of each view is a so-called YUV420 image.

In the example of FIG. 7, since the color image is the so-called YUV420 image, the horizontal and vertical resolutions of the Cb component and the Cr component of the color image are ½ times the horizontal and vertical resolutions of the Y component. Therefore, each of the horizontal and vertical resolutions of the depth image is reduced by ½ times.

In this case, since the multiplexing is identical to the case of FIG. 5, except that the horizontal and vertical resolutions of the Cb image, the Cr image, and the after-resolution-conversion depth image are ½ times the horizontal and vertical resolutions of the Y image, respectively, a description thereof will be omitted. Also, the horizontal resolutions of the Cb combined image and the Cr combined image are ½ times the horizontal and vertical resolutions of the after-arrangement Y image, and the multiplexed image is the so-called YUV420 image.

Also, when the color image is the so-called YUV420 image, the image multiplexing unit 22 may perform the synthesis by disposing the Cb image and the Cr image in the upper half of the screen and disposing the after-resolution-conversion depth image in the lower half of the screen, without reducing the horizontal resolutions of the Cb image and the Cr image by ½ times. In this case, the multiplexed image becomes the so-called YUV422 image.

Also, when the color image is the so-called YUV422 or YUV420 image, the position relationship among the pixel of the Y component and the pixels of the Cb component and the Cr component in the multiplexed image is identical to the position relationship among the pixel of the Y image and the pixels of the Cb image and the Cr image in the even-numbered pixels, but is different in the odd-numbered pixels. Therefore, the image multiplexing unit 22 may correct the positions of the respective pixels of the Y component, the Cb component, and the Cr component of the multiplexed image, such that the position relationship among the pixel of the Y component and the pixels of the Cb component and the Cr component in the multiplexed image becomes identical to the position relationship between the pixel of the Y image and the pixels of the Cb image and the Cr image in all pixels. In this case, for example, a flag representing that the pixel position of the multiplexed image has been corrected is included in the multiplexing information and is transmitted to the decoding apparatus, and the decoding apparatus restores the pixel position of the multiplexed image.

[Example of Description of Multiplexing Information]

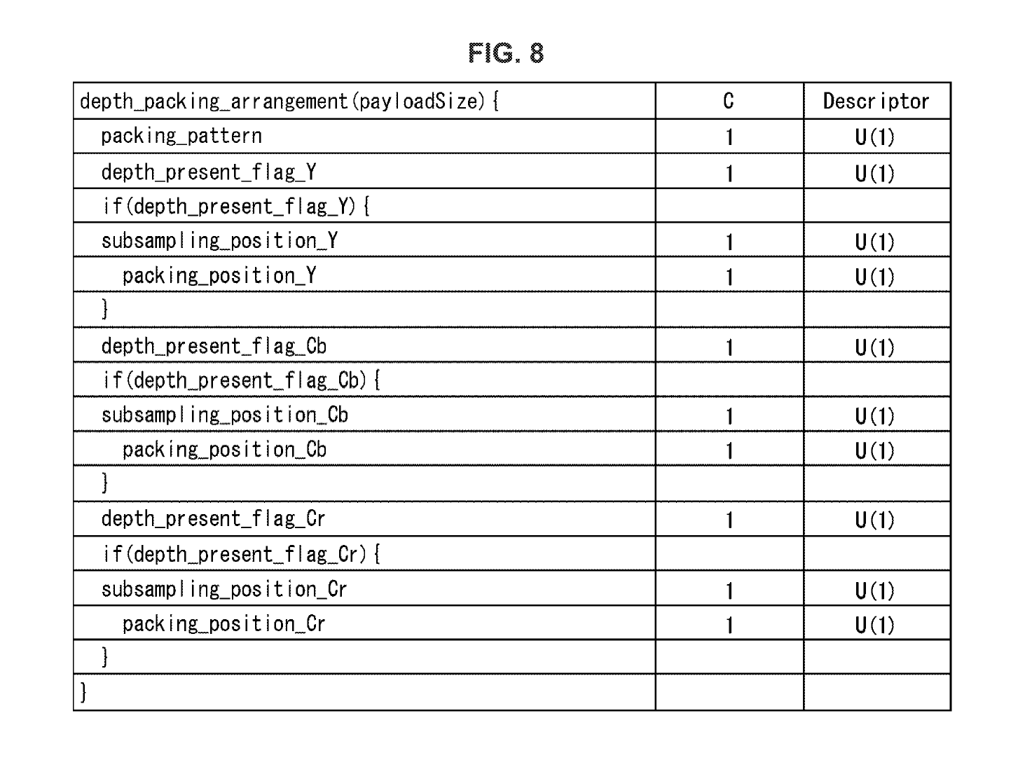

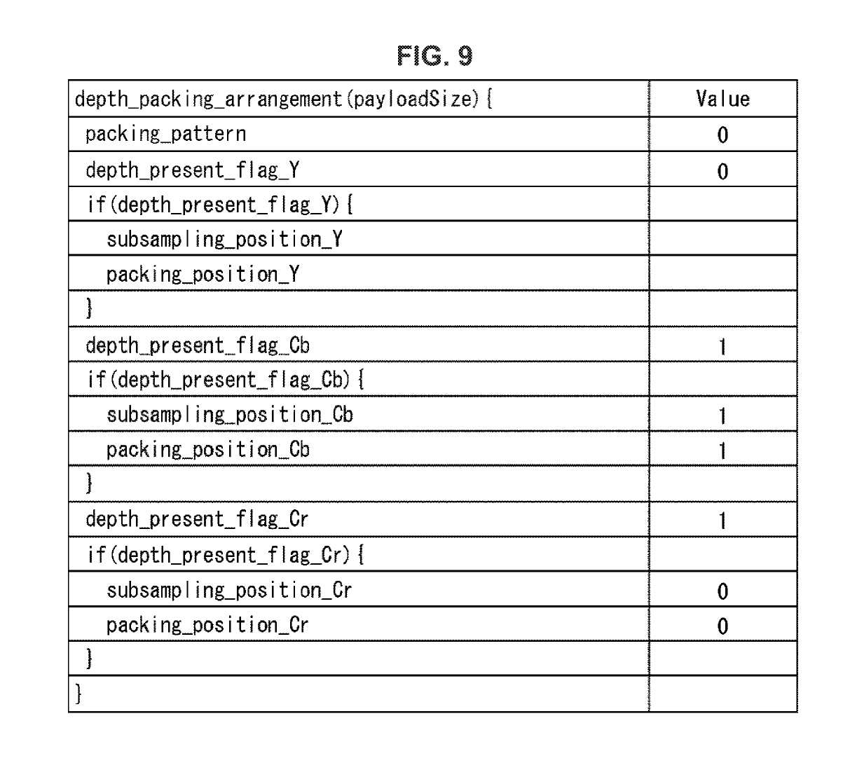

FIGS. 8 and 9 are diagrams illustrating examples of description of multiplexing information when the multiplexed image and the multiplexing information are encoded in accordance with the MVC scheme or the AVC scheme.

As illustrated in FIG. 8, when the multiplexed image and the multiplexing information are encoded in accordance with the MVC scheme or the AVC scheme, for example, Supplemental Enhancement Information (SEI) is provided for description of the multiplexing information.

In the SEI provided for the description of the multiplexing information, 1-bit multiplexing mode information (packing_pattern) is described. The multiplexing mode information is 0 when representing a side-by-side mode and is 1 when representing an over/under mode.

In the SEI provided for the description of the multiplexing information, a 1-bit depth image flag (depth_present_flag), 1-bit pixel position information (subsampling_position), and 1-bit screen position information (packing_position) for each of the Y image, the Cb image, and the Cr image are also described. The depth image flag is a flag that represents whether the depth image is combined. When the depth image is not combined, 0 is described as the depth image flag, and when the depth image is combined, 1 is described as the depth image flag.

In the present embodiment, since the depth image is not combined in the Y image, 0 is described as the depth image flag (depth_present_flag_Y) for the Y image. Also, since the depth image is not combined in the Cb image and the Cr image, 1 is described as the depth image flag (depth_present_flag_Cb) for the Cb image and the depth image flag (depth_present_flag_Cr) for the Cr image.

Also, the pixel position information is 0 when representing that the before-reduction position of each after-reduction pixel is the position of the even-numbered pixel and is 1 when representing that before-reduction position of each after-reduction pixel is the position of the odd-numbered pixel. The screen position information is 0 when representing the left half or upper half area and is 1 when representing the right half or lower half area.

As a result, for example, when the multiplexing processing is performed as described in FIGS. 4 to 7, the SEI provided for the description of the multiplexing information is illustrated in FIG. 9.

Specifically, in the multiplexing processing described in FIGS. 4 to 7, since the depth image is disposed in the left half area of the Cb combined image and the right half area of the Cr combined image, 0 representing the side-by-side mode is described as the multiplexing mode information, as illustrated in FIG. 9. Also, since the depth image is not combined in the Y image, 0 is described as the depth image flag (depth_present_flag_Y) for the Y image, and nothing is described in the pixel position information (subsampling_position_Y) for the Y image and the screen position information (packing_position_Y) for the Y image.

Also, since the depth image is combined in the Cb image and the Cr image, 1 is described as the depth image flag (depth_present_flag_Cb) for the Cb image and the depth image flag (depth_present_flag_Cr) for the Cr image. Also, in the Cb image, the odd-numbered pixel is left at the time of reduction, and the position of the after-reduction Cb image within the Cb combined image is the right half area. Therefore, 1 is described as the pixel position information (subsampling_position_Cb) for the Cb image and the screen position information (packing_position_Cb) for the Cb image.

On the other hand, in the Cr image, the even-numbered pixel is left at the time of reduction, and the position of the after-reduction Cr image within the Cr combined image is the left half area. Therefore, 0 is described as the pixel position information (subsampling_position_Cr) for the Cr image and the screen position information (packing_position_Cr) for the Cr image.

[Description of Processing of Encoding Apparatus]

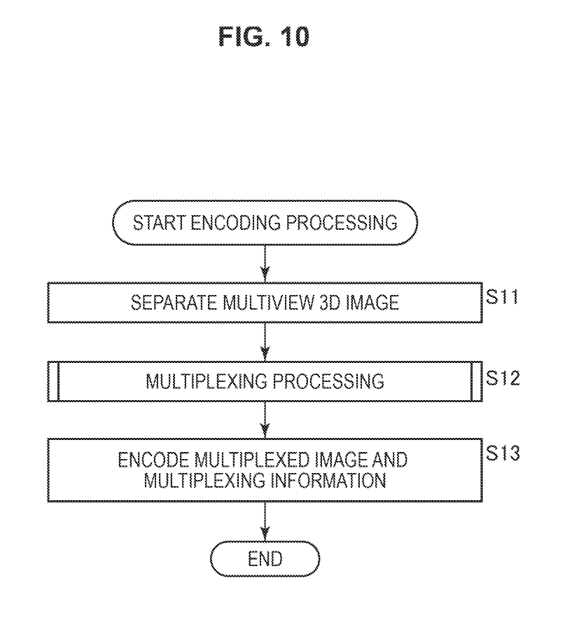

FIG. 10 is a flow chart describing encoding processing by the encoding apparatus 20 of FIG. 2. The encoding processing is started, for example, when the multiview 3D image is input to the encoding apparatus 20.

In step S11 of FIG. 10, the multiview image separation unit 21 of the encoding apparatus 20 separates the multiview 3D image input to the encoding apparatus 20, and obtains the color image and the depth image of each view. The multiview image separation unit 21 supplies the image multiplexing unit 22 with the color image and the depth image of each view at each view.

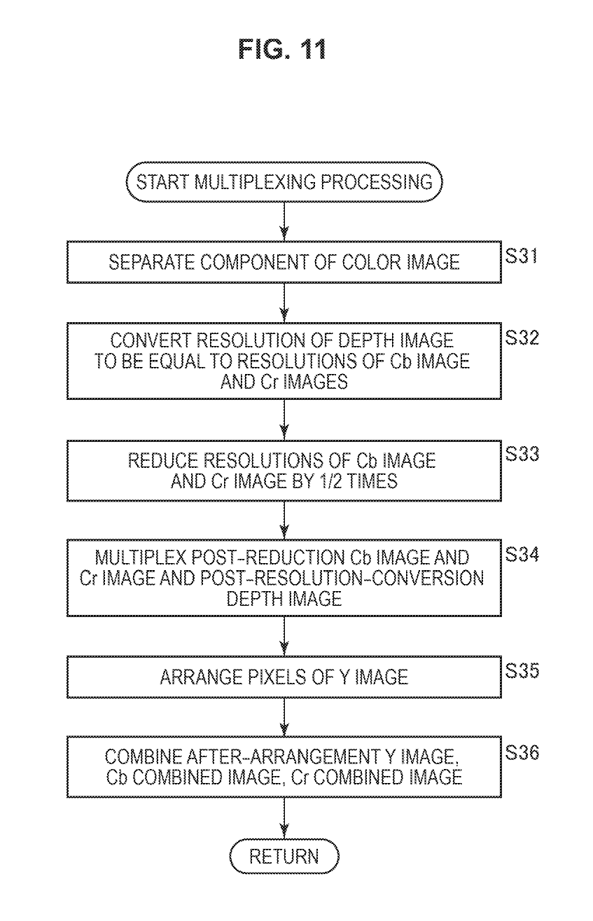

In step S12, the image multiplexing unit 22 performs the multiplexing process. Details of the multiplexing processing will be described below with reference to FIG. 11. The image multiplexing unit 22 supplies the multiview image encoding unit 23 with the multiplexed image and the multiplexing information of each view, which are obtained as a result of the multiplexing process.

In step S13, the multiview image encoding unit 23 encodes the multiplexed image of each view and the multiplexing information, which are supplied from the image multiplexing unit 22, in accordance with the coding scheme, such as the MVC scheme or the AVC scheme.

The multiview image encoding unit 23 outputs the resultant bitstream as the multiplexed image bitstream, and ends the processing.

FIG. 11 is a flow chart describing details of the multiplexing processing of step S12 of FIG. 10.

In step S31 of FIG. 11, the component separation processing unit 31 of the image multiplexing unit 22 (FIG. 3) separates the component of the color image of a predetermined view, which is supplied from the multiview image separation unit 21 of FIG. 2, and obtains the Y component, the Cb component, and the Cr component. The component separation processing unit 31 supplies the pixel arrangement processing unit 35 with the Y component of the color image as the Y image. Also, the component separation processing unit 31 supplies the reduction processing unit 32 with the Cb component and the Cr component of the color image as the Cb image and the Cr image.

In step S32, the chroma resolution conversion processing unit 33 performs conversion such that the resolution of the depth image of a predetermined view, which is supplied from the multiview image separation unit 21 of FIG. 2, becomes equal to the resolutions of the Cb image and the Cr image. The chroma resolution conversion processing unit 33 supplies the screen combining processing unit 34 with the after-resolution-conversion depth image.

In step S33, the reduction processing unit 32 reduces the horizontal or vertical resolution of the Cb image and the Cr image, which are supplied from the component separation processing unit 31, by ½ times. The reduction processing unit 32 supplies the screen combining processing unit 34 with the after-reduction Cb image and Cr image. Also, the reduction processing unit 32 supplies the pixel arrangement processing unit 35 with the pixel position information, and also supplies the multiview image encoding unit 23 of FIG. 2 with the pixel position information as the multiplexing information.

In step S34, the screen combining processing unit 34 multiplexes the after-reduction Cb image and Cr image, which are supplied from the reduction processing unit 32, and the after-resolution-conversion depth image, which is supplied from the chroma resolution conversion processing unit 33. The screen combining processing unit 34 supplies the component combining processing unit 36 with the resultant Cb combined image and Cr combined image. Also, the screen combining processing unit 34 supplies the pixel arrangement processing unit 35 with the screen position information and the multiplexing mode information, and also supplies the multiview image encoding unit 23 of FIG. 2 with the screen position information and the multiplexing mode information as the multiplexing information.

In step S35, the pixel arrangement processing unit 35 arranges the pixels of the Y image supplied from the component separation processing unit 31, based on the pixel position information supplied from the reduction processing unit 32 and the screen position information and the multiplexing mode information supplied from the screen combining processing unit 34. The pixel arrangement processing unit 35 supplies the component combining processing unit 36 with the after-arrangement Y image.

In step S36, the component combining processing unit 36 combines the after-arrangement Y image supplied from the pixel arrangement processing unit 35 and the Cb combined image and the Cr combined image supplied from the screen combining processing unit 34 as the Y component, the Cb component, and the Cr component of the multiplexed image, respectively, and generates the multiplexed image. The component combining processing unit 36 supplies the multiview image encoding unit 23 of FIG. 2 with the generated multiplexed image. Then, the processing returns to step S12 of FIG. 10, and the processing proceeds to step S13.

As described above, since the encoding apparatus 20 performs encoding by multiplexing the Cb image, the Cr image, and the depth image to one screen, encoding parameters, such as a motion vector, a Coded Block Pattern (CBP), and an encoding mode, can be shared between the color image and the depth image. As a result, encoding efficiency is improved.

Specifically, for example, in the encoding such as the AVC mode, it is assumed that there is a correlation between the motion vectors of the Y component and the Cb component and Cr component of the color image, and only the motion vector of the Y component is detected. The motion vector is set to be shared in the Y component and the Cb component and Cr component, and is transmitted to the decoding apparatus. Therefore, when the encoding apparatus 20 performs the encoding such as the AVC mode, the encoding apparatus 20 has only to detect the motion vector of the Y component alone of the multiplexed image and transmit the motion vector to the decoding apparatus. Therefore, encoding efficiency is improved. On the other hand, when the color image and the depth image are separately encoded as in the prior art, it is necessary to detect the motion vectors of the Y component of the color image and the depth image and transmit the motion vectors to the decoding apparatus.

Also, in the case where the multiview 3D image is an image in which a depth-direction position of a still image or an image of an object shifted in parallel with respect to a camera is not relatively changed, the correlation between the motion vectors of the color image and the depth image is strong. Therefore, encoding efficiency is further improved.

Moreover, the encoding apparatus 20 also encodes the multiplexing information together with the multiplexed image. Therefore, in the decoding apparatus, which is to be described below, the Cb image and Cr image and the depth image can be accurately separated, based on the multiplexing information.

Also, in the image multiplexing unit 22, any variation may be provided in the resolutions of the Cb image and Cr image and the depth image as long as the resolution of the Y image is equal to or greater than the resolutions of the Cb combined image and Cr combined image, and the resolution of the after-resolution-conversion depth image within the Cb combined image and Cr combined image is equal to or greater than the resolutions of the after-reduction Cb image and Cr image.

[Example of Configuration of Decoding Apparatus]

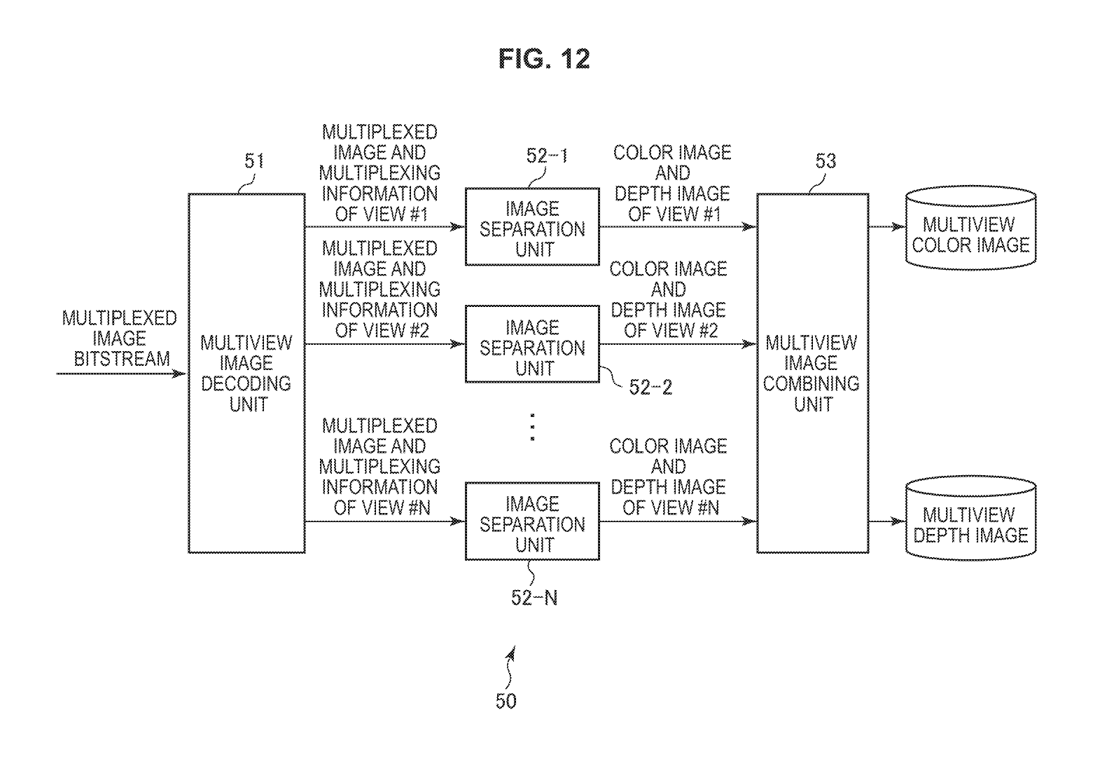

FIG. 12 is a block diagram illustrating an example of a configuration of a decoding apparatus that decodes the multiplexed image bitstream output by the encoding apparatus 20 of FIG. 2.

The decoding apparatus 50 of FIG. 12 includes a multiview image decoding unit 51, image separation units 52-1 to 52-N, and a multiview image synthesis unit 53. The decoding apparatus 50 decodes the multiplexed image bitstream output by the encoding apparatus 20 at each view.

Specifically, the multiview image decoding unit 51 of the decoding apparatus 50 functions as a receiving unit to receive the multiplexed image bitstream transmitted from the encoding apparatus 20. The multiview image decoding unit 51 decodes the multiplexed image bitstream at each view in accordance with the scheme corresponding to the MVC scheme, the AVC scheme, or the like by using the encoding parameters added as the header of the multiplexed image bitstream. The multiview image decoding unit 51 supplies the image separation units 52-1 to 52-N with the multiplexed image and the multiplexing information of each view, which are obtained as a result of the decoding. Specifically, the multiview image decoding unit 51 supplies the image separation unit 52-1 with the multiplexed image and the multiplexing information of view #1. Subsequently, in the similar manner, the multiview image decoding unit 51 supplies the image separation units 52-2 to 52-N with the multiplexed images of views #2 to #N and the multiplexing information at each view, respectively.

Each of the image separation units 52-1 to 52-N performs the separation processing to separate the multiplexed image into the color image and the depth image, based on the multiplexing information supplied from the multiview image decoding unit 51. Each of the image separation units 52-1 to 52-N supplies the multiview image synthesis unit 53 with the color image and the depth image of each view, which are obtained as a result of the separation processing.

Also, in the following, when there is no particular need to distinguish the image separation units 52-1 to 52-N, they will be collectively referred to as the image separation unit 52.

The multiview image synthesis unit 53 combines the color image of each view supplied from the image separation unit 52, and generates the multiview color image. Also, the multiview image synthesis unit 53 combines the depth image of each view supplied from the image separation unit 52, and generates the multiview depth image. The multiview image synthesis unit 53 outputs the multiview color image and the multiview depth image as the multiview 3D image.

[Example of Configuration of Image Separation Unit]

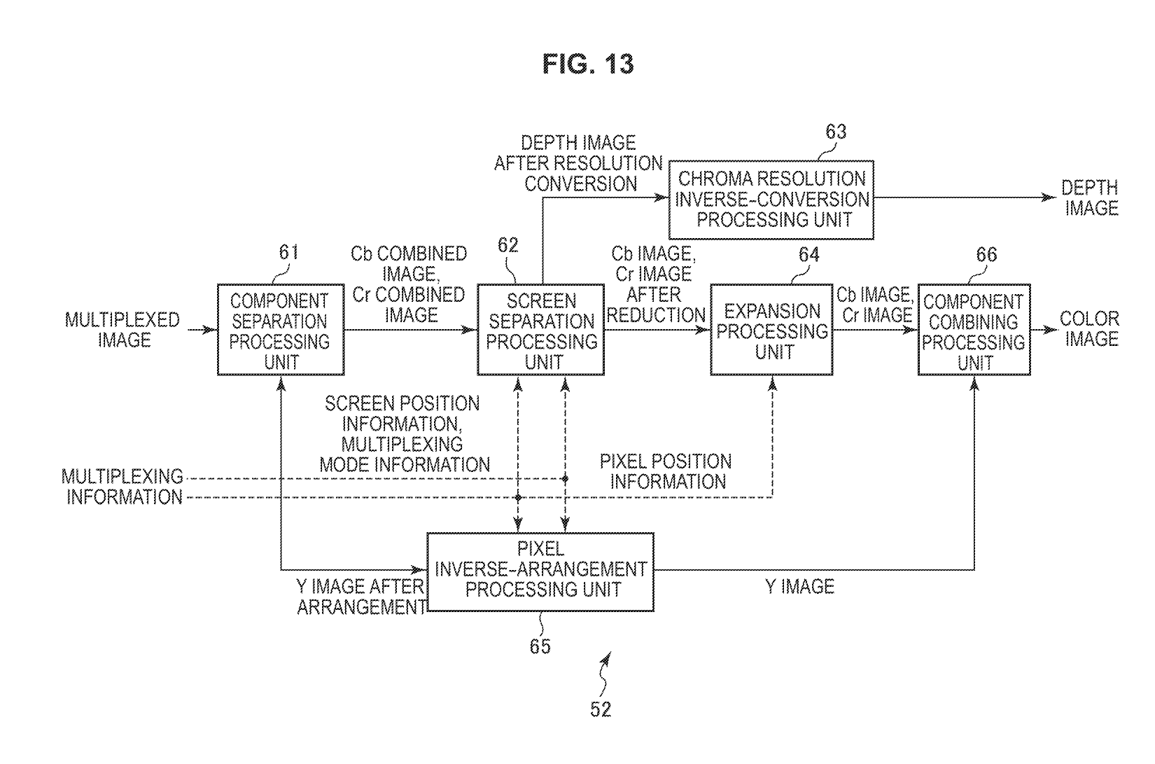

FIG. 13 is a block diagram illustrating an example of a configuration of the image separation unit 52 of FIG. 12.

The image separation unit 52 of FIG. 13 includes a component separation processing unit 61, a screen separation processing unit 62, a chroma resolution inverse-conversion processing unit 63, an expansion processing unit 64, a pixel inverse-arrangement processing unit 65, and a component combining processing unit 66. Also, in FIG. 13, a solid line indicates an image, and a dashed line indicates information.

The component separation processing unit 61 of the image separation unit 52 separates the components of the multiplexed image supplied from the multiview image decoding unit 51 of FIG. 12, and obtains the Y component, the Cb component, and the Cr component of the multiplexed image. The component separation processing unit 61 supplies the pixel inverse-arrangement processing unit 65 with the after-arrangement Y image that is the Y component of the multiplexed image. Also, the component separation processing unit 61 supplies the screen separation processing unit 62 with the Cb combined image, which is the Cb component of the multiplexed image, and the Cr combined image, which is the Cr component of the multiplexed image.

The screen separation processing unit 62 separates the after-reduction Cb image and the half-area image of the after-resolution-conversion depth image from the Cb combined image supplied from the component separation processing unit 61, based on the screen position information and the multiplexing mode information among the multiplexing information supplied from the multiview image decoding unit 51 of FIG. 12. Also, the screen separation processing unit 62 separates the after-reduction Cr image and the half area image of the after-resolution-conversion depth image from the Cr combined image supplied from the component separation processing unit 61, based on the screen position information and the multiplexing mode information.

For example, as illustrated in FIG. 9, when the multiplexing mode information represents the side-by-side mode and the screen position information for the Cb image is 1, the screen position information represents the right half area. Therefore, the screen separation processing unit 62 separates the left half area of the Cb combined image as the half area image of the after-resolution-conversion depth image, and separates the right half area as the after-reduction Cb image. Also, as illustrated in FIG. 9, when the multiplexing mode information represents the side-by-side mode and the screen position information for the Cr image is 0, the screen position information represents the left half area. Therefore, the screen separation processing unit 62 separates the right half area of the Cr combined image as the half area image of the after-resolution-conversion depth image, and separates the left half area as the after-reduction Cr image.

Also, the screen separation processing unit 62 combines the half area images of the separated after-resolution-conversion depth image, based on the pixel position information among the multiplexing information.

For example, as illustrated in FIG. 9, when the pixel position information for the Cb image represents that the before-reduction position of each pixel of the after-reduction Cb image is the position of the odd-numbered pixel, the screen separation processing unit 62 arranges each pixel of the half area image of the after-resolution-conversion depth image, which is separated from the Cb combined image, as the even-numbered pixel of the after-resolution-conversion depth image. Also, when the pixel position information for the Cr image represents that the before-reduction position of each pixel of the after-reduction Cr image is the position of the even-numbered pixel, the screen separation processing unit 62 arranges each pixel of the half area image of the after-resolution-conversion depth image, which is separated from the Cr combined image, as the odd-numbered pixel of the after-resolution-conversion depth image. In this manner, the after-resolution-conversion depth image is generated.

The screen separation processing unit 62 supplies the chroma resolution inverse-conversion processing unit 63 with the generated after-resolution-conversion depth image. Also, the screen separation processing unit 62 supplies the expansion processing unit 64 with the separated after-reduction Cb image and Cr image.

Also, when the entire area images of the after-resolution-conversion depth image are arranged within the Cb combined image and the Cr combined image, for example, as described above, when the color image is the YUV420 image and the multiplexed image is the YUV422 image, the screen separation processing unit 62 supplies the chroma resolution inverse-conversion processing unit 63 with one of the after-resolution-conversion depth images separated from the Cb combined image and the Cr combined image.

The chroma resolution inverse-conversion processing unit 63 converts the resolution of the after-resolution-conversion depth image, which is supplied from the screen separation processing unit 62, to be equal to the resolution of the before-encoding depth image, that is, the resolution of the Y image. For example, when the color image is the so-called YUV420 image, the chroma resolution inverse-conversion processing unit 63 expands each of the horizontal and vertical resolutions of the after-resolution-conversion depth image by two times. The chroma resolution inverse-conversion processing unit 63 supplies the multiview image synthesis unit 53 of FIG. 12 with the depth image, the resolution of which is returned to the before-encoding resolution as a result of the resolution conversion.

The expansion processing unit 64 expands the after-reduction Cb image and Cr image supplied from the screen separation processing unit 62, based on the pixel position information among the multiplexing information supplied from the multiview image decoding unit 51 of FIG. 12.

For example, as illustrated in FIG. 9, when the pixel position information for the Cb image represents that the before-reduction position of each pixel of the after-reduction Cb image is the position of the odd-numbered pixel, the expansion processing unit 64 expands the horizontal and vertical resolutions by 2 times by interpolation performed in a state of setting each pixel of the after-reduction Cb image as the odd-numbered pixel of the after-expansion Cb image. Also, as illustrated in FIG. 9, when the pixel position information for the Cr image represents that the before-reduction position of each pixel of the after-reduction Cr image is the position of the even-numbered pixel, the expansion processing unit 64 expands the horizontal and vertical resolutions by 2 times by interpolation performed in a state of setting each pixel of the after-reduction Cr image as the even-numbered pixel of the after-expansion Cr image. The expansion processing unit 64 supplies the component combining processing unit 66 with the Cb image and Cr image, which are obtained as a result of the expansion.

The pixel inverse-arrangement processing unit 65 functions as a pixel arranging unit and restores the position of each pixel of the after-arrangement Y image supplied from the component separation processing unit 61, based on the multiplexing information supplied from the multiview image decoding unit 51 of FIG. 12.

For example, as illustrated in FIG. 9, when the multiplexing mode information represents the side-by-side mode and the screen position information for the Cb image is 1, the screen position information represents the right half area. Therefore, as illustrated in FIG. 9, when the pixel position information for the Cb image represents that the before-reduction position of each pixel of the after-reduction Cb image is the position of the odd-numbered pixel, the pixel inverse-arrangement processing unit 65 arranges the pixels of the right half area of the after-arrangement Y image as the odd-numbered pixels of the original Y image.

Also, as illustrated in FIG. 9, when the multiplexing mode information represents the side-by-side mode and the screen position information for the Cr image is 0, the screen position information represents the left half area. Therefore, as illustrated in FIG. 9, when the pixel position information for the Cr image represents that the before-reduction position of each pixel of the after-reduction Cr image is the position of the even-numbered pixel, the pixel inverse-arrangement processing unit 65 arranges the pixels of the left half area of the after-arrangement Y image as the even-numbered pixels of the original Y image. In the above manner, the position of each pixel of the after-arrangement Y image is returned to the position of each pixel of the before-arrangement Y image. The pixel inverse-arrangement processing unit 65 supplies the component combining processing unit 66 with the Y image, the position of each pixel of which is restored.

The component combining processing unit 66 combines the Y image supplied from the pixel inverse-arrangement processing unit 65 and the Cb image and Cr image supplied from the expansion processing unit 64 as the Y component, the Cb component, and the Cr component of the color image, and obtains the color image. The component combining processing unit 66 supplies the multiview image synthesis unit 53 of FIG. 12 with the obtained color image.

[Description of Processing of Decoding Apparatus]

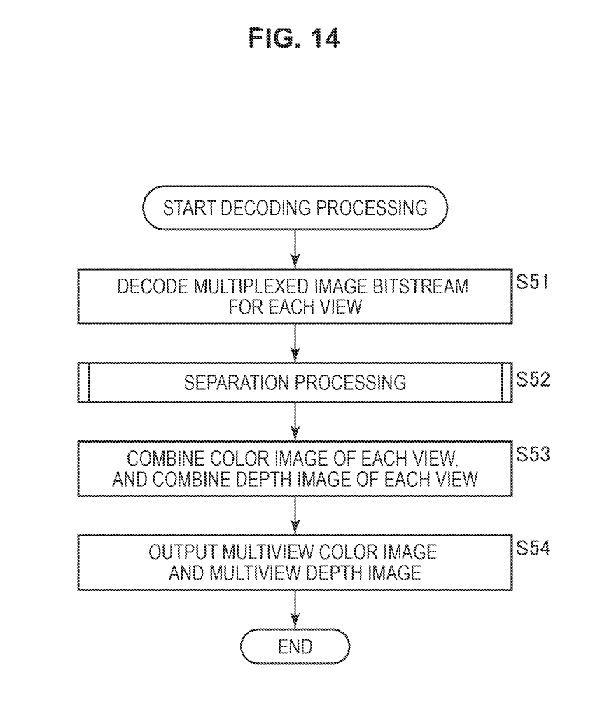

FIG. 14 is a flow chart describing decoding processing by the decoding apparatus 50 of FIG. 12. The decoding processing is started, for example, when the multiplexed image bitstream is input from the encoding apparatus 20 of FIG. 2.

In step S51 of FIG. 14, the multiview image decoding unit 51 of the decoding apparatus 50 decodes the multiplexed image bitstream input from the encoding apparatus 20 for each view in accordance with the scheme corresponding to the MVC scheme, the AVC scheme, or the like. The multiview image decoding unit 51 supplies the image separation units 52-1 to 52-N with the multiplexed image and the multiplexing information of each view, which are obtained as a result of the decoding.

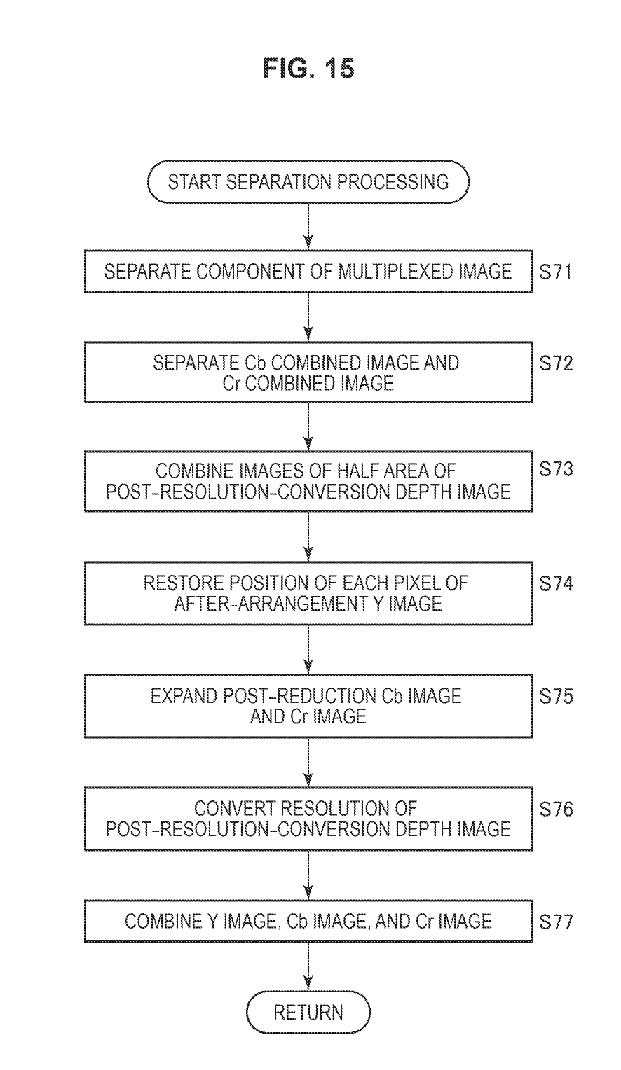

In step S52, the image separation unit 52 performs the separation processing to separate the multiplexed image into the color image and the depth image, based on the multiplexing information supplied from the multiview image decoding unit 51. Details of the separation processing will be described below with reference to FIG. 15. The image separation unit 52 supplies the multiview image synthesis unit 53 with the color image and the depth image, which are obtained as a result of the separating process.

In step S53, the multiview image synthesis unit 53 combines the color image of each view supplied from the image separation unit 52, and combines the depth image of each view supplied from the image separation unit 52.

In step S54, the multiview image synthesis unit 53 outputs the multiview color image and the multiview depth image, which are obtained as a result of the synthesis, as the multiview 3D image, and ends the processing.

FIG. 15 is a flow chart describing details of the separation processing step S52 of FIG. 14.

In step S71 of FIG. 15, the component separation processing unit 61 of the image separation unit 52 separates the components of the multiplexed image supplied from the multiview image decoding unit 51 of FIG. 12, and obtains the Y component, the Cb component, and the Cr component of the multiplexed image. The component separation processing unit 61 supplies the pixel inverse-arrangement processing unit 65 with the after-arrangement Y image that is the Y component of the multiplexed image. Also, the component separation processing unit 61 supplies the screen separation processing unit 62 with the Cb combined image, which is the Cb component of the multiplexed image, and the Cr combined image, which is the Cr component of the multiplexed image.

In step S72, the screen separation processing unit 62 separates the Cb combined image and the Cr combined image supplied from the component separation processing unit 61, based on the screen position information and the multiplexing mode information among the multiplexing information supplied from the multiview image decoding unit 51 of FIG. 12. The screen separation processing unit 62 supplies the expansion processing unit 64 with the after-reduction Cb image obtained by separating the Cb combined image and the Cr image obtained by separating the Cr combined image.

In step S73, the screen separation processing unit 62 combines, based on the pixel position information, the half area image of the after-resolution-conversion depth image obtained by separating the Cb combined image and the half area image of the after-resolution-conversion depth image obtained by separating the Cr combined image. In this manner, the after-resolution-conversion depth image is generated. The screen separation processing unit 62 supplies the chroma resolution inverse-conversion processing unit 63 with the generated after-resolution-conversion depth image.

In step S74, the pixel inverse-arrangement processing unit 65 restores the position of each pixel of the after-arrangement Y image supplied from the component separation processing unit 61, based on the multiplexing information supplied from the multiview image decoding unit 51 of FIG. 12. The pixel inverse-arrangement processing unit 65 supplies the component combining processing unit 66 with the Y image, the position of each pixel of which is restored.

In step S75, the expansion processing unit 64 expands the after-reduction Cb image and Cr image supplied from the screen separation processing unit 62, based on the pixel position information among the multiplexing information supplied from the multiview image decoding unit 51 of FIG. 12. The expansion processing unit 64 supplies the component combining processing unit 66 with the Cb image and Cr image, which are obtained as a result of the expansion.

In step S76, the chroma resolution inverse-conversion processing unit 63 converts the resolution of the after-resolution-conversion depth image, supplied from the screen separation processing unit 62, to be equal to the resolution of the before-encoding depth image, that is, the resolution of the Y image. The chroma resolution inverse-conversion processing unit 63 supplies the multiview image synthesis unit 53 of FIG. 12 with the depth image, the resolution of which is restored to the before-encoding resolution as a result of the resolution conversion.

In step S77, the component combining processing unit 66 combines the Y image supplied from the pixel inverse-arrangement processing unit 65 and the Cb image and Cr image supplied from the expansion processing unit 64 as the Y component, the Cb component, and the Cr component of the color image, and obtains the color image. The component combining processing unit 66 supplies the multiview image synthesis unit 53 of FIG. 12 with the obtained color image. Then, the processing returns to step S52 of FIG. 14, and the processing proceeds to step S53.

In this manner, the decoding apparatus 50 can decode the multiplexed image bitstream obtained by the encoding that improves the encoding efficiency, by performing encoding by multiplexing the Cb image, the Cr image, and the depth image to one screen. Also, in the multiplexed image bitstream, since the Cb image, the Cr image, and the depth image are encoded by multiplexing to one screen, the decoding apparatus 50 has only to include one multiview image decoding unit 51 in order to decode the multiview 3D image.

On the contrary, the conventional image processing system 10, which separately encodes the color image and the depth image, needs to include two decoding apparatuses: the color image decoding apparatus 15 for decoding the color image, and the depth image decoding apparatus 16 for decoding the depth image. Since the decoded color image and depth image are often used in display or the like at the same time, it is difficult to separately decode both of the color image and the depth image by one decoding apparatus.

Also, in the present embodiment, the depth image is multiplexed into the Cb image and the Cr image, but the depth image may also be multiplexed into one of the Y image, the Cb image, and the Cr image.

### Second Embodiment

[Example of Configuration of Encoding Apparatus]

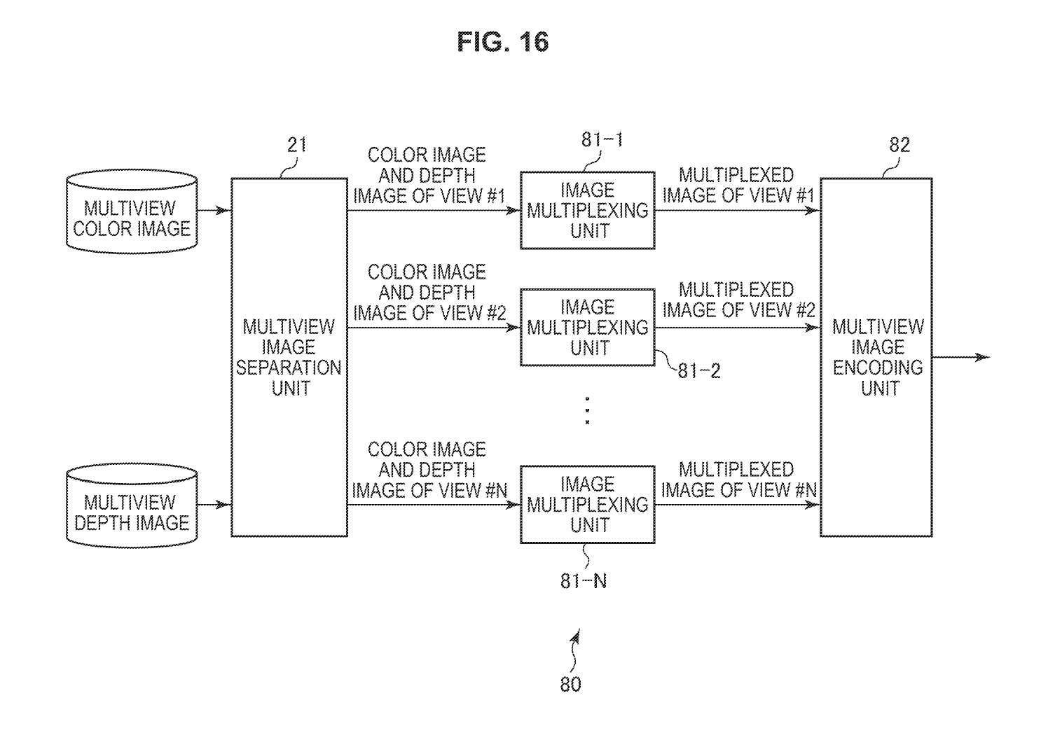

FIG. 16 is a block diagram illustrating an example of a configuration of a second embodiment of an encoding apparatus to which the present technology is applied.

In the configuration illustrated in FIG. 16, the same reference numerals are assigned to the same configuration as that of FIG. 2. A redundant description will be appropriately omitted.

The configuration of the encoding apparatus 80 of FIG. 16 is different from the configuration of FIG. 2 in that, instead of the image multiplexing units 22-1 to 22-N and the multiview image encoding unit 23, image multiplexing units 81-1 to 81-N (N is the number of views of the multiview 3D image, and in the present embodiment, N is an integer equal to or greater than 3), and a multiview image encoding unit 82 are provided. The encoding apparatus 80 encodes a luma component and a chroma component of a color image, and a depth image as components of a multiplexed image.

Specifically, each of the image multiplexing units 81-1 to 81-N of the encoding apparatus 80 performs a resolution conversion on the depth image from the multiview image separation unit 21. Each of the image multiplexing units 81-1 to 81-N performs multiplexing processing on the luma component and chroma component of the color image from the multiview image separation unit 21 and the resolution-converted depth image, which are set as each component of the multiplexed image. Each of the image multiplexing unit 81-1 to 81-N supplies the multiview image encoding unit 82 with the multiplexed image obtained as a result of the multiplexing processing.

Also, in the following, when there is no particular need to distinguish the image multiplexing units 81-1 to 81-N, they will be collectively referred to as the image multiplexing unit 81.

The multiview image encoding unit 82 encodes the multiplexed image of each view, which is supplied from the image multiplexing unit 81, in accordance with a coding scheme corresponding to a High Efficiency Video Coding (HEVC) scheme or the like. The multiview image encoding unit 82 outputs the resultant encoding stream (bitstream) of each view as the multiplexed image encoding stream.

Also, regarding the HEVC scheme, as of August 2011, “WD3: Working Draft3 of High-Efficiency Video Coding”, JCTVC-E603_d5 (version5), by Thomas Wiegand, Woo-jin Han, Benjamin Bross, Jens-Rainer Ohm, and Gary J. Sullivian, was issued as draft on May 20, 2011.

[Example of Configuration of Image Multiplexing Unit]

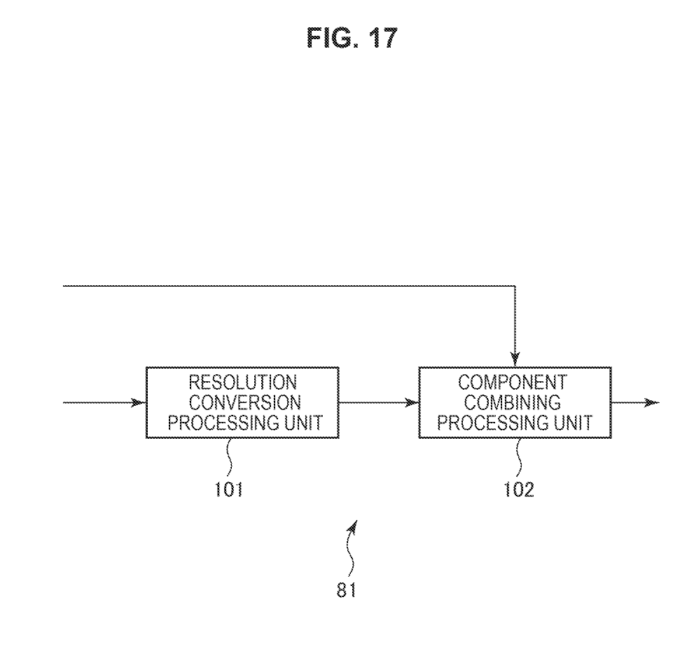

FIG. 17 is a block diagram illustrating an example of a configuration of the image multiplexing unit 81 of FIG. 16.

The image multiplexing unit 81 of FIG. 17 includes a resolution conversion processing unit 101 and a component combining processing unit 102.

The resolution conversion processing unit 101 of the image multiplexing unit 81 performs conversion such that the resolution of the depth image of a predetermined view, which is supplied from the multiview image separation unit 21 of FIG. 16, becomes equal to the resolutions of the Cb component and the Cr component of the color image. The resolution conversion processing unit 101 supplies the component combining processing unit 102 with the after-resolution-conversion depth image.

The component combining processing unit 102 generates the multiplexed image by combining the luma component and the chroma component of the color image of a predetermined view from the multiview image separation unit 21 and the after-resolution-conversion depth image from the resolution conversion processing unit 101, respectively, as the luma component, the chroma component, and the depth component of the multiplexed image. The component combining processing unit 102 supplies the multiview image encoding unit 82 of FIG. 2 with the multiplexed image.

[Description of Processing of Screen Multiplexing Unit]

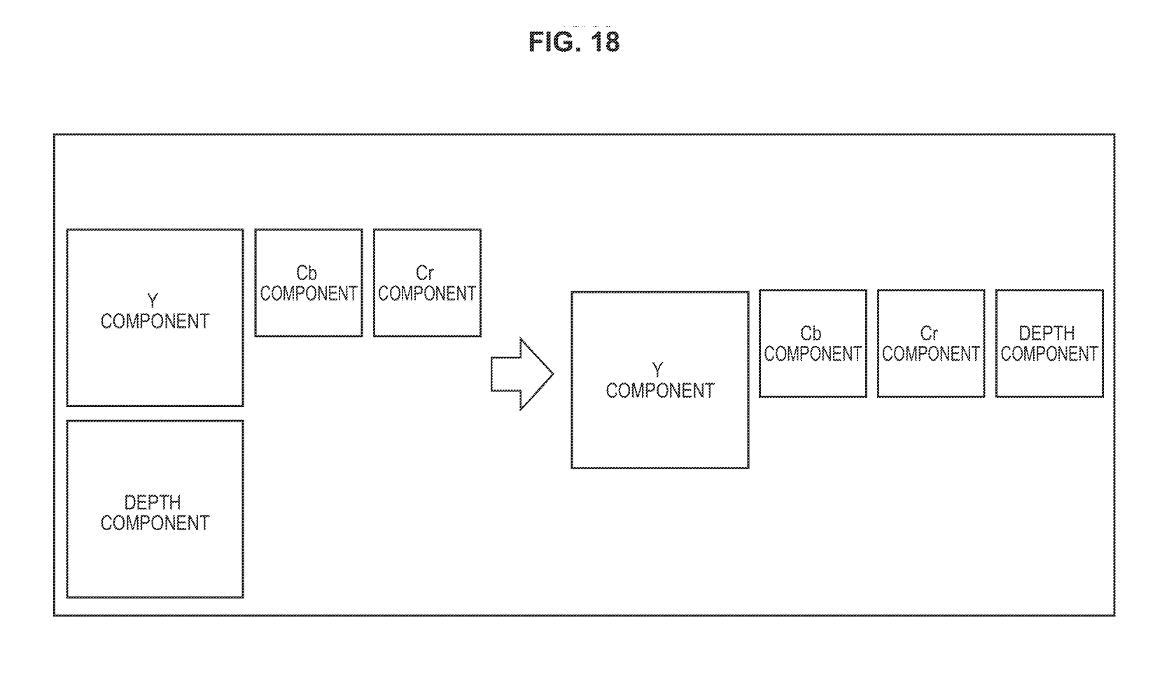

FIG. 18 is a diagram describing the multiplexing processing of the screen multiplexing unit 81 of FIG. 17.

Also, in the example of FIG. 18, the depth image input to the encoding apparatus 80 is assumed to have the same resolution as the Y image.

As illustrated in FIG. 18, the screen multiplexing unit 81 sets the Y component of the color image of a predetermined view, which is supplied from the multiview image separation unit 21 of FIG. 16, as the Y component of the multiplexed image. Also, the image multiplexing unit 81 sets the Cb component of the color image of a predetermined view as the Cb component of the multiplexed image, and sets the Cr component of the color image of a predetermined view as the Cr component of the multiplexed image. Furthermore, the image multiplexing unit 81 performs conversion such that the resolution of the depth image becomes equal to the resolutions of the Cb component and the Cr component, and sets the after-resolution-conversion depth image as the depth component of the multiplexed image.

[Example of Configuration of Multiview Image Encoding Unit]

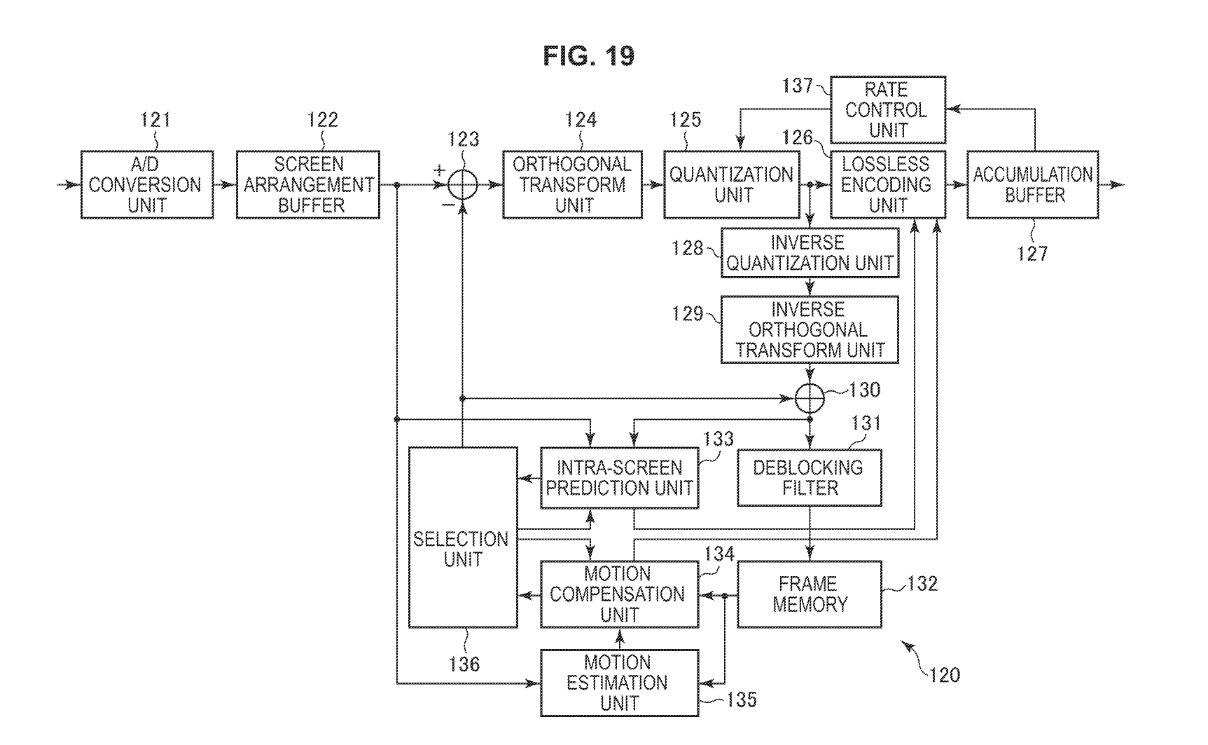

FIG. 19 is a block diagram illustrating an example of a configuration of the encoding unit that encodes the multiplexed image of one arbitrary view in the multiview image encoding unit 82 of FIG. 16. That is, the multiview image encoding unit 82 includes N encoding units 120 of FIG. 19.

The encoding unit 120 of FIG. 19 includes an A/D conversion unit 121, a screen arrangement buffer 122, a calculation unit 123, an orthogonal transform unit 124, a quantization unit 125, a lossless encoding unit 126, an accumulation buffer 127, an inverse quantization unit 128, an inverse orthogonal transform unit 129, an addition unit 130, a deblocking filter 131, a frame memory 132, an intra-screen prediction unit 133, a motion compensation unit 134, a motion estimation unit 135, a selection unit 136, and a rate control unit 137.

The A/D conversion unit 121 of the encoding unit 120 performs an A/D conversion on the frame-based multiplexed image of a predetermined view, which is supplied from the image multiplexing unit 81 of FIG. 16, and outputs the frame-based multiplexed image to the screen arrangement buffer 122, which stores the multiplexed image. The screen arrangement buffer 122 arranges the frame-based multiplexed image of stored display order according to a Group of Picture (GOP) structure in order for the purpose of encoding, and outputs the frame-based multiplexed image to the calculation unit 123, the intra-screen prediction unit 133 and the motion estimation unit 135.

The calculation unit 123 functions as an encoding unit, and encodes the multiplexed image to be encoded by calculating a difference between the predicted image, which is supplied from the selection unit 136, and the multiplexed image to be encoded, which is output from the screen arrangement buffer 122. Specifically, the calculation unit 123 subtracts the predicted image, which is supplied from the selection unit 136, from the multiplexed image to be encoded, which is supplied from the screen arrangement buffer 122. The calculation unit 123 outputs the image, which is obtained as a result of the subtraction, to the orthogonal transform unit 124 as residual information. Also, when the predicted image is not supplied from the selection unit 136, the calculation unit 123 directly outputs the image read from the screen arrangement buffer 122 to the orthogonal transform unit 124 as the residual information.

The orthogonal transform unit 124 performs an orthogonal transform, such as a discrete cosine transform or a Karhunen-Loeve transform, on the residual information from the calculation unit 123, and supplies the quantization unit 125 with the resultant coefficient.

The quantization unit 125 quantizes the coefficient supplied from the orthogonal transform unit 124. The quantized coefficient is input to the lossless encoding unit 126.

The lossless encoding unit 126 obtains intra-screen prediction information representing an optimal intra prediction mode or the like from the intra-screen prediction unit 133, and obtains motion information representing an optimal inter prediction mode, a motion vector, or the like from the motion compensation unit 134.

The lossless encoding unit 126 performs a lossless encoding, such as a variable length encoding (for example, a Context-Adaptive Variable Length Coding (CAVLC) or the like) and an arithmetic coding (for example, a Context-Adaptive Binary Arithmetic Coding (CABAC) or the like), on the quantized coefficient supplied from the quantization unit 125, and sets the resultant encoding stream as a coefficient encoding stream. Also, the lossless encoding unit 126 encodes the intra-screen prediction information or the motion information, and sets the resultant encoding stream as an information encoding stream. The lossless encoding unit 126 supplies the accumulation buffer 127 with the coefficient encoding stream and the information encoding stream as multiplexed image encoding stream, and accumulates the streams therein.

The accumulation buffer 127 temporarily stores and transmits the multiplexing encoding stream supplied from the lossless encoding unit 126.

Also, the quantized coefficient output from the quantization unit 125 is also input to the inverse quantization unit 128, is inversely quantized, and is then supplied to the inverse orthogonal transform unit 129.

The inverse orthogonal transform unit 129 performs an inverse orthogonal transform, such as an inverse discrete cosine transform or an inverse Karhunen-Loeve transform, on the coefficient supplied from the inverse quantization unit 128, and supplies the addition unit 130 with the resultant residual information.

The addition unit 130 obtains a locally decoded multiplexed image by adding the residual information as the image to be decoded, which is supplied from the inverse orthogonal transform unit 129, to the predicted image, which is supplied from the selection unit 136. Also, when the predicted image is not supplied from the selection unit 136, the addition unit 130 sets the residual information supplied from the inverse orthogonal transform unit 129 as the locally decoded multiplexed image. The addition unit 130 supplies the deblocking filter 131 with the locally decoded multiplexed image, and also supplies the intra-screen prediction unit 133 with the locally decoded multiplexed image as a reference image.

The deblocking filter 131 removes a block distortion by filtering the locally decoded multiplexed image supplied from the addition unit 130. The deblocking filter 131 supplies the frame memory 132 with the resultant multiplexed image and accumulates the multiplexed image therein. The multiplexed image accumulated in the frame memory 132 is output to the motion compensation unit 134 and the motion estimation unit 135 as the reference image.

The intra-screen prediction unit 133 generates the predicted image by performing the intra-screen prediction processing of all intra prediction modes being candidates by using the reference image supplied from the addition unit 130.

Also, the intra-screen prediction unit 133 calculates cost function values for all intra prediction modes being candidates (details will be described below) by using the predicted image and the multiplexed image supplied from the screen arrangement buffer 122. The intra-screen prediction unit 133 determines the intra prediction mode, whose cost function value is minimum, as the optimal intra prediction mode. The intra-screen prediction unit 133 supplies the selection unit 136 with the predicted image generated in the optimal intra prediction mode and the corresponding cost function value. When the selection of the predicted image generated in the optimal intra prediction mode is notified from the selection unit 136, the intra-screen prediction unit 133 supplies the lossless encoding unit 126 with the intra-screen prediction information representing the optimal intra prediction mode or the like.

Also, the cost function value is also referred to as a Rate Distortion (RD) cost. For example, as defined by Joint Model (JM), which is reference software in H.264/AVC, the cost function value is calculated based on either technique of a high complexity mode or a low complexity mode.

Specifically, when the high complexity mode is adopted as the technique for calculating the cost function value, the cost function value expressed as Math. (1) below is calculated for each prediction mode by temporarily performing up to the lossless encoding on all prediction modes being candidates.

Cost(Mode)=D+λ·R (1)

D is a difference (distortion) between an original image and a decoded image, R is an amount of generated codes including up to an orthogonal transform coefficient, and λ is a Lagrange multiplier given as a function of quantization parameter QP.

On the other hand, when the low complexity mode is adopted as the technique for calculating the cost function value, the cost function value expressed as Math. (2) below is calculated for each prediction mode by performing the generation of the decoded image and the calculation of the header bit of information representing the prediction mode on all prediction modes being candidates.

Cost(Mode)=D+QPtoQuant(QP)·Header_Bit (2)

D is a difference (distortion) between an original image and a decoded image, Header_Bit is a header bit for a prediction mode, and QPtoQuant is a function given as a function of quantization parameter QP.

In the low complexity mode, with respect to all prediction modes, the decoded image needs only to be generated, and the lossless encoding need not be performed. Therefore, it is sufficient even if an amount of computation is small. Also, it is assumed herein that the high complexity mode is adopted as the technique for calculating the cost function value.

The motion compensation unit 134 performs motion compensation processing by reading the reference image from the frame memory 132, based on the optimal inter prediction mode and the motion vector supplied from the motion estimation unit 135. The motion compensation unit 134 supplies the selection unit 136 with the resultant predicted image and the cost function value supplied from the motion estimation unit 135. Also, when the selection of the predicted image generated in the optimal inter prediction mode is notified from the selection unit 136, the motion compensation unit 134 outputs the motion information representing the optimal inter prediction mode, the corresponding motion vector, and the like to the lossless encoding unit 126.

The motion estimation unit 135 perform motion estimation processing of all inter prediction modes being candidates, based on the luma component of the multiplexed image to be encoded, which is supplied from the screen arrangement buffer 122, and the luma component of the reference image, which is supplied from the frame memory 132, and generates the motion vector. Specifically, the motion estimation unit 135 performs matching between the luma component of the multiplexed image to be encoded and the luma component of the reference image for each inter prediction mode, and generates the motion vector.

In this case, the motion estimation unit 135 calculates the cost function values for all inter prediction modes being candidates, and determines the inter prediction mode, whose cost function value is minimum, as the optimal inter prediction mode. The motion estimation unit 135 supplies the motion compensation unit 134 with the optimal inter prediction mode and the corresponding motion vector and cost function value.

Also, the inter prediction mode is information representing a size, a prediction direction, and a reference index of a block to be inter-predicted. The prediction direction includes a forward prediction (L0 prediction) using a reference image, whose display time is earlier than that of a multiplexed image to be inter-predicted, a backward prediction (L1 prediction) using a reference image, whose display time is later than that of a multiplexed image to be inter-predicted, and a bi-directional prediction (bi-prediction) using a reference image, whose display time is earlier than that of a multiplexed image to be inter-predicted, and a reference image, whose display time is later than that of a multiplexed image to be inter-predicted. Also, the reference index is a number for specifying the reference image. For example, as the image is closer to the multiplexed image to be inter-predicted, the reference index of the image is smaller.

The selection unit 136 determines either of the optimal intra prediction mode and the optimal inter prediction mode, whose cost function value is minimum, as the optimal prediction mode, based on the cost function values supplied from the intra-screen prediction unit 133 and the motion compensation unit 134. The selection unit 136 supplies the predicted image of the optimal prediction mode to the calculation unit 123 and the addition unit 130. Also, the selection unit 136 notifies the intra-screen prediction unit 133 or the motion compensation unit 134 of the selection of the predicted image of the optimal prediction mode.

The rate control unit 137 controls the rate of the quantization operation of the quantization unit 125, based on the multiplexed image encoding stream accumulated in the accumulation buffer 127, so as to prevent occurrence of overflow or underflow.

[Example of Configuration of Intra-Screen Prediction Unit]

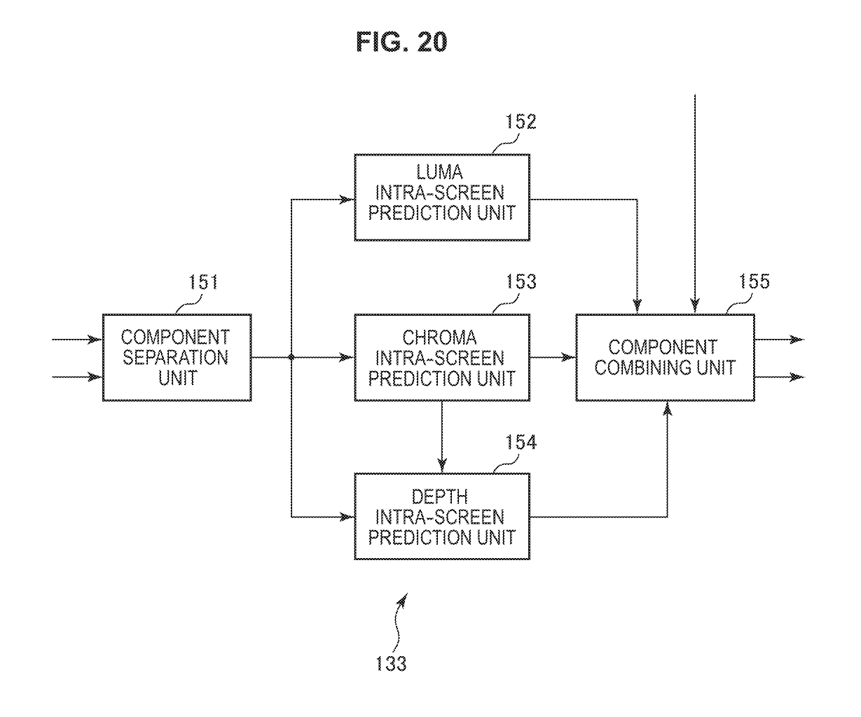

FIG. 20 is a block diagram illustrating an example of a configuration of the intra-screen prediction unit 133 of FIG. 19.

The intra-screen prediction unit 133 of FIG. 20 includes a component separation unit 151, a luma intra-screen prediction unit 152, a chroma intra-screen prediction unit 153, a depth intra-screen prediction unit 154, and a component combining unit 155.

The component separation unit 151 of the intra-screen prediction unit 133 separates the luma components, the chroma components, and the depth components of the reference image, which is supplied from the addition unit 130 of FIG. 19, and the multiplexed image to be encoded, which is supplied from the screen arrangement buffer 122. The component separation unit 151 supplies the luma intra-screen prediction unit 152 with the luma components of the reference image and the multiplexed image to be encoded, and supplies the chroma intra-screen prediction unit 153 with the chroma component. Also, the component separation unit 151 supplies the depth intra-screen prediction unit 154 with the depth components of the reference image and the multiplexed image to be encoded.

The luma intra-screen prediction unit 152 generates the luma component of the predicted image by performing the intra-screen prediction of all intra prediction modes being candidates, by using the luma component of the reference image supplied from the component separation unit 151. Also, the luma intra-screen prediction unit 152 calculates the cost function value by using the luma component of the multiplexed image to be encoded, which is supplied from the component separation unit 151, and the luma component of the predicted image, and determines the intra prediction mode, whose cost function value is minimum, as the optimal intra prediction mode for the luma component. The luma intra-screen prediction unit 152 supplies the component combining unit 155 with the luma component of the predicted image generated in the optimal intra prediction mode for the luma component, the optimal intra prediction mode for the luma component, and the corresponding cost function value.

The chroma intra-screen prediction unit 153 generates the chroma component of the predicted image by performing the intra-screen prediction of all intra prediction modes being candidates, by using the chroma component of the reference image supplied from the component separation unit 151. Also, the chroma intra-screen prediction unit 153 calculates the cost function value by using the chroma component of the multiplexed image to be encoded, which is supplied from the component separation unit 151, and the chroma component of the predicted image, and determines the intra prediction mode, whose cost function value is minimum, as the optimal intra prediction mode for the chroma component.

The chroma intra-screen prediction unit 153 supplies the component combining unit 155 with the chroma component of the predicted image generated in the optimal intra prediction mode for the chroma component, the optimal intra prediction mode for the chroma component, and the corresponding cost function value. Also, the chroma intra-screen prediction unit 153 supplies the depth intra-screen prediction unit 154 with the optimal intra prediction mode for the chroma component.

The depth intra-screen prediction unit 154 functions as a setting unit, and sets the optimal intra prediction mode for the chroma component, which is supplied from the chroma intra-screen prediction unit 153, as the optimal intra prediction mode for the depth component. That is, the depth intra-screen prediction unit 154 sets the optimal intra prediction mode to be shared with the chroma intra-screen prediction unit 153. The depth intra-screen prediction unit 154 generates the depth component of the predicted image by performing the intra-screen prediction of the optimal intra prediction mode for the depth component, by using the depth component of the reference image supplied from the component separation unit 151.

Also, the depth intra-screen prediction unit 154 calculates the cost function value by using the depth component of the multiplexed image to be encoded, which is supplied from the component separation unit 151, and the depth component of the predicted image. The depth intra-screen prediction unit 154 supplies the component combining unit 155 with the depth component of the predicted image and the cost function value.

The component combining unit 155 combines the luma component of the predicted image from the luma intra-screen prediction unit 152, the chroma component of the predicted image from the chroma intra-screen prediction unit 153, and the depth component of the predicted image from the depth intra-screen prediction unit 154. The component combining unit 155 supplies the selection unit 136 of FIG. 19 with the predicted image obtained as a result of the synthesis, the luma component and the chroma component of the predicted image, and the cost function value of the depth component. Also, when the selection of the predicted image generated in the optimal intra prediction mode is notified from the selection unit 136 of FIG. 19, the component combining unit 155 supplies the lossless encoding unit 126 with the intra-screen prediction information representing the optimal intra prediction modes for the luma component and the chroma component, or the like.

Also, in the present embodiment, the optimal intra prediction mode for the chroma component is determined, and the optimal intra prediction mode is set as the optimal intra prediction mode for the depth component. However, the optimal intra prediction mode for the depth component may be determined, and the optimal intra prediction mode may be set as the optimal intra prediction mode for the chroma component.

[Example of Configuration of Motion Compensation Unit]

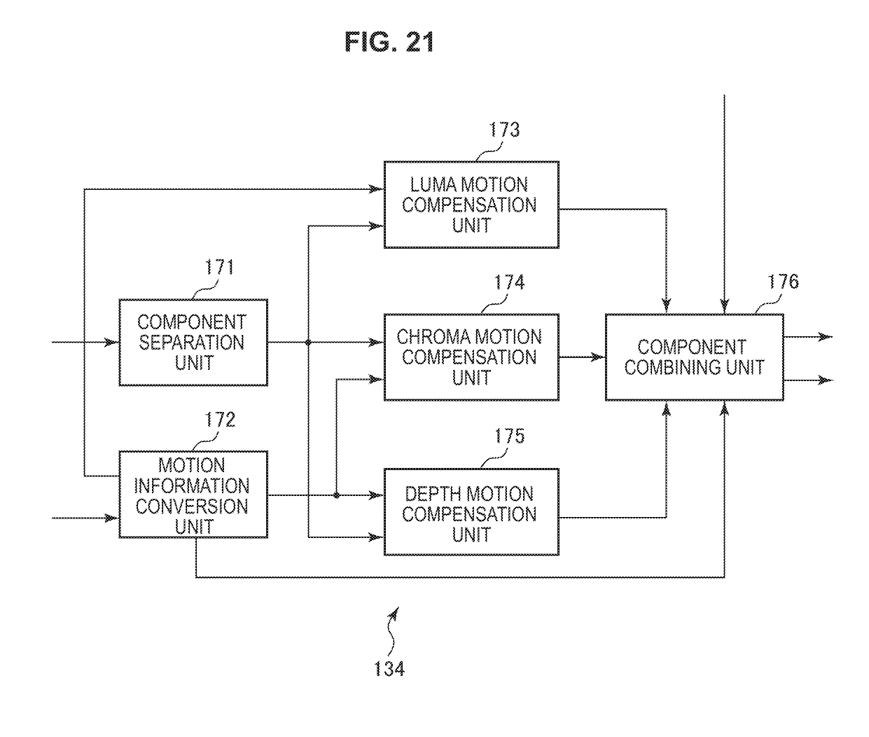

FIG. 21 is a block diagram illustrating an example of a configuration of the motion compensation unit 134 of FIG. 19.

The motion compensation unit 134 of FIG. 21 includes a component separation unit 171, a motion information conversion unit 172, a luma motion compensation unit 173, a chroma motion compensation unit 174, a depth motion compensation unit 175, and a component combining unit 176.

The component separation unit 171 of the motion compensation unit 134 separates the luma component, the chroma component, and the depth component of the reference image supplied from the addition unit 130 of FIG. 19. The component separation unit 171 supplies the luma motion compensation unit 173 with the luma component of the reference image, and supplies the chroma motion compensation unit 174 with the chroma component. Also, the component separation unit 171 supplies the depth motion compensation unit 175 with the depth component of the reference image.

The motion information conversion unit 172 supplies the luma motion compensation unit 173 with the optimal inter prediction mode and the motion vector supplied from the motion estimation unit 135 of FIG. 19. Also, the motion information conversion unit 172 converts the motion vector, based on the luma component of the color image, the chroma component of the color image, and the resolution of the after-resolution-conversion depth image. For example, when the color image is the so-called YUV420 image, the motion information conversion unit 172 multiplies the motion vector by ½. The motion information conversion unit 172 supplies the chroma motion compensation unit 174 and the depth motion compensation unit 175 with the after-conversion motion vector and the optimal inter prediction mode. Also, the motion information conversion unit 172 supplies the component combining unit 176 with the cost function value, the optimal inter prediction mode, and the motion vector supplied from the motion estimation unit 135.

The luma motion compensation unit 173 performs motion compensation processing by reading the luma component of the reference picture through the component separation unit 171, based on the optimal inter prediction mode and the motion vector supplied from the motion information conversion unit 172, and generates the luma component of the predicted image. The luma motion compensation unit 173 supplies the component combining unit 176 with the luma component of the predicted image.

The chroma motion compensation unit 174 performs motion compensation processing by reading the chroma component of the reference picture through the component separation unit 171, based on the optimal inter prediction mode and the motion vector supplied from the motion information conversion unit 172. That is, the chroma motion compensation unit 174 functions as a setting unit, sets the optimal inter prediction mode and the motion vector to be shared with the luma motion compensation unit 173, and performs the motion compensation processing. The chroma motion compensation unit 174 supplies the component combining unit 176 with the chroma component of the resultant predicted image.

The depth motion compensation unit 175 performs motion compensation processing by reading the depth component of the reference picture through the component separation unit 171, based on the optimal inter prediction mode and the motion vector supplied from the motion information conversion unit 172. That is, the depth motion compensation unit 175 functions as a setting unit, sets the optimal inter prediction mode and the motion vector to be shared with the luma motion compensation unit 173, and performs the motion compensation processing. The depth motion compensation unit 175 supplies the component combining unit 176 with the depth component of the resultant predicted image.

The component combining unit 176 combines the luma component of the predicted image from the luma motion compensation unit 173, the chroma component of the predicted image from the chroma motion compensation unit 174, and the depth component of the predicted image from the depth motion compensation unit 175. The component combining unit 176 supplies the selection unit 136 of FIG. 19 with the predicted image obtained as a result of the synthesis and the cost function value supplied from the motion information conversion unit 172. Also, when the selection of the predicted image generated in the optimal inter prediction mode is notified from the selection unit 136 of FIG. 19, the component combining unit 176 supplies the lossless encoding unit 126 with the motion information representing the optimal inter prediction mode, the motion vector, and the like.

[Example of Configuration of Lossless Encoding Unit]

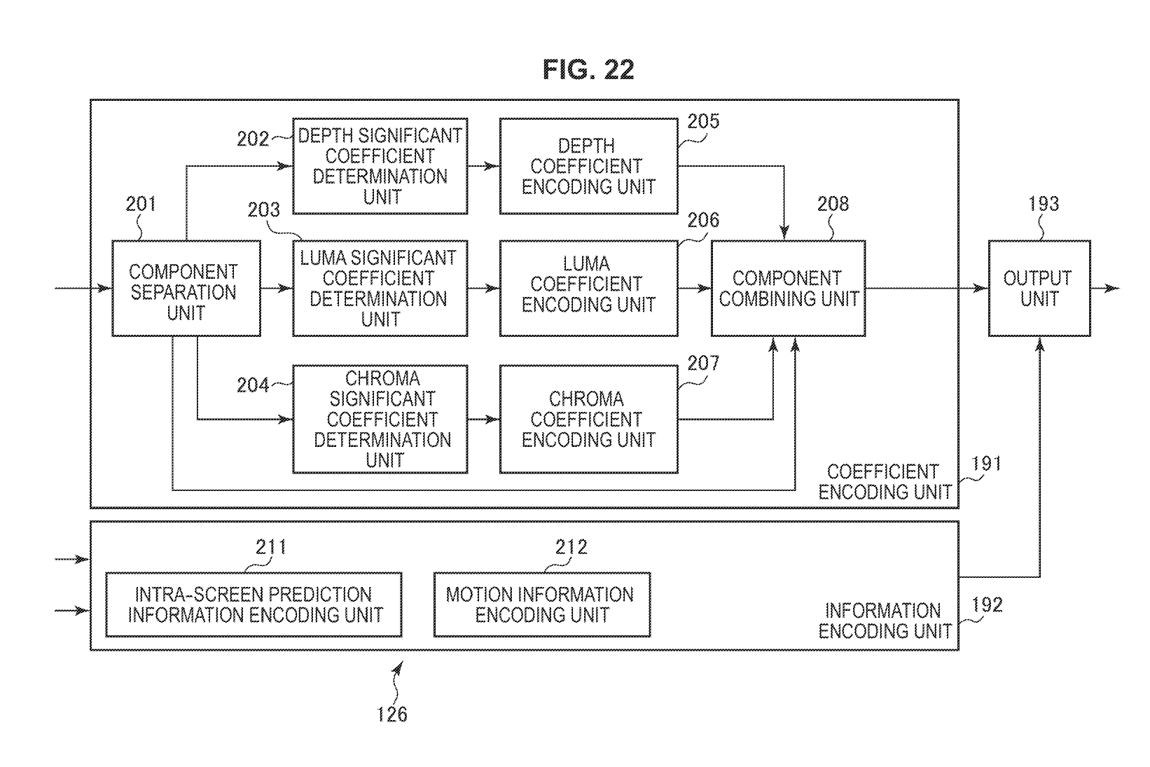

FIG. 22 is a block diagram illustrating an example of a configuration of the lossless encoding unit 126 of FIG. 19.

The lossless encoding unit 126 of FIG. 22 includes a coefficient encoding unit 191, an information encoding unit 192, and an output unit 193.

The coefficient encoding unit 191 of the lossless encoding unit 126 includes a component separation unit 201, a depth significant coefficient determination unit 202, a luma significant coefficient determination unit 203, a chroma significant coefficient determination unit 204, and a depth coefficient encoding unit 205, a luma coefficient encoding unit 206, a chroma coefficient encoding unit 207, and a component combining unit 208.

The component separation unit 201 separates the coefficient supplied from the quantization unit 125 of FIG. 19 into the luma component, the chroma component, and the depth component. The component separation unit 201 supplies the depth significant coefficient determination unit 202 with the depth component of the coefficient, supplies the luma significant coefficient determination unit 203 with the luma component, and supplies the chroma significant coefficient determination unit 204 with the chroma component. Also, when the optimal prediction mode is the optimal inter prediction mode, the component separation unit 201 performs encoding by setting a no_residual_data flag (its details will be described below), and supplies the component combining unit 208 with the no_residual_data flag.

The depth significant coefficient determination unit 202 determines whether the depth component of the coefficient is 0, based on the depth component of the coefficient supplied from the component separation unit 201. When it is determined that the depth component of the coefficient is 0, the depth significant coefficient determination unit 202 supplies the depth coefficient encoding unit 205 with 0 representing the absence of the significant coefficient as the significant coefficient flag representing whether the significant coefficient of the depth component is present. On the other hand, when it is determined that the depth component of the coefficient is nonzero, the depth significant coefficient determination unit 202 supplies the depth coefficient encoding unit 205 with 1 representing the presence of the significant coefficient as the significant coefficient flag of the depth component, and supplies the depth coefficient encoding unit 205 with the depth component of the coefficient.

Since the luma significant coefficient determination unit 203 and the chroma significant coefficient determination unit 204 perform the same processing as the depth significant coefficient determination unit 202, except that the processing targets thereof are the luma component and the chroma component, respectively, their description will be omitted.

When the significant coefficient flag of the depth component supplied from the depth significant coefficient determination unit 202 is 1, the depth coefficient encoding unit 205 performs lossless encoding on the depth component of the coefficient. The depth coefficient encoding unit 205 supplies the component combining unit 208 with 0 as the significant coefficient flag of the depth component or 1 as the significant coefficient flag of the depth component and the lossless-encoded depth component of the coefficient, as the depth component of the coefficient encoding stream.

Since the luma coefficient encoding unit 206 and the chroma coefficient encoding unit 207 perform the same processing as the depth coefficient encoding unit 205, except that the processing targets thereof are the luma component and the chroma component, respectively, their description will be omitted.

The component combining unit 208 combines the depth component of the coefficient encoding stream from the depth coefficient encoding unit 205, the luma component of the coefficient encoding stream from the luma coefficient encoding unit 206, and the chroma component of the coefficient encoding stream from the chroma coefficient encoding unit 207. Also, when the encoding stream of the no_residual_data flag is supplied from the component separation unit 201, the component combining unit 208 includes the encoding stream of the no_residual_data flag in the coefficient encoding stream obtained as a result of the synthesis. The component combining unit 208 supplies the output unit 193 with the coefficient encoding stream.

The information encoding unit 192 includes an intra-screen prediction information encoding unit 211 and a motion information encoding unit 212.

The intra-screen prediction information encoding unit 211 of the information encoding unit 192 encodes the intra-screen prediction information for the luma component and the intra-screen prediction information for the chroma component, which are supplied from the component combining unit 155 of the intra-screen prediction unit 133 (FIG. 20). The intra-screen prediction information encoding unit 211 supplies the output unit 193 with the encoding stream, which is obtained as a result of the encoding, as the information encoding stream.

The motion information encoding unit 212 encodes the motion information supplied from the component combining unit 176 of the motion compensation unit 134 (FIG. 21), and supplies the output unit 193 with the resultant encoding stream as the information encoding stream.

The output unit 193 supplies the accumulation buffer 127 of FIG. 19 with the coefficient encoding stream supplied from the component combining unit 208 and the information encoding stream supplied from the information encoding unit 192 as the multiplexed image encoding stream.

[Description of Significant Coefficient Flag]

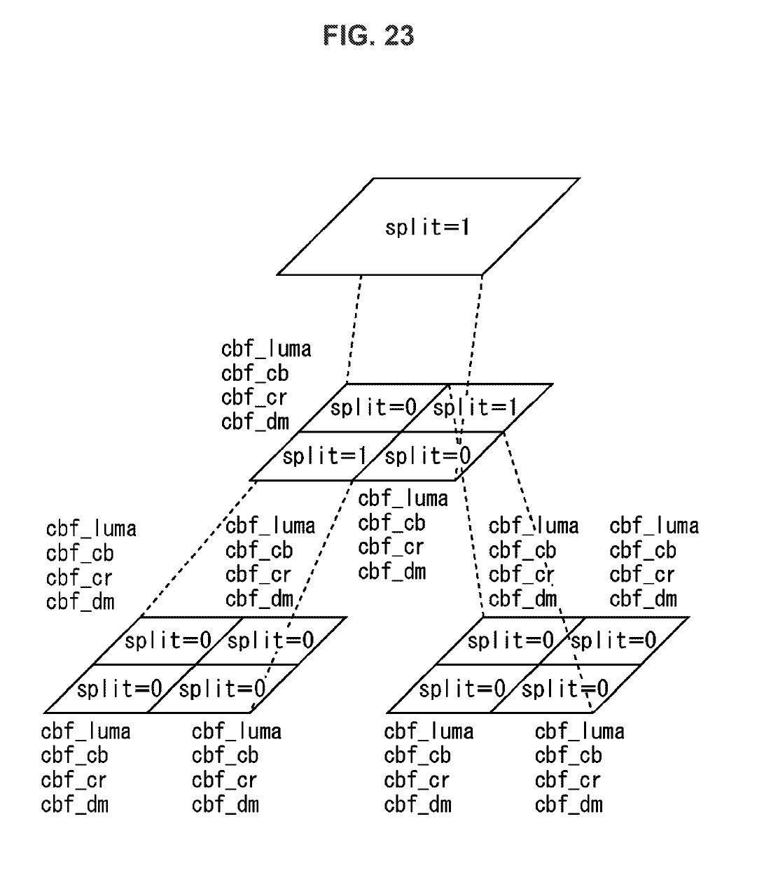

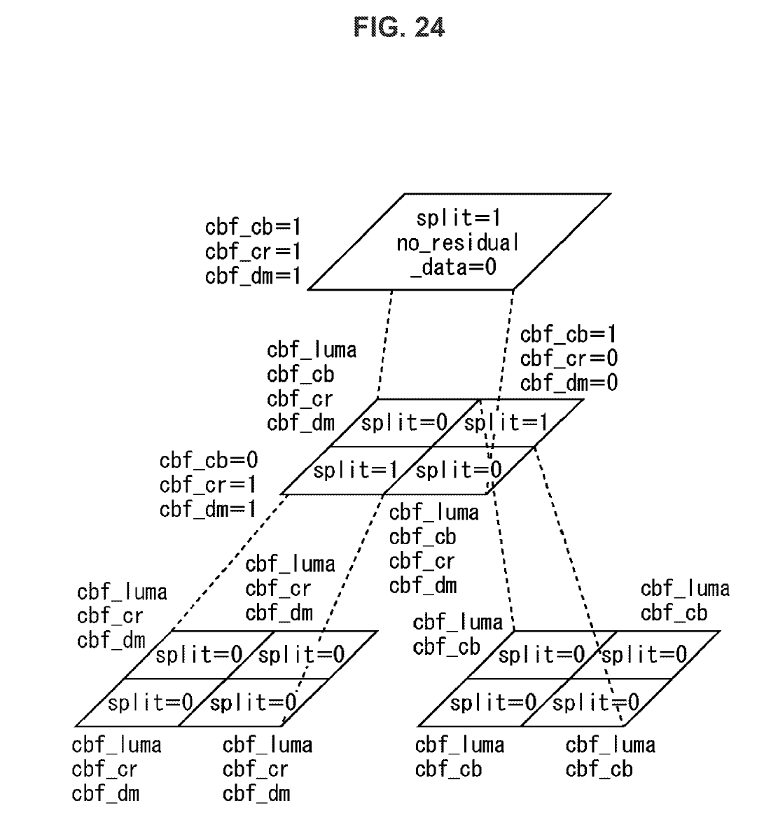

FIG. 23 is a diagram describing the significant coefficient flag when the optimal prediction mode is the optimal intra prediction mode, and FIG. 24 is a diagram describing the significant coefficient flag when the optimal prediction mode is the optimal inter prediction mode.

In FIGS. 23 and 24, a square represents a coding unit defined in an HEVC mode. The coding unit is also referred to as a Coding Tree Block (CTB) and is a partial region of a picture-based image, which serves as a macroblock in an AVC mode. While the macroblock is fixed to a pixel size of 16×16, the size of the coding unit is not fixed and is designated in each sequence.

Also, the coding unit is divided one layer down when a value of a split flag is 1, and is not divided when the value of the split flag is 0.

As illustrated in FIG. 23, when the optimal prediction mode is the optimal intra prediction mode, the significant coefficient flag (cbf_luma) of the luma component, the significant coefficient flag (cbf_cb, cbf_cr) of the chroma component, and the significant coefficient flag (cbf_dm) of the depth component are set with respect to the coding unit, the value of the split flag of which is 0.

On the other hand, as illustrated in FIG. 24, when the optimal prediction mode is the optimal inter prediction mode, the no_residual_data flag representing whether the significant coefficients are present in all components of the coding unit is set with respect to the coding unit of the uppermost layer. The no_residual_data flag is 1 when representing that no significant coefficients are present in all components of the coding unit, and is 0 when representing that the significant coefficient is present in at least one component of the coding unit.

Also, the significant coefficient flag of the chroma component and the significant coefficient flag of the depth component are not dependent on the value of the split flag, and are set when 1 in the coding unit that is one layer upper than its own coding unit or when its own coding unit is the coding unit of the uppermost layer. Furthermore, the significant coefficient flag of the luma component is set with respect to the coding unit, the value of the split flag of which is 0.

[Example of Syntax Related to Coefficients]

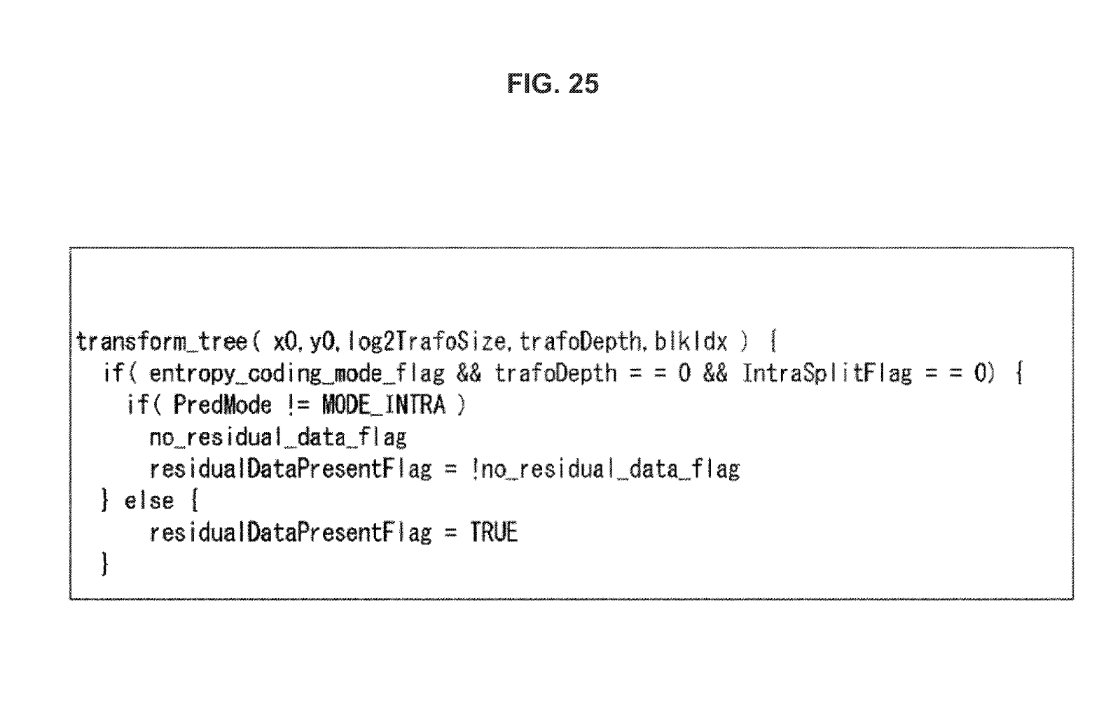

FIGS. 25 to 28 are diagrams illustrating examples of a syntax related to coefficients.

In the syntax of FIG. 25, in the case where the optimal prediction mode is not the optimal intra prediction mode, that is, when the optimal prediction mode is the optimal inter prediction mode, the setting of the no_residual_data flag (no_residual_data_flag) is described.

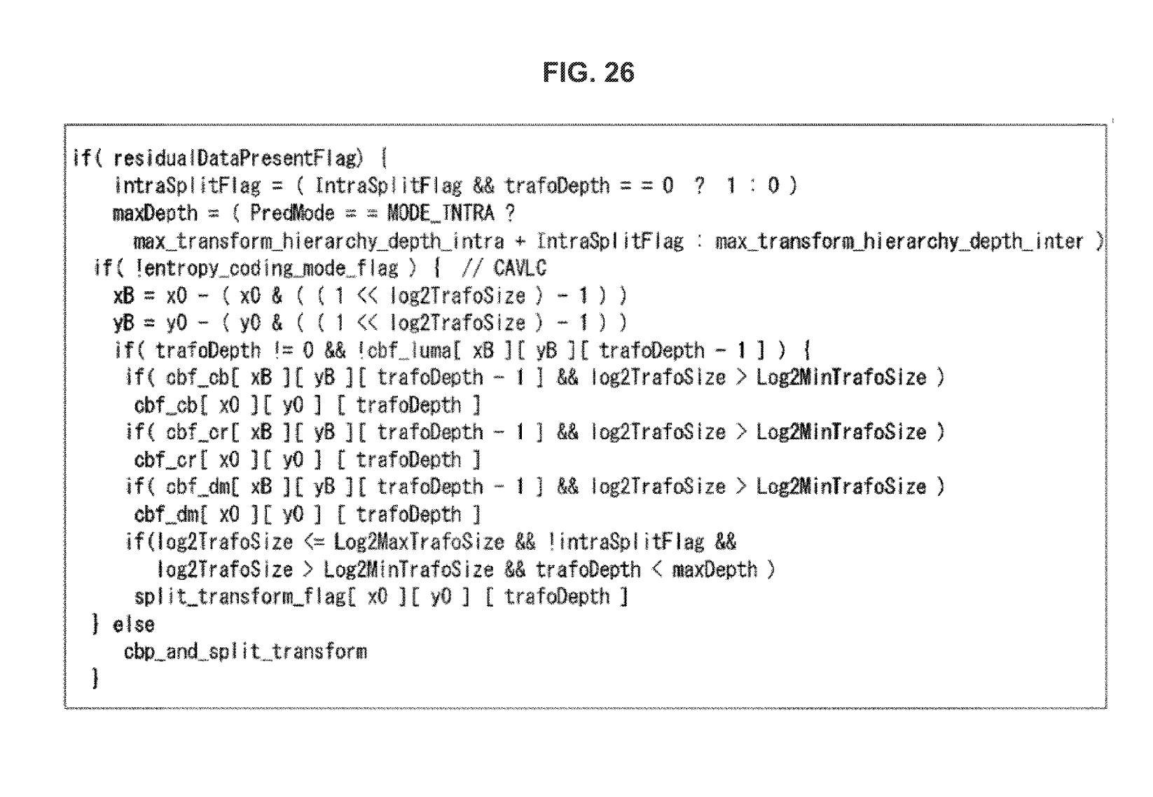

Also, in the syntax of FIG. 26, in the case where the lossless encoding of the coefficient is CAVLC and the no_residual_data flag is 0, when the layer of the processing target is not the uppermost layer and the significant coefficient flag of the chroma component or the depth component of the layer above the layer of the processing target is 1, the setting of the significant coefficient flag of the chroma component or the depth component is described.

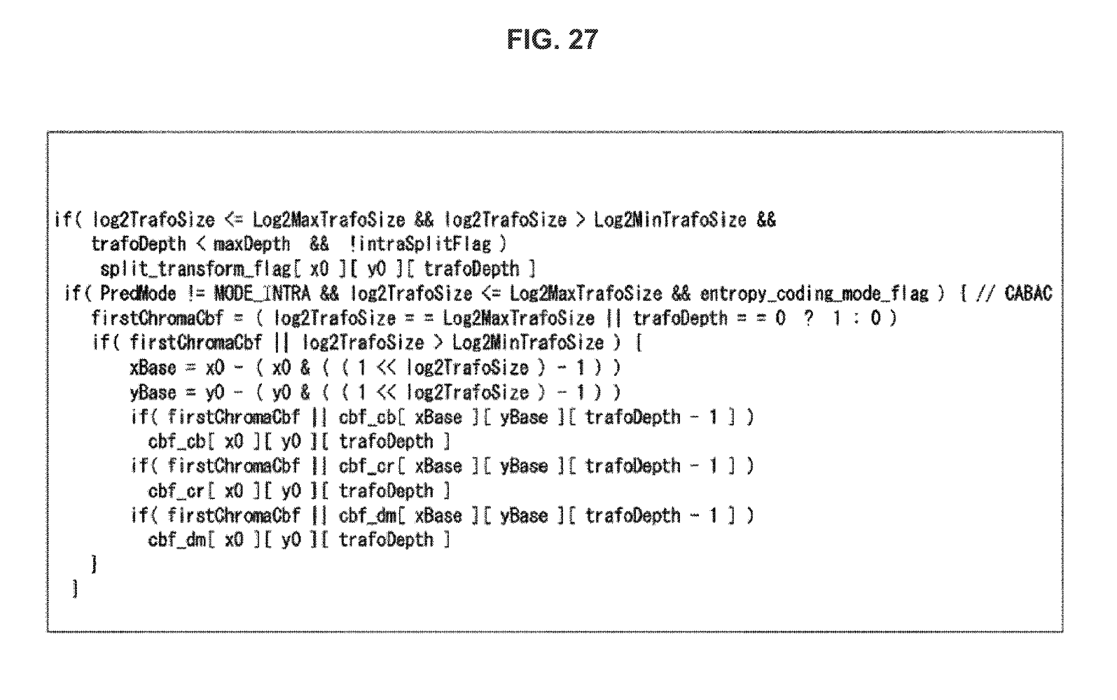

Furthermore, in the syntax of FIG. 27, in the case where the lossless encoding mode is CAVAC and the optimal prediction mode is the optimal inter prediction mode, when the significant coefficient flag of the chroma component or the depth component of the layer above the layer of the processing target is 1, the setting of the significant coefficient flag of the chroma component or the depth component is described, and when the layer of the processing target is the uppermost layer, the setting of the significant coefficient flags of the chroma component and the depth component is described.

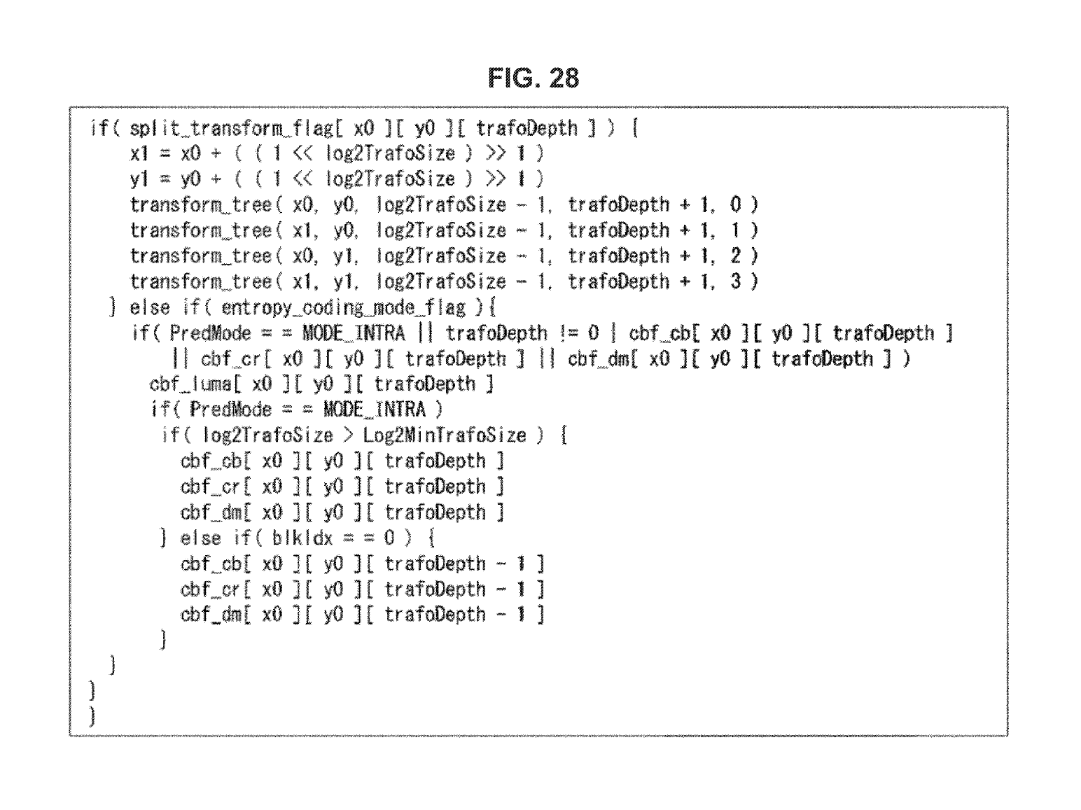

In the syntax of FIG. 28, in the case where the split flag is 0, and the optimal prediction mode is the optimal intra prediction mode or the optimal prediction mode is the optimal inter prediction mode, and the layer of the processing target is the layer other than the uppermost layer, or the layer of the processing target is the uppermost layer and the no_residual_data flag is 0, and the significant coefficient flag of the component other than the luma component is 1, the setting of the significant coefficient flag of the luma component is described. That is, in the case where the split flag is 0, the optimal prediction mode is the optimal inter prediction mode, the layer of the processing target is the uppermost layer, and the no_residual_data flag is 0, when the significant coefficient flag of the component other than the luma component is 0, the significant coefficient flag of the luma component is necessarily 1. Therefore, the significant coefficient flag of the luma component is not set.

[Description of Encoding Processing]

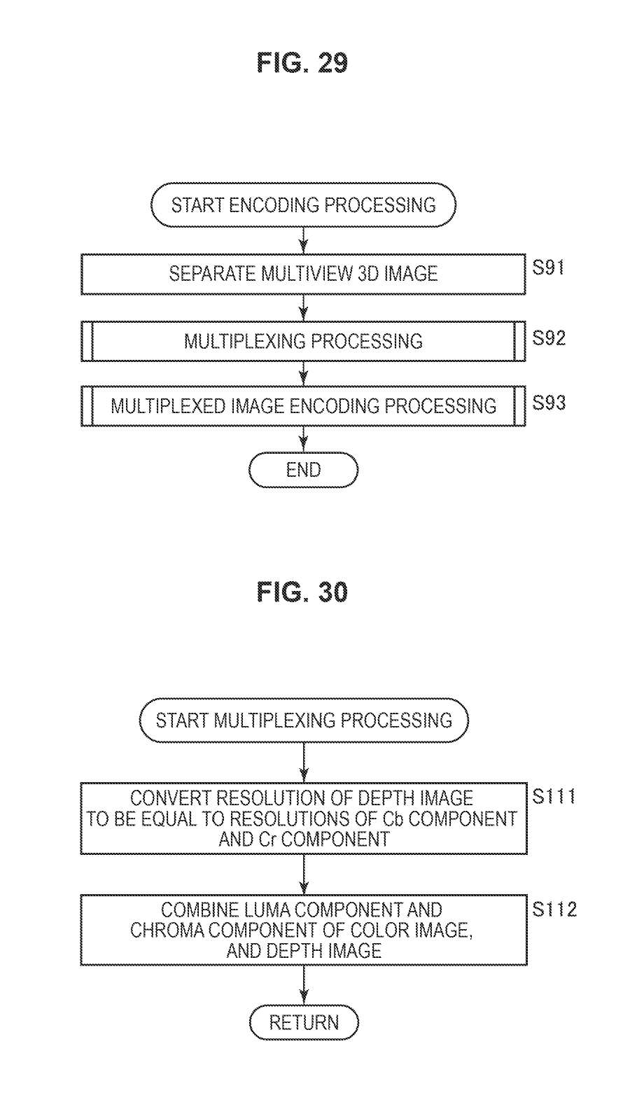

FIG. 29 is a flow chart describing the encoding processing by the encoding apparatus 80 of FIG. 16.

In step S91 of FIG. 29, the multiview image separation unit 21 of the encoding apparatus 80 separates the multiview 3D image input to the encoding apparatus 80, and obtains the color image and the depth image of each view. The multiview image separation unit 21 supplies the image multiplexing unit 81 with the color image and the depth image of each view at each view.

In step S92, the image multiplexing unit 81 performs the multiplexing processing. Details of the multiplexing processing will be described below with reference to FIG. 30.

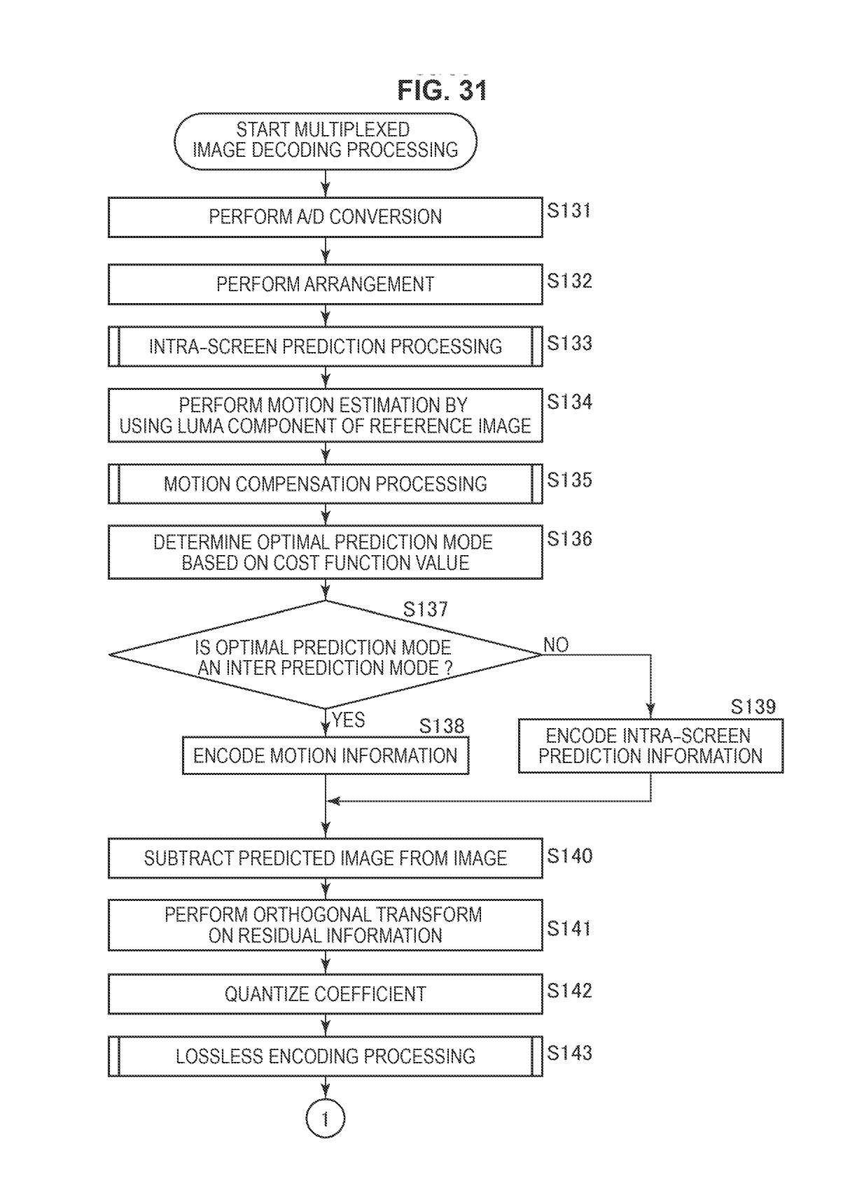

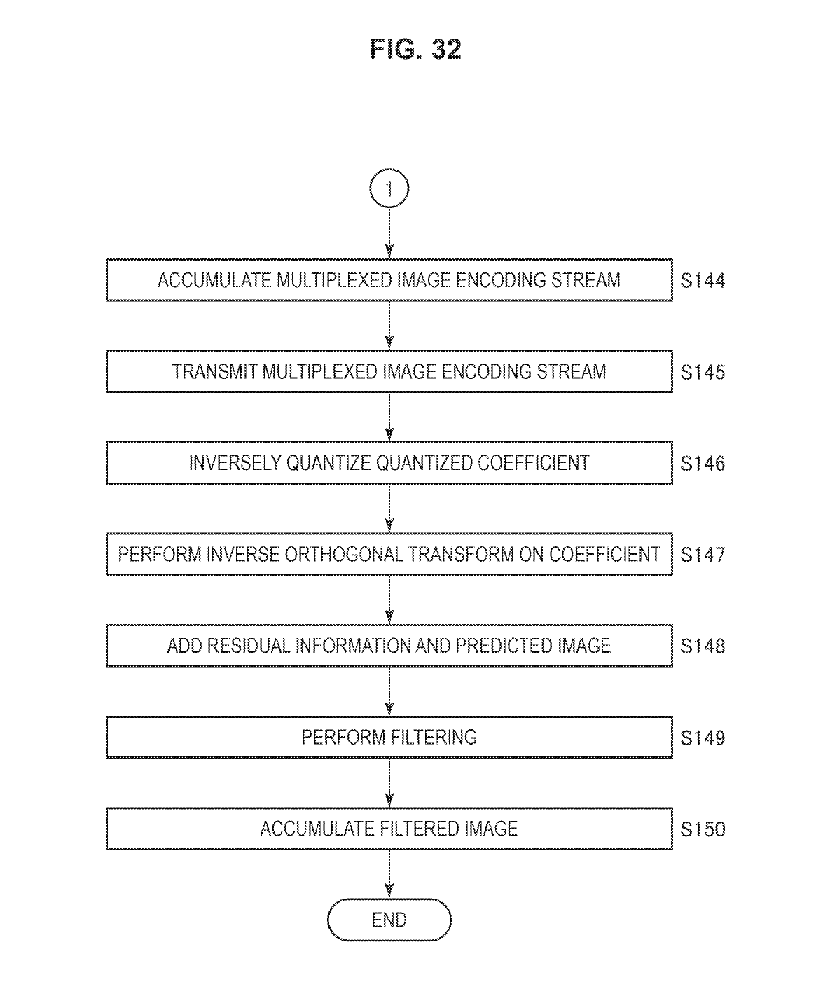

In step S93, the multiview image encoding unit 82 performs the multiplexed image encoding processing to encode the multiplexed image of each view, which is supplied from the image multiplexing unit 81, in accordance with the encoding scheme corresponding to the HEVC scheme. Details of the multiplexed image encoding processing will be described below with reference to FIGS. 31 and 32.

FIG. 30 is a flow chart describing details of the multiplexing processing of step S92 of FIG. 29.

In step S111 of FIG. 30, the resolution conversion processing unit 101 of the image multiplexing unit 81 (FIG. 17) performs conversion such that the resolution of the depth image of a predetermined view, which is supplied from the multiview image separation unit 21 of FIG. 16, becomes equal to the resolutions of the Cb component and the Cr component of the color image. The resolution conversion processing unit 101 supplies the component combining processing unit 102 with the after-resolution-conversion depth image.

In step S112, the component combining processing unit 102 generates the multiplexed image by combining the luma component and the chroma component of the color image of a predetermined view from the multiview image separation unit 21 and the after-resolution-conversion depth image from the resolution conversion processing unit 101, respectively, as the luma component, the chroma component, and the depth component of the multiplexed image. The component combining processing unit 102 supplies the multiview image encoding unit 82 of FIG. 2 with the multiplexed image. Then, the processing returns to the processing of step S92 of FIG. 29 and proceeds to step S93.

FIGS. 31 and 32 are flow charts describing details of the multiplexed image encoding processing of step S93 of FIG. 29. The multiplexed image encoding processing is performed at each view.

In step S131 of FIG. 31, the A/D conversion unit 121 of the encoding unit 120 (FIG. 19) performs the A/D conversion on the frame-based multiplexed image of a predetermined view, which is supplied from the image multiplexing unit 81 of FIG. 16, and outputs the frame-based multiplexed image to the screen arrangement buffer 122, which stores the multiplexed image.

In step S132, the screen arrangement buffer 122 arranges the multiplexed image of the frame of the stored display order in order for the purpose of encoding according to the GOP structure. The screen arrangement buffer 122 supplies the after-arrangement frame-based multiplexed image to the calculation unit 123, the intra-screen prediction unit 133, and the motion estimation unit 135.

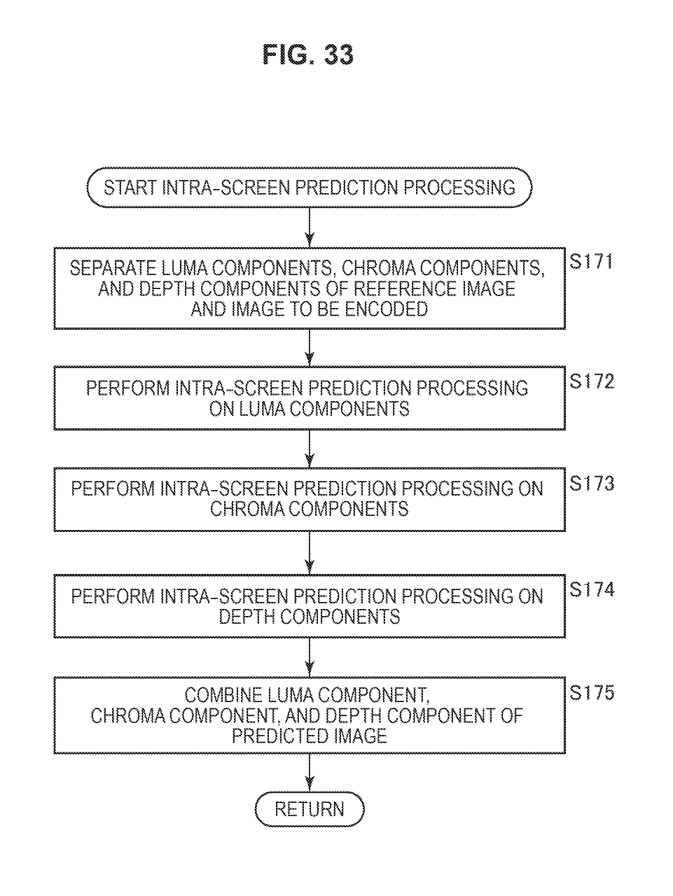

In step S133, the intra-screen prediction unit 133 performs the intra-screen prediction processing of all intra prediction modes being candidates by using the reference image supplied from the addition unit 130. Details of the intra-screen prediction processing will be described below with reference to FIG. 33.

In step S134, the motion estimation unit 135 generates the motion vector by performing the motion estimation processing of all inter prediction modes being candidates by using the luma component of the multiplexed image to be encoded, which is supplied from the screen arrangement buffer 122, and the luma component of the reference image, which is supplied from the frame memory 132. In this case, the motion estimation unit 135 calculates the cost function values for all inter prediction modes being candidates, and determines the inter prediction mode, whose cost function value is minimum, as the optimal inter prediction mode. The motion estimation unit 135 supplies the motion compensation unit 134 with the optimal inter prediction mode and the corresponding motion vector and cost function value.

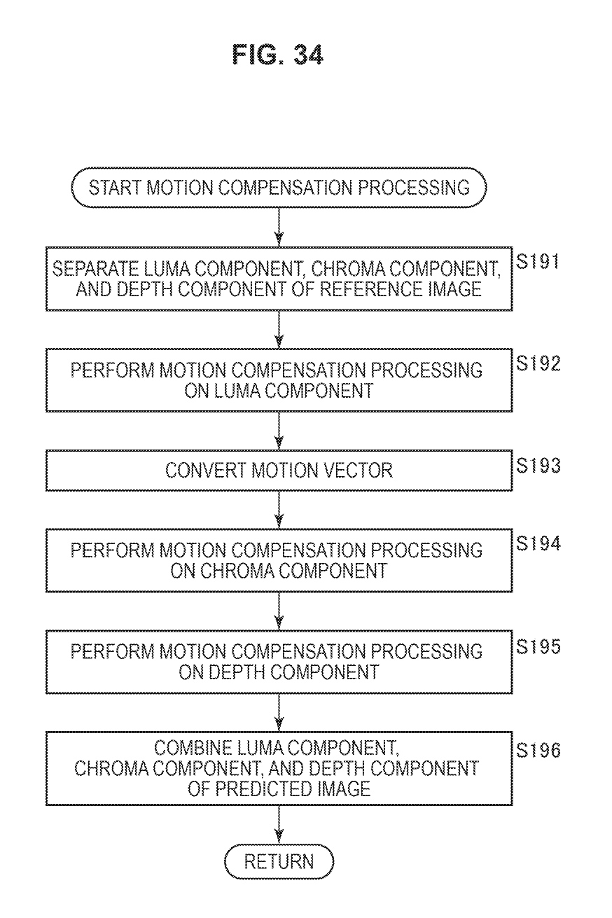

In step S135, the motion compensation unit 134 performs the motion compensation processing by reading the reference image from the frame memory 132, based on the motion vector and the optimal inter prediction mode supplied from the motion estimation unit 135. Details of the motion compensation processing will be described below with reference to FIG. 34.

In step S136, the selection unit 136 determines either of the optimal intra prediction mode and the optimal inter prediction mode, whose cost function value is minimum, as the optimal prediction mode, based on the cost function values supplied from the intra-screen prediction unit 133 and the motion compensation unit 134. The selection unit 136 supplies the predicted image of the optimal prediction mode to the calculation unit 123 and the addition unit 130.

In step S137, the selection unit 136 determines whether the optimal prediction mode is the optimal inter prediction mode. In step S137, when it is determined that the optimal prediction mode is the optimal inter prediction mode, the selection unit 136 notifies the motion compensation unit 134 of the selection of the predicted image generated in the optimal inter prediction mode. Therefore, the component combining unit 176 of the motion compensation unit 134 (FIG. 21) outputs the motion information representing the optimal inter prediction mode, the motion vector, and the like, which is supplied from the motion estimation unit 135 through the motion information conversion unit 172, to the lossless encoding unit 126.

In step S138, the motion information encoding unit 212 of the information encoding unit 192 of the lossless encoding unit 126 (FIG. 22) encodes the motion information supplied from the motion compensation unit 134 and supplies the encoded motion information to the output unit 193. Then, the processing proceeds to step S140.

On the other hand, when it is determined in step S137 that the optimal prediction mode is not the optimal inter prediction mode, that is, when the optimal prediction mode is the optimal intra prediction mode, the selection unit 136 notifies the intra-screen prediction unit 133 of the selection of the predicted image generated in the optimal intra prediction mode. Therefore, the component combining unit 155 of the intra-screen prediction unit 133 (FIG. 20) supplies the lossless encoding unit 126 with the intra-screen prediction information for the luma component and the chroma component.

In step S139, the intra-screen prediction information encoding unit 211 of the information encoding unit 192 of the lossless encoding unit 126 encodes the intra-screen prediction information supplied from the intra-screen prediction unit 133 and supplies the encoded intra-screen prediction information to the output unit 193. Then, the processing proceeds to step S140.

In step S140, the calculation unit 123 subtracts the predicted image, which is supplied from the selection unit 136, from the multiplexed image, which is supplied from the screen arrangement buffer 122. The calculation unit 123 outputs the image, which is obtained as a result of the subtraction, to the orthogonal transform unit 124 as residual information.

In step S141, the orthogonal transform unit 124 performs the orthogonal transform on the residual information from the calculation unit 123, and supplies the resultant coefficient to the quantization unit 125.

In step S142, the quantization unit 125 quantizes the coefficient supplied from the orthogonal transform unit 124. The quantized coefficient is input to the lossless encoding unit 126 and the inverse quantization unit 128.

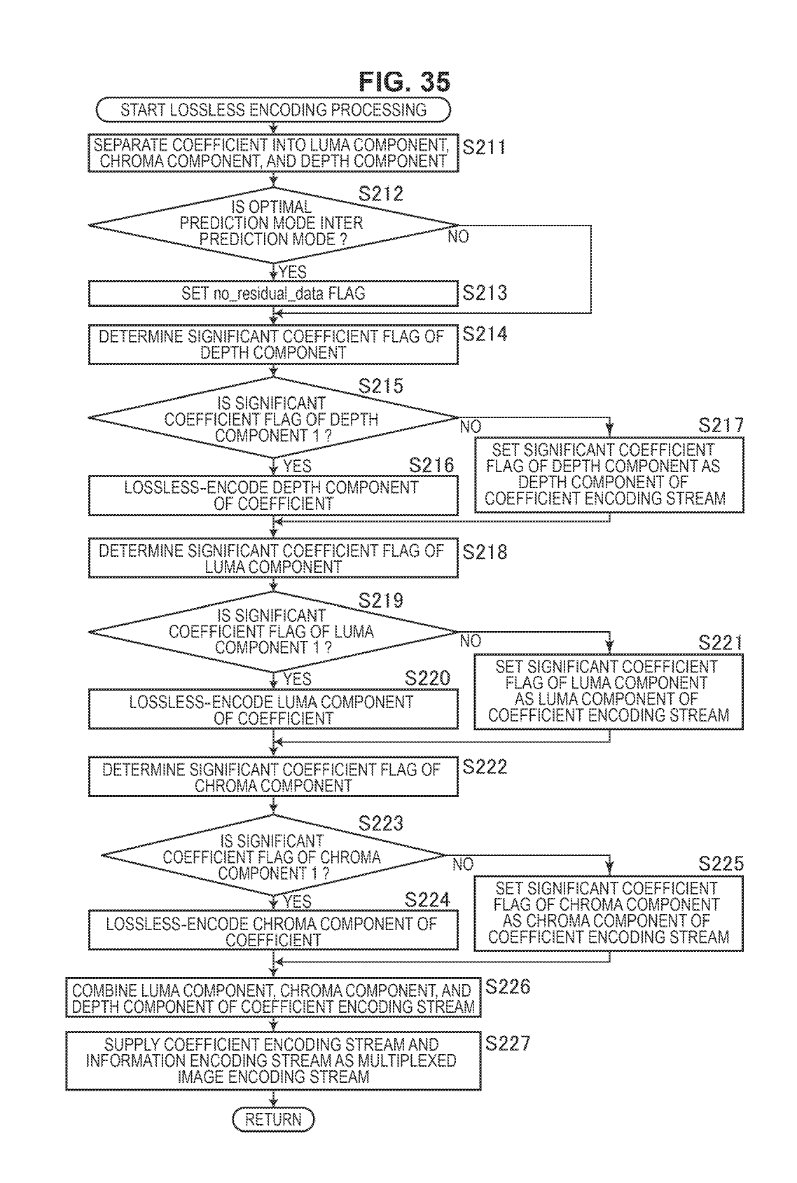

In step S143, the lossless encoding unit 126 performs the lossless encoding processing to lossless-encode the quantized coefficient supplied from the quantization unit 125. Details of the lossless encoding processing will be described below with reference to FIG. 35.

In step S144 of FIG. 32, the lossless encoding unit 126 supplies the accumulation buffer 127 with the multiplexed image encoding stream, which is obtained as a result of the lossless encoding processing, and accumulates the multiplexed image encoding streams therein.

In step S145, the accumulation buffer 127 transmits the accumulated multiplexed image encoding stream.

In step S146, the inverse quantization unit 128 inversely quantizes the quantized coefficient supplied from the quantization unit 125.

In step S147, the inverse orthogonal transform unit 129 performs the inverse orthogonal transform on the coefficient supplied from the inverse quantization unit 128, and supplies the resultant residual information to the addition unit 130.

In step S148, the addition unit 130 obtains a locally decoded multiplexed image by adding the residual information supplied from the inverse orthogonal transform unit 129 to the predicted image supplied from the selection unit 136. The addition unit 130 supplies the deblocking filter 131 with the obtained multiplexed image, and also supplies the intra-screen prediction unit 133 with the reference image.

In step S149, the deblocking filter 131 removes a block distortion by filtering the locally decoded multiplexed image supplied from the addition unit 130.

In step S150, the deblocking filter 131 supplies the frame memory 132 with the filtered multiplexed image, and accumulates the multiplexed image therein. The multiplexed image accumulated in the frame memory 132 is output to the motion compensation unit 134 and the motion estimation unit 135 as the reference image. Then, the processing is ended.

Also, the processing of steps S133 to S140 of FIGS. 31 and 32 is performed based on, for example, the coding unit. Also, in the multiplexed image encoding processing of FIGS. 31 and 32, for simplicity of description, the intra-screen prediction processing and the motion compensation processing are always performed, but in practice, only one of them may be performed by a picture type or the like.

FIG. 33 is a flow chart describing details of the intra-screen prediction processing of step S133 of FIG. 31.

In step S171 of FIG. 33, the component separation unit 151 of the intra-screen prediction unit 133 (FIG. 20) separates the luma components, the chroma components, and the depth components of the reference image, which is supplied from the addition unit 130 of FIG. 19, and the multiplexed image to be encoded, which is supplied from the screen arrangement buffer 122. The component separation unit 151 supplies the luma intra-screen prediction unit 152 with the luma components of the reference image and the multiplexed image to be encoded, and supplies the chroma intra-screen prediction unit 153 with the chroma component. Also, the component separation unit 151 supplies the depth intra-screen prediction unit 154 with the depth components of the reference image and the multiplexed image to be encoded.

In step S172, the luma intra-screen prediction unit 152 performs the intra-screen prediction processing on the luma component of the reference image supplied from the component separation unit 151. Specifically, the luma intra-screen prediction unit 152 generates the luma component of the predicted image by performing the intra-screen prediction of all intra prediction modes being candidates by using the luma component of the reference image supplied from the component separation unit 151. Also, the luma intra-screen prediction unit 152 calculates the cost function value by using the luma component of the multiplexed image to be encoded, which is supplied from the component separation unit 151, and the luma component of the predicted image, and determines the intra prediction mode, whose cost function value is minimum, as the optimal intra prediction mode for the luma component. The luma intra-screen prediction unit 152 supplies the component combining unit 155 with the luma component of the predicted image generated in the optimal intra prediction mode for the luma component, the optimal intra prediction mode for the luma component, and the corresponding cost function value.

In step S173, the chroma intra-screen prediction unit 153 performs the intra-screen prediction processing on the chroma component of the reference image supplied from the component separation unit 151. Specifically, the chroma intra-screen prediction unit 153 generates the chroma component of the predicted image by performing the intra-screen prediction of all intra prediction modes being candidates by using the chroma component of the reference image supplied from the component separation unit 151. Also, the chroma intra-screen prediction unit 153 calculates the cost function value by using the chroma component of the multiplexed image to be encoded, which is supplied from the component separation unit 151, and the chroma component of the predicted image, and determines the intra prediction mode, whose cost function value is minimum, as the optimal intra prediction mode for the chroma component.

The chroma intra-screen prediction unit 153 supplies the component combining unit 155 with the chroma component of the predicted image generated in the optimal intra prediction mode for the chroma component, the optimal intra prediction mode for the chroma component, and the corresponding cost function value. Also, the chroma intra-screen prediction unit 153 supplies the depth intra-screen prediction unit 154 with the optimal intra prediction mode for the chroma component.

In step S174, the depth intra-screen prediction unit 154 sets the optimal intra prediction mode for the chroma component, which is supplied from the chroma intra-screen prediction unit 153, as the optimal intra prediction mode for the depth component, and performs the intra-screen prediction processing on the depth component of the reference image from the component separation unit 151.

Specifically, the depth intra-screen prediction unit 154 generates the depth component of the predicted image by performing the intra-screen prediction of the optimal intra prediction mode for the depth component, which is the optimal intra prediction mode for the chroma component, by using the depth component of the reference image supplied from the component separation unit 151. Also, the depth intra-screen prediction unit 154 calculates the cost function value by using the depth component of the multiplexed image to be encoded, which is supplied from the component separation unit 151, and the depth component of the predicted image. The depth intra-screen prediction unit 154 supplies the component combining unit 155 with the depth component of the predicted image and the cost function value.

In step S175, the component combining unit 155 combines the luma component of the predicted image from the luma intra-screen prediction unit 152, the chroma component of the predicted image from the chroma intra-screen prediction unit 153, and the depth component of the predicted image from the depth intra-screen prediction unit 154. The component combining unit 155 supplies the selection unit 136 of FIG. 19 with the predicted image obtained as a result of the synthesis, the luma component and the chroma component of the predicted image, and the cost function value of the depth component. Then, the processing returns to step S133 of FIG. 31 and proceeds to step S134.

FIG. 34 is a flow chart describing details of the motion compensation processing step S135 of FIG. 31.

In step S191 of FIG. 34, the component separation unit 171 of the motion compensation unit 134 (FIG. 21) separates the luma component, the chroma component, and the depth component of the reference image supplied from the addition unit 130 of FIG. 19. The component separation unit 171 supplies the luma motion compensation unit 173 with the luma component of the reference image, and supplies the chroma motion compensation unit 174 with the chroma component. Also, the component separation unit 171 supplies the depth motion compensation unit 175 with the depth component of the reference image.

In step S192, the luma motion compensation unit 173 performs the motion compensation processing of the luma component by reading the luma component of the reference picture through the component separation unit 171, based on the optimal inter prediction mode and the motion vector supplied from the motion information conversion unit 172. The luma motion compensation unit 173 supplies the component combining unit 176 with the luma component of the resultant predicted image.

In step S193, the motion information conversion unit 172 converts the motion vector, based on the luma component of the color image, the chroma component of the color image, and the resolution of the after-resolution-conversion depth image. The motion information conversion unit 172 supplies the chroma motion compensation unit 174 and the depth motion compensation unit 175 with the after-conversion motion vector and the optimal intra prediction mode.

In step S194, the chroma motion compensation unit 174 performs the motion compensation processing of the chroma component by reading the chroma component of the reference picture through the component separation unit 171, based on the optimal inter prediction mode and the motion vector supplied from the motion information conversion unit 172. The chroma motion compensation unit 174 supplies the component combining unit 176 with the chroma component of the resultant predicted image.

In step S195, the depth motion compensation unit 175 performs the motion compensation processing of the depth component by reading the depth component of the reference picture through the component separation unit 171, based on the optimal inter prediction mode and the motion vector supplied from the motion information conversion unit 172. The depth motion compensation unit 175 supplies the component combining unit 176 with the depth component of the resultant predicted image.

In step S196, the component combining unit 176 combines the luma component of the predicted image from the luma motion compensation unit 173, the chroma component of the predicted image from the chroma motion compensation unit 174, and the depth component of the predicted image from the depth motion compensation unit 175. The component combining unit 176 supplies the selection unit 136 of FIG. 19 with the predicted image obtained as a result of the synthesis and the cost function value supplied from the motion estimation unit 135 through the motion information conversion unit 172. Then, the processing returns to step S135 of FIG. 31 and proceeds to step S136.

FIG. 35 is a flow chart describing details of the lossless encoding processing of step S143 of FIG. 31.

In step S211 of FIG. 35, the component separation unit 201 of the coefficient encoding unit 191 of the lossless encoding unit 126 separates the coefficient supplied from the quantization unit 125 of FIG. 19 into the luma component, the chroma component, and the depth component. The component separation unit 201 supplies the depth significant coefficient determination unit 202 with the depth component of the coefficient, supplies the luma significant coefficient determination unit 203 with the luma component, and supplies the chroma significant coefficient determination unit 204 with the chroma component.

In step S212, the lossless encoding unit 126 determines whether the optimal prediction mode is the optimal inter prediction mode, that is, whether the motion information is supplied from the motion compensation unit 134. When it is determined in step S212 that the optimal prediction mode is the optimal inter prediction mode, the component separation unit 201 performs encoding by setting the no_residual_data flag and supplies the component combining unit 208 with the no_residual_data flag in step S213. Then, the processing proceeds to step S214.

On the other hand, when it is determined in step S212 that the optimal prediction mode is not the inter prediction mode, that is, when the optimal prediction mode is the intra prediction mode, the processing proceeds to step S214.

In step S214, the depth significant coefficient determination unit 202 determines the significant coefficient flag of the depth component, based on the depth component of the coefficient supplied from the component separation unit 201. Specifically, the depth significant coefficient determination unit 202 determines whether the depth component of the coefficient is 0. When it is determined that the depth component of the coefficient is 0, the depth significant coefficient determination unit 202 determines the significant coefficient flag of the depth component as 0 and supplies the depth coefficient encoding unit 205 with the significant coefficient flag of the depth component. On the other hand, when it is determined that the depth component of the coefficient is not zero, the depth significant coefficient determination unit 202 determines the significant coefficient flag of the depth component as 1 and supplies the depth coefficient encoding unit 205 with the significant coefficient flag of the depth component and the depth component of the coefficient.

In step S215, the depth coefficient encoding unit 205 determines whether the significant coefficient flag of the depth component supplied from the depth significant coefficient determination unit 202 is 1. When it is determined in step S215 that the significant coefficient flag of the depth component is 1, the depth coefficient encoding unit 205 performs the lossless encoding on the depth component of the coefficient supplied from the depth significant coefficient determination unit 202 in step S216. The depth coefficient encoding unit 205 supplies the component combining unit 208 with the lossless-encoded depth component of the coefficient and the significant coefficient flag of the depth component as the depth component of the coefficient encoding stream, and the processing proceeds to step S218.

On the other hand, when it is determined in step S215 that the significant coefficient flag of the depth component is not 1, that is, when the significant coefficient flag of the depth component is 0, the processing proceeds to step S217. In step S217, the depth coefficient encoding unit 205 supplies the component combining unit 208 with the significant coefficient flag of the depth component as the depth component of the coefficient encoding stream, and the processing proceeds to step S218.

In step S218, as in the depth significant coefficient determination unit 202, the luma significant coefficient determination unit 203 determines the significant coefficient flag of the luma component, based on the luma component of the coefficient supplied from the component separation unit 201, and supplies the luma coefficient encoding unit 206 with the significant coefficient flag of the luma component. Also, as in the depth significant coefficient determination unit 202, if necessary, the luma significant coefficient determination unit 203 supplies the luma coefficient encoding unit 206 with the luma component of the coefficient.

In step S219, the luma coefficient encoding unit 206 determines whether the significant coefficient flag of the luma component supplied from the luma significant coefficient determination unit 203 is 1. When it is determined in step S219 that the significant coefficient flag of the luma component is 1, the luma coefficient encoding unit 206 performs the lossless encoding on the luma component of the coefficient supplied from the luma significant coefficient determination unit 203 in step S220. The luma coefficient encoding unit 206 supplies the component combining unit 208 with the lossless-encoded luma component of the coefficient and the significant coefficient flag of the luma component as the luma component of the coefficient encoding stream, and the processing proceeds to step S222.

On the other hand, when it is determined in step S219 that the significant coefficient flag of the luma component is not 1, the luma coefficient encoding unit 206 supplies the component combining unit 208 with the significant coefficient flag of the luma component as the luma component of the coefficient encoding stream in step S221. Then, the processing proceeds to step S222.

In step S222, as in the depth significant coefficient determination unit 202, the chroma significant coefficient determination unit 204 determines the significant coefficient flag of the chroma component, based on the chroma component of the coefficient supplied from the component separation unit 201, and supplies the chroma coefficient encoding unit 207 with the significant coefficient flag of the chroma component. Also, as in the depth significant coefficient determination unit 202, if necessary, the chroma significant coefficient determination unit 204 supplies the chroma coefficient encoding unit 207 with the chroma component of the coefficient.

In step S223, the chroma coefficient encoding unit 207 determines whether the significant coefficient flag of the chroma component supplied from the chroma significant coefficient determination unit 204 is 1. When it is determined in step S223 that the significant coefficient flag of the chroma component is 1, the chroma coefficient encoding unit 207 performs the lossless encoding on the chroma component of the coefficient supplied from the chroma significant coefficient determination unit 204 in step S224. The chroma coefficient encoding unit 207 supplies the component combining unit 208 with the lossless-encoded chroma component of the coefficient and the significant coefficient flag of the chroma component as the chroma component of the coefficient encoding stream, and the processing proceeds to step S226.

On the other hand, when it is determined in step S223 that the significant coefficient flag of the chroma component is not 1, the chroma coefficient encoding unit 207 supplies the component combining unit 208 with the significant coefficient flag of the chroma component as the chroma component of the coefficient encoding stream in step S225. Then, the processing proceeds to step S226.

In step S226, the component combining unit 208 combines the luma component of the coefficient encoding stream from the luma coefficient encoding unit 206, the chroma component of the coefficient encoding stream from the chroma coefficient encoding unit 207, and the depth component of the coefficient encoding stream from the depth coefficient encoding unit 205. Also, when the encoding stream of the no_residual_data flag is supplied from the component separation unit 201, the component combining unit 208 includes the no_residual_data flag in the coefficient encoding stream obtained as a result of the synthesis. The component combining unit 208 supplies the output unit 193 with the coefficient encoding stream.

In step S227, the output unit 193 supplies the accumulation buffer 127 of FIG. 19 with the coefficient encoding stream supplied from the component combining unit 208 and the information encoding stream supplied from the information encoding unit 192 as the multiplexed image encoding stream. Then, the processing returns to step S143 of FIG. 31 and proceeds to step S144 of FIG. 32.

In this manner, the encoding apparatus 80 encodes the multiplexed image by sharing the optimal intra prediction mode or the optimal inter prediction mode and the motion vector as the information (encoding parameter) related to the encoding of the chroma component and the depth component of the multiplexed image. Therefore, the information quantity of the intra-screen prediction information or the motion information of the multiplexed image is reduced, improving the coding efficiency. Also, in the case where the multiview 3D image is an image in which a depth-direction position of a still image or an image of an object shifted in parallel with respect to a camera is not relatively changed, the correlation between the motion vectors of the color image and the depth image is strong. Therefore, the encoding efficiency is further improved.

Furthermore, since the encoding methods of the chroma component and the depth component of the multiplexed image are identical, it is easy to expand from the conventional encoding method of the color image to the encoding method of the multiplexed image.

[Example of Configuration of Decoding Apparatus]

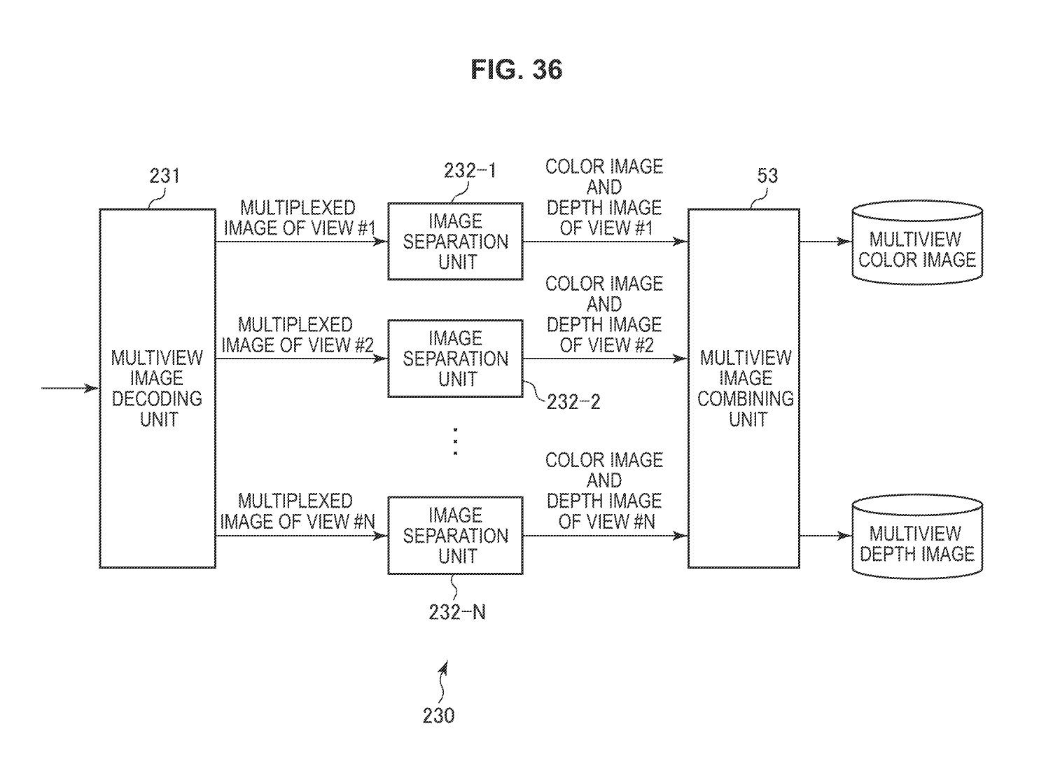

FIG. 36 is a block diagram illustrating an example of a configuration of the decoding apparatus that decodes the multiplexed image encoding stream output by the encoding apparatus 80 of FIG. 16.

In the configuration illustrated in FIG. 36, the same reference numerals are assigned to the same configuration as that of FIG. 12. A redundant description will be appropriately omitted.

The configuration of the decoding apparatus 230 of FIG. 36 differs from the configuration of FIG. 12 in that, instead of the multiview image decoding unit 51 and the image separation units 52-1 to 52-N, a multiview image decoding unit 231 and image separation units 232-1 to 232-N are provided.

The multiview image decoding unit 231 of the decoding apparatus 230 decodes the multiplexed image encoding stream received from the encoding apparatus 80 at each view in accordance with the scheme corresponding to the HEVC scheme or the like. The multiview image decoding unit 231 supplies the image separation units 232-1 to 232-N with the multiplexed image of each view, which is obtained as a result of the decoding. Specifically, the multiview image decoding unit 231 supplies the image separation unit 232-1 with the multiplexed image of view #1. Subsequently, in the similar manner, the multiview image decoding unit 231 supplies the image separation units 232-2 to 232-N with the multiplexed images of views #2 to #N at each view, respectively.

Each of the image separation units 232-1 to 232-N performs the separation processing by setting the luma component and the chroma component of the multiplexed image supplied from the multiview image decoding unit 231 as the luma component and the chroma component of the color image and setting the after-resolution-conversion depth component as the depth image. Each of the image separation units 232-1 to 232-N supplies the multiview image synthesis unit 53 with the color image and the depth image of each view, which are obtained as a result of the separation processing.

Also, in the following, when there is no particular need to distinguish the image separation units 232-1 to 232-N, they will be collectively referred to as the image separation unit 232.

[Example of Configuration of Multiview Image Decoding Unit]

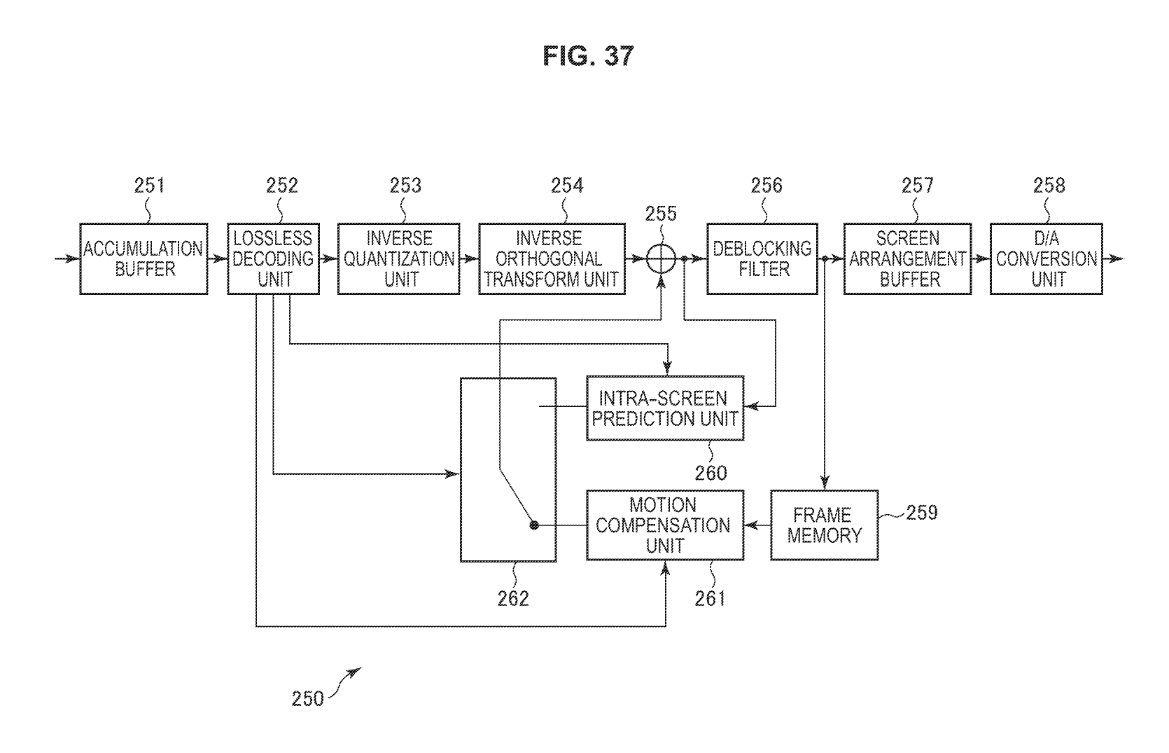

FIG. 37 is a block diagram illustrating an example of a configuration of the decoding unit that decodes the multiplexed image encoding stream of one arbitrary view in the multiview image decoding unit 231 of FIG. 36. That is, the multiview image decoding unit 231 includes N decoding units 250 of FIG. 37.

The decoding unit 250 of FIG. 37 includes an accumulation buffer 251, a lossless decoding unit 252, an inverse quantization unit 253, an inverse orthogonal transform unit 254, an addition unit 255, a deblocking filter 256, a screen arrangement buffer 257, a D/A conversion unit 258, a frame memory 259, an intra-screen prediction unit 260, a motion compensation unit 261, and a switch 262.

The accumulation buffer 251 of the decoding unit 250 receives and accumulates the multiplexed image encoding stream of a predetermined view transmitted from the encoding apparatus 80 of FIG. 16. The accumulation buffer 251 supplies the lossless decoding unit 252 with the accumulated multiplexed image encoding stream.

The lossless decoding unit 252 obtains the quantized coefficient by performing the lossless decoding, such as a variable length decoding or an arithmetic decoding, on the coefficient encoding stream among the multiplexed image encoding streams from the accumulation buffer 251. The lossless decoding unit 252 supplies the inverse quantization unit 253 with the quantized coefficient. Also, the lossless decoding unit 252 decodes the information encoding stream among the multiplexed image encoding streams.

When the intra-screen prediction information is obtained as a result of the decoding of the information encoding stream, the lossless decoding unit 252 supplies the intra-screen prediction unit 260 with the intra-screen prediction information, and also notifies the switch 262 that the optimal prediction mode is the intra prediction mode. On the other hand, when the motion information is obtained as a result of the decoding of the information encoding stream, the lossless decoding unit 252 supplies the motion compensation unit 261 with the motion information, and also notifies the switch 262 that the optimal prediction mode is the inter prediction mode.

The inverse quantization unit 253, the inverse orthogonal transform unit 254, the addition unit 255, the deblocking filter 256, the frame memory 259, the intra-screen prediction unit 260, and the motion compensation unit 261 perform the same processing as the inverse quantization unit 128, the inverse orthogonal transform unit 129, the addition unit 130, the deblocking filter 131, the frame memory 132, the intra-screen prediction unit 133, and the motion compensation unit 134 of FIG. 19, respectively. In this manner, the coefficient encoding stream is decoded.

Specifically, the inverse quantization unit 253 inversely quantizes the quantized coefficient from the lossless decoding unit 252, and supplies the inverse orthogonal transform unit 254 with the resultant coefficient.

The inverse orthogonal transform unit 254 performs the inverse orthogonal transform, such as an inverse discrete cosine transform or an inverse Karhunen-Loeve transform, on the coefficient from the inverse quantization unit 253, and supplies the addition unit 255 with the resultant residual information.

The addition unit 255 adds the residual information as the image to be decoded, which is supplied from the inverse orthogonal transform unit 254, to the predicted image, which is supplied from the switch 262, supplies the deblocking filter 256 with the resultant multiplexed image, and also supplies the intra-screen prediction unit 260 with the multiplexed image as the reference image. Also, when the predicted image is not supplied from the switch 262, the addition unit 255 supplies the deblocking filter 256 with the multiplexed image, which is the residual information supplied from the inverse orthogonal transform unit 254, and also supplies the intra-screen prediction unit 260 with the multiplexed image as the reference image.

The deblocking filter 256 removes a block distortion by filtering the multiplexed image supplied from the addition unit 255. The deblocking filter 256 supplies the frame memory 259 with the resultant multiplexed image, accumulates the multiplexed image therein, and supplies the screen arrangement buffer 257 with the multiplexed image. The multiplexed image accumulated in the frame memory 259 is supplied to the motion compensation unit 261 as the reference image.

The screen arrangement buffer 257 stores the multiplexed image supplied from the deblocking filter 256 on a frame basis. The screen arrangement buffer 257 arranges the frame-based multiplexed image of the order for the stored encoding, in the original display order, and supplies the D/A conversion unit 258 with the arranged frame-based multiplexed image.

The D/A conversion unit 258 performs the D/A conversion on the frame-based multiplexed image supplied from the screen arrangement buffer 257, and outputs the D/A-converted frame-based multiplexed image as the multiplexed image of a predetermined view.

The intra-screen prediction unit 260 generates the predicted image by performing the intra-screen prediction of the optimal intra prediction mode, which is represented by the intra-screen prediction information supplied from the lossless decoding unit 252, by using the reference image supplied from the addition unit 255. The intra-screen prediction unit 260 supplies the switch 262 with the predicted image.

The motion compensation unit 261 performs the motion compensation processing by reading the reference image from the frame memory 259, based on the motion information supplied from the lossless decoding unit 252. The motion compensation unit 261 supplies the switch 262 with the resultant predicted image.

When it is notified from the lossless decoding unit 252 that the optimal prediction mode is the intra prediction mode, the switch 262 supplies the addition unit 255 with the predicted image supplied from the intra-screen prediction unit 260. On the other hand, when it is notified from the lossless decoding unit 252 that the optimal prediction mode is the inter prediction mode, the predicted image supplied from the motion compensation unit 261 is supplied to the addition unit 255.

[Example of Configuration of Lossless Decoding Unit]

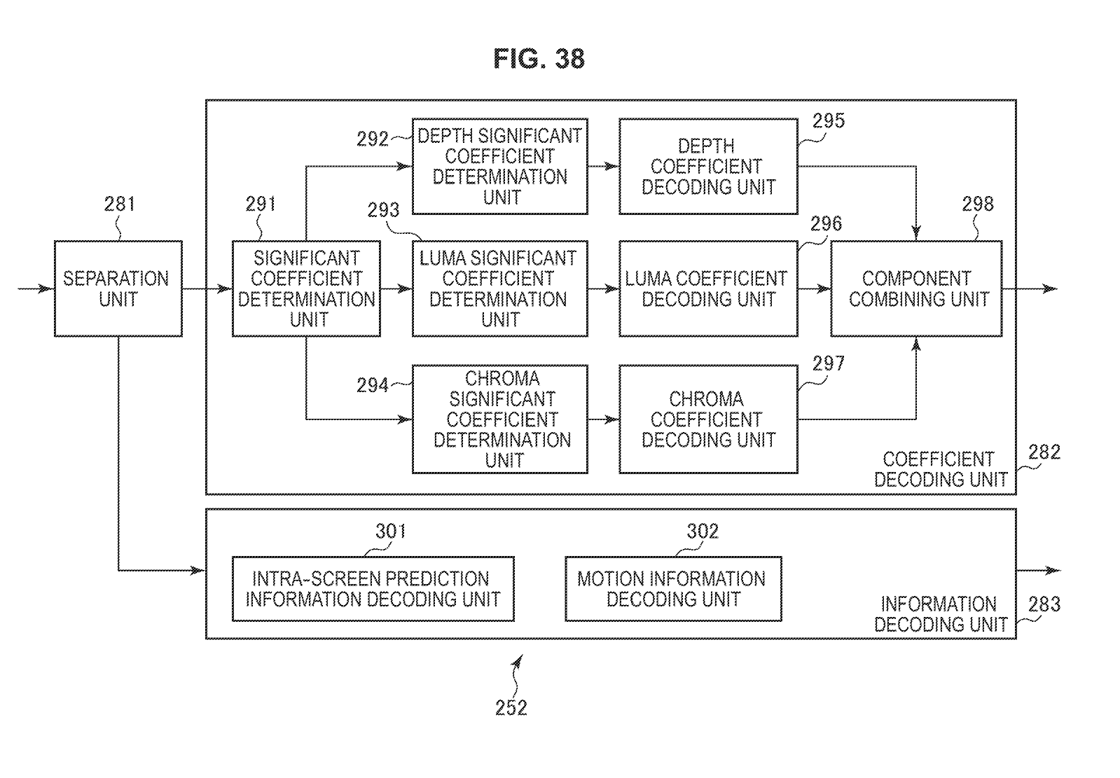

FIG. 38 is a block diagram illustrating an example of a configuration of the lossless decoding unit 252 of FIG. 37.

The lossless decoding unit 252 of FIG. 38 includes a separation unit 281, a coefficient decoding unit 282, and an information decoding unit 283.

The separation unit 281 of the lossless decoding unit 252 separates the multiplexing stream supplied from the accumulation buffer 251 of FIG. 37 into the coefficient encoding stream and the information encoding stream. The separation unit 281 supplies the coefficient decoding unit 282 with the coefficient encoding stream, and supplies the information decoding unit 283 with the information encoding stream.

The coefficient decoding unit 282 includes a significant coefficient determination unit 291, a depth significant coefficient determination unit 292, a luma significant coefficient determination unit 293, a chroma significant coefficient determination unit 294, a depth coefficient decoding unit 295, a luma coefficient decoding unit 296, a chroma coefficient decoding unit 297, and a component combining unit 298.

Also, when the no_residual_data flag is included in the coefficient encoding stream supplied from the separation unit 281, the significant coefficient determination unit 291 of the coefficient decoding unit 282 determines whether the no_residual_data flag is 0. When the no_residual_data flag is 0, or when the no_residual_data flag is not included in the coefficient encoding stream, the significant coefficient determination unit 291 separates the coefficient encoding stream into the depth component, the luma component, and the chroma component. The significant coefficient determination unit 291 supplies the depth significant coefficient determination unit 292 with the depth component of the coefficient encoding stream, supplies the luma significant coefficient determination unit 293 with the luma component, and supplies the chroma significant coefficient determination unit 294 with the chroma component.

The depth significant coefficient determination unit 292 determines whether the significant coefficient flag of the depth component included in the depth component of the coefficient encoding stream supplied from the significant coefficient determination unit 291 is 1. When it is determined that the significant coefficient flag of the depth component is 1, the depth significant coefficient determination unit 292 supplies the depth coefficient decoding unit 295 with the lossless-encoded depth component of the coefficient included in the depth component of the coefficient encoding stream.

Since the luma significant coefficient determination unit 293 and the chroma significant coefficient determination unit 294 perform the same processing as the depth significant coefficient determination unit 292, except that the components to be processed are the luma component and the chroma component, respectively, their description will be omitted.

The depth coefficient decoding unit 295 performs the lossless decoding on the lossless-encoded depth component of the coefficient supplied from the depth significant coefficient determination unit 292, and supplies the component combining unit 298 with the resultant depth component of the coefficient.

Since the luma coefficient decoding unit 296 and the chroma coefficient decoding unit 297 perform the same processing as the depth coefficient decoding unit 295, except that the components to be processed are the luma component and the chroma component, respectively, their description will be omitted.

The component combining unit 298 combines the depth component of the coefficient from the depth coefficient decoding unit 295, the luma component of the coefficient from the luma coefficient decoding unit 296, and the chroma component of the coefficient from the chroma coefficient decoding unit 297. In this case, the coefficient of each component, which is not supplied, becomes 0. Therefore, when the no_residual_data flag is 1, all components of the coefficient of the coding unit of the uppermost layer become 0. Also, the component of the coefficient of the coding unit, in which the significant coefficient flag of a predetermined component is 0, becomes 0. The component combining unit 298 supplies the inverse quantization unit 253 of FIG. 37 with the after-synthesis coefficient.

The information decoding unit 283 includes an intra-screen prediction information decoding unit 301 and a motion information decoding unit 302.

When the information encoding stream supplied from the separation unit 281 is the encoding stream of the intra-screen prediction information, the intra-screen prediction information decoding unit 301 of the information decoding unit 283 decodes the information encoding stream and obtains the intra-screen prediction information. The intra-screen prediction information decoding unit 301 supplies the intra-screen prediction unit 260 (FIG. 37) with the obtained intra-screen prediction information, and also supplies the switch 262 with the effect that the optimal prediction mode is the intra prediction mode.

When the information encoding stream supplied from the separation unit 281 is the encoding stream, the motion information decoding unit 302 decodes the information encoding stream and obtains the motion information. The motion information decoding unit 302 supplies the motion compensation unit 261 (FIG. 37) with the obtained motion information, and also supplies the switch 262 with the effect that the optimal prediction mode is the inter prediction mode.

[Example of Configuration of Intra-Screen Prediction Unit]

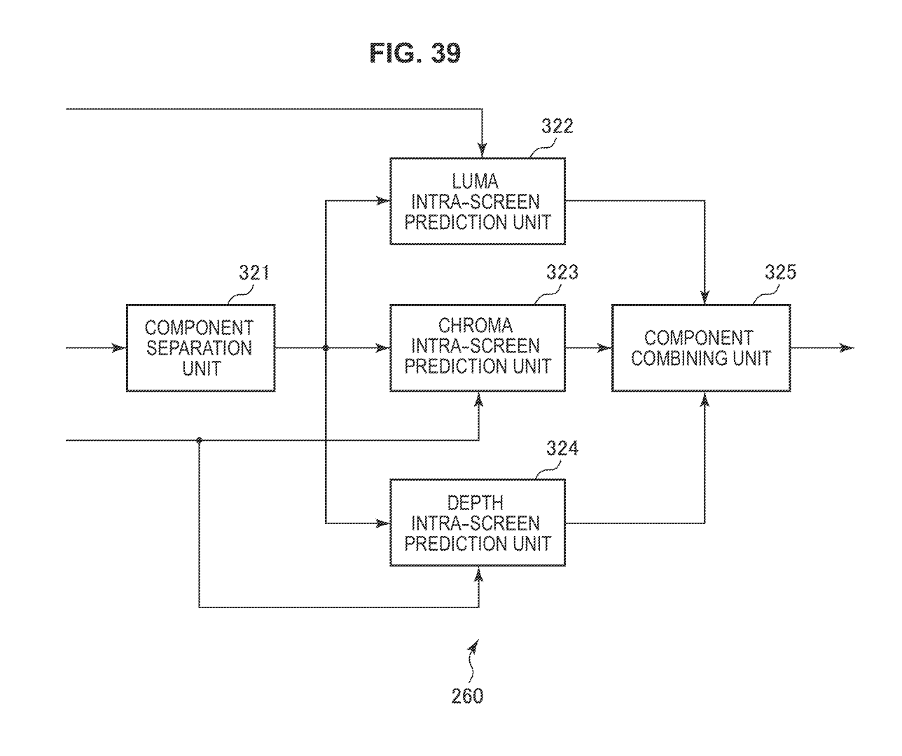

FIG. 39 is a block diagram illustrating an example of a configuration of the intra-screen prediction unit 260 of FIG. 37.

The intra-screen prediction unit 260 of FIG. 39 includes a component separation unit 321, a luma intra-screen prediction unit 322, a chroma intra-screen prediction unit 323, a depth intra-screen prediction unit 324, and a component combining unit 325.

The component separation unit 321 of the intra-screen prediction unit 260 separates the luma component, the chroma component, and the depth component of the reference image supplied from the addition unit 255 of FIG. 37. The component separation unit 321 supplies the luma intra-screen prediction unit 322 with the luma components of the reference image, and supplies the chroma intra-screen prediction unit 323 with the chroma component. Also, the component separation unit 321 supplies the depth intra-screen prediction unit 324 with the depth component of the reference image.

The luma intra-screen prediction unit 322 performs the intra-screen prediction of the optimal intra prediction mode, which is represented by the intra-screen prediction information for the luma component supplied from the lossless decoding unit 252 of FIG. 37, by using the luma component of the reference image supplied from the component separation unit 321. The luma intra-screen prediction unit 322 supplies the component combining unit 325 with the luma component of the resultant predicted image.

The chroma intra-screen prediction unit 323 performs the intra-screen prediction of the optimal intra prediction mode, which is represented by the intra-screen prediction information for the chroma component supplied from the lossless decoding unit 252 of FIG. 37, by using the chroma component of the reference image supplied from the component separation unit 321. The chroma intra-screen prediction unit 323 supplies the component combining unit 325 with the chroma component of the resultant predicted image.

The depth intra-screen prediction unit 324 sets the optimal intra prediction mode, which is represented by the intra-screen prediction information for the chroma component supplied from the lossless decoding unit 252 of FIG. 37, as the optimal intra prediction mode for the depth component. That is, the depth intra-screen prediction unit 324 shares the optimal intra prediction mode with the chroma intra-screen prediction unit 323. The depth intra-screen prediction unit 324 generates the depth component of the predicted image by performing the intra-screen prediction of the optimal intra prediction mode for the depth component, by using the depth component of the reference image supplied from the component separation unit 321. The depth intra-screen prediction unit 324 supplies the component combining unit 325 with the depth component of the predicted image.

The component combining unit 325 combines the luma component of the predicted image from the luma intra-screen prediction unit 322, the chroma component of the predicted image from the chroma intra-screen prediction unit 323, and the depth component of the predicted image from the depth intra-screen prediction unit 324. The component combining unit 325 supplies the switch 262 of FIG. 37 with the predicted image, which is obtained as a result of the synthesis.

[Example of Configuration of Motion Compensation Unit]

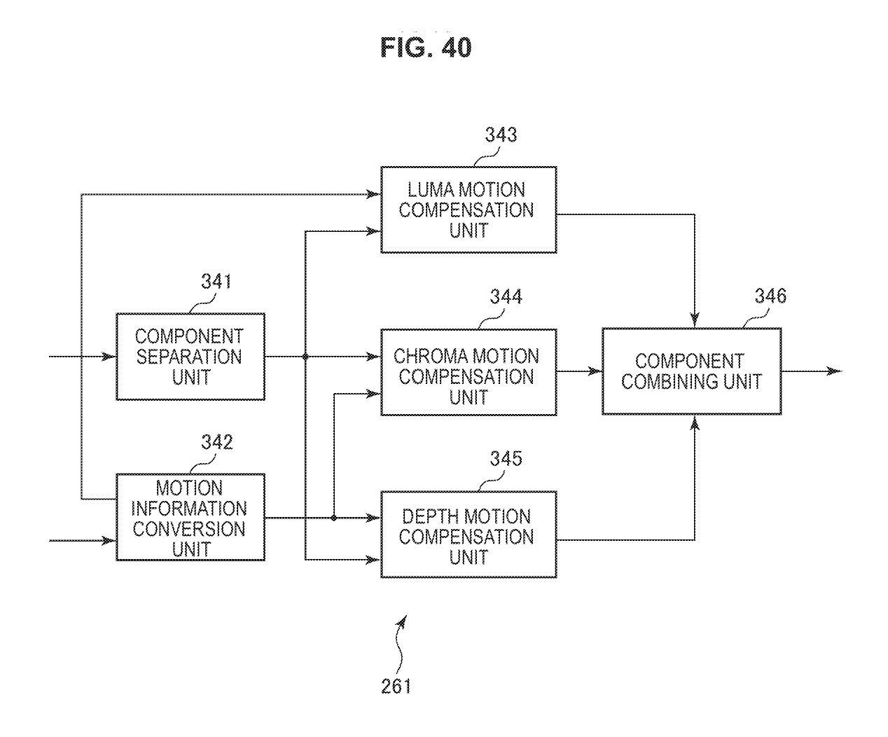

FIG. 40 is a block diagram illustrating an example of a configuration of the motion compensation unit 261 of FIG. 37.

The motion compensation unit 261 of FIG. 40 includes a component separation unit 341, a motion information conversion unit 342, a luma motion compensation unit 343, a chroma motion compensation unit 344, a depth motion compensation unit 345, and a component combining unit 346.

The component separation unit 341 of the motion compensation unit 261 separates the luma component, the chroma component, and the depth component of the reference image supplied from the addition unit 255 of FIG. 37. The component separation unit 341 supplies the luma motion compensation unit 343 with the luma component of the reference image, and supplies the chroma motion compensation unit 344 with the chroma component. Also, the component separation unit 341 supplies the depth motion compensation unit 345 with the depth component of the reference image.

The motion information conversion unit 342 supplies the luma motion compensation unit 343 with the motion information supplied from the lossless decoding unit 252 of FIG. 37. Also, as in the motion information conversion unit 172 of FIG. 21, the motion information conversion unit 342 converts the motion vector of the motion information, based on the luma component of the color image, the chroma component of the color image, and the resolution of the after-resolution-conversion depth image. The motion information conversion unit 342 supplies the chroma motion compensation unit 344 and the depth motion compensation unit 345 with the after-conversion motion vector and the optimal inter prediction mode.

The luma motion compensation unit 343 performs the motion compensation processing by reading the luma component of the reference picture through the motion information conversion unit 342, based on the motion information supplied from the component separation unit 341, and obtains the luma component of the predicted image. The luma motion compensation unit 343 supplies the component combining unit 346 with the luma component of the predicted image.

The chroma motion compensation unit 344 performs the motion compensation by reading the chroma component of the reference picture through the component separation unit 341, based on the optimal inter prediction mode and the after-conversion motion vector supplied from the motion information conversion unit 342. That is, the chroma motion compensation unit 344 performs the motion compensation processing by sharing the optimal inter prediction mode and the motion vector with the luma motion compensation unit 343. The chroma motion compensation unit 344 supplies the component combining unit 346 with the chroma component of the resultant predicted image.

The depth motion compensation unit 345 performs the motion compensation by reading the depth component of the reference picture through the component separation unit 341, based on the optimal inter prediction mode and the after-conversion motion vector supplied from the motion information conversion unit 342. That is, the depth motion compensation unit 345 performs the motion compensation processing by sharing the optimal inter prediction mode and the motion vector with the luma motion compensation unit 343. The depth motion compensation unit 345 supplies the component combining unit 346 with the depth component of the resultant predicted image.

The component combining unit 346 combines the luma component of the predicted image from the luma motion compensation unit 343, the chroma component of the predicted image from the chroma motion compensation unit 344, and the depth component of the predicted image from the depth motion compensation unit 345. The component combining unit 346 supplies the switch 262 of FIG. 37 with the predicted image, which is obtained as a result of the synthesis.

[Example of Configuration of Image Separation Unit]

FIG. 41 is a block diagram illustrating an example of a configuration of the image separation unit 232 of FIG. 36.

The image separation unit 232 of FIG. 41 includes a component separation processing unit 361 and a resolution conversion processing unit 362.

The component separation processing unit 361 of the image separation unit 232 separates the luma component, the chroma component, and the depth component of the multiplexed image of a predetermined view from the multiview image decoding unit 231 of FIG. 36. The component separation processing unit 361 generates the color image of a predetermined view by setting the separated luma component of the multiplexed image of the predetermined view as the luma component and combining the separated chroma component of the multiplexed image as the chroma component. The component separation processing unit 361 supplies the multiview image synthesis unit 53 of FIG. 36 with the color image of the predetermined view. Also, the component separation processing unit 361 supplies the resolution conversion processing unit 362 with the separated depth component of the multiplexed image of the predetermined view.

The resolution conversion processing unit 362 performs conversion such that the resolution of the depth component of the multiplexed image of the predetermined view, which is supplied from the component separation processing unit 361, becomes equal to the resolution of the luma component of the color image of the predetermined view. The resolution conversion processing unit 362 generates the after-resolution-conversion depth component as the depth image of the predetermined view, and supplies the multiview image synthesis unit 53 with the after-resolution-conversion depth component.

[Description of Processing of Decoding Apparatus]

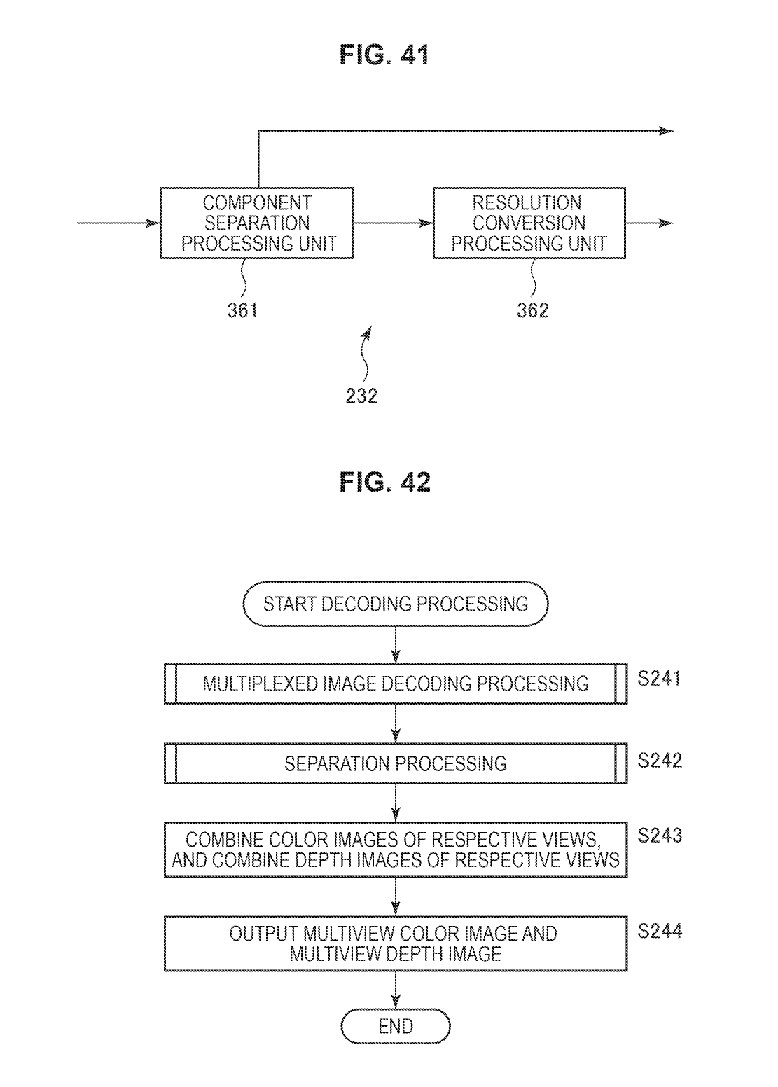

FIG. 42 is a flow chart describing decoding processing by the decoding apparatus 230 of FIG. 36. The decoding processing is started, for example, when the multiplexed image encoding stream is input from the encoding apparatus 80 of FIG. 16.

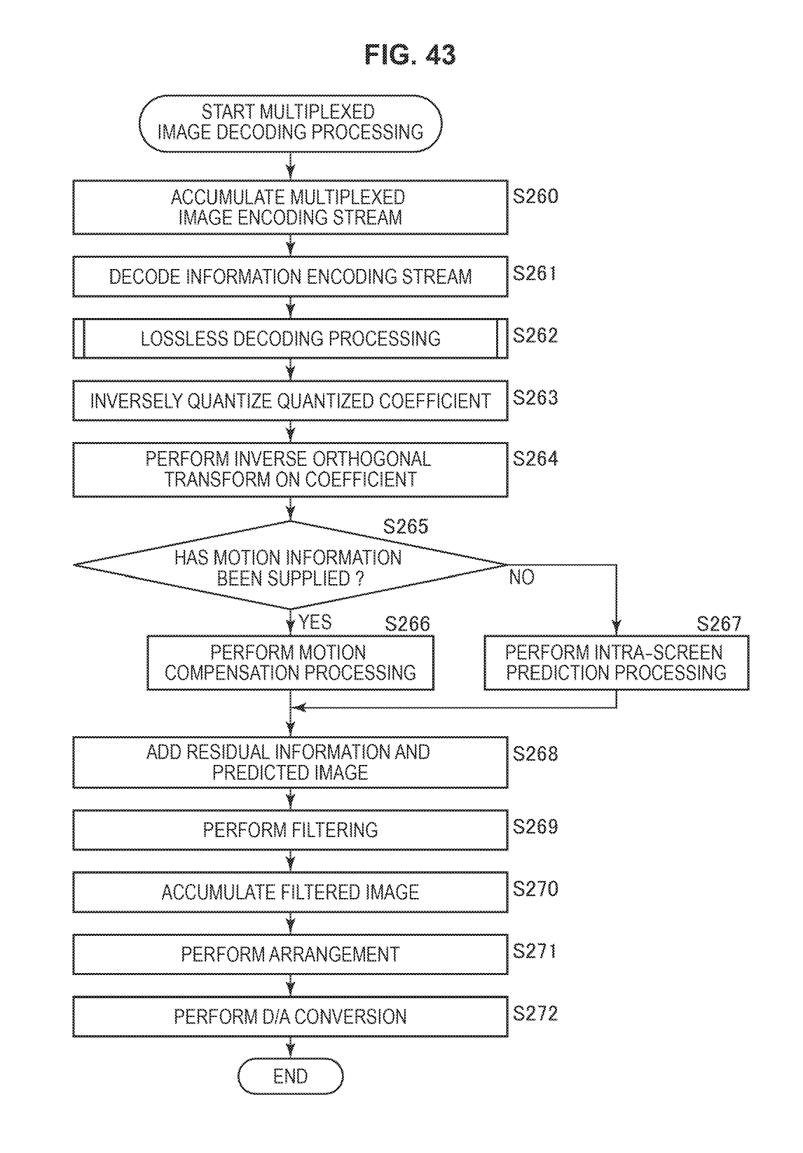

In step S241 of FIG. 42, the multiview image decoding unit 231 of the decoding apparatus 230 performs the multiplexed image decoding processing to decode the multiplexed image encoding stream received from the encoding apparatus 80 of FIG. 16 at each view in accordance with the scheme corresponding to the HEVC scheme or the like. Details of the multiplexed image decoding processing will be described below with reference to FIG. 43.

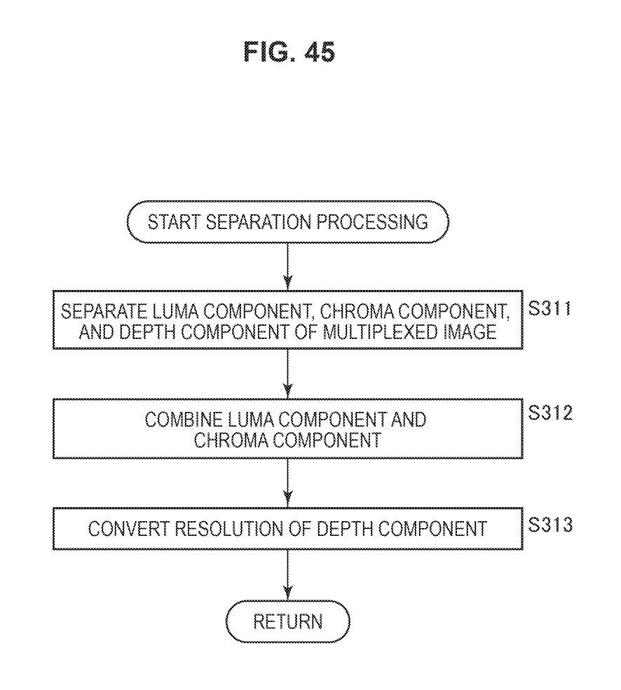

In step S242, the image separation unit 232 performs the separation processing to separate the multiplexed image supplied from the multiview image decoding unit 231 into the color image and the depth image. Details of the separation processing will be described below with reference to FIG. 45.

Since the processing of steps S243 and S244 is identical to the processing of steps S53 and S54 of FIG. 14, its description will be omitted.

FIG. 43 is a flow chart describing details of the multiplexed image decoding processing of step S241 of FIG. 42. The multiplexed image decoding processing is performed at each view.

In step S260 of FIG. 43, the accumulation buffer 251 of the decoding unit 250 receives and accumulates the multiplexed image encoding stream of a predetermined view transmitted from the encoding apparatus 80 of FIG. 16. The accumulation buffer 251 supplies the lossless decoding unit 252 with the accumulated multiplexed image encoding stream.

In step S261, the information decoding unit 283 of the lossless decoding unit 252 (FIG. 38) decodes the information encoding stream among the multiplexed image encoding streams supplied from the accumulation buffer 251 through the separation unit 281.

Specifically, when the information encoding stream is the encoding stream of the intra-screen prediction information, the intra-screen prediction information decoding unit 301 decodes the information encoding stream and supplies the intra-screen prediction unit 260 with the resultant intra-screen prediction information. Also, the intra-screen prediction information decoding unit 301 supplies the switch 262 with the effect that the optimal prediction mode is the intra prediction mode.

On the other hand, when the information encoding stream is the encoding stream, the motion information decoding unit 302 decodes the information encoding stream and supplies the intra-screen prediction unit 260 with the resultant motion information. Also, the motion information decoding unit 302 supplies the switch 262 with the effect that the optimal prediction mode is the inter prediction mode.

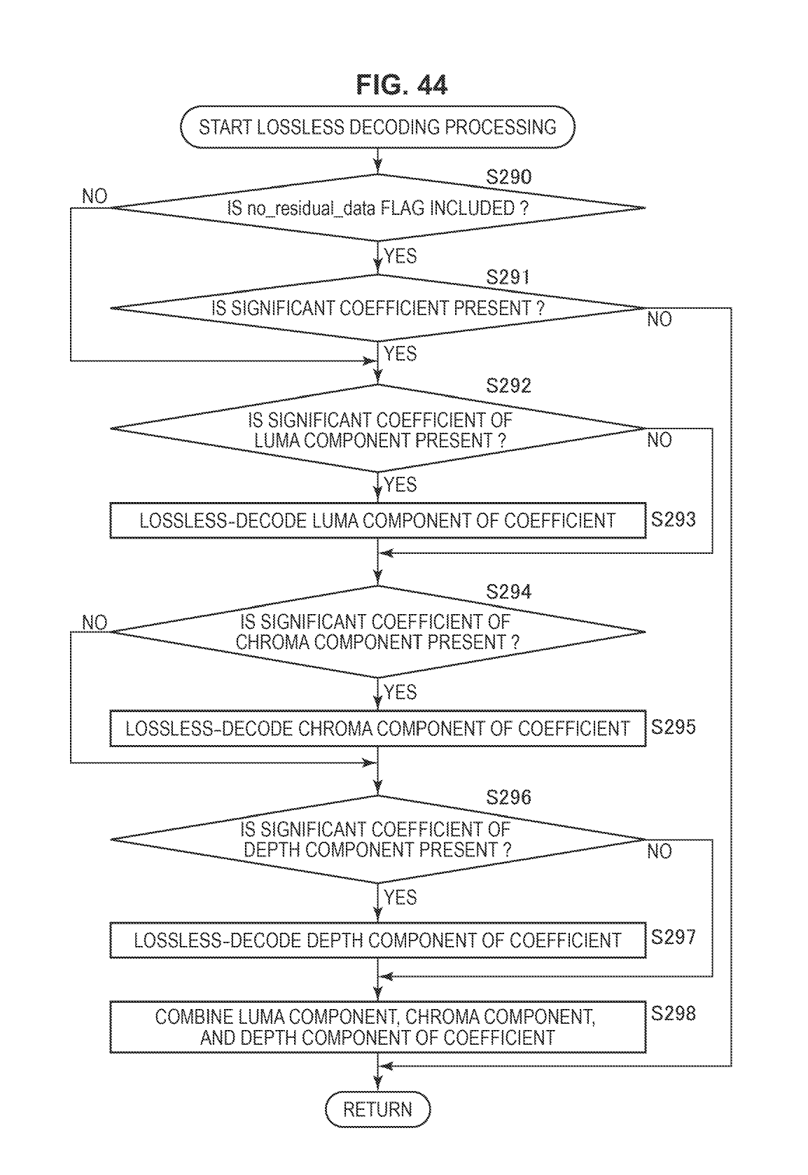

In step S262, the coefficient decoding unit 282 of the lossless decoding unit 252 (FIG. 38) performs the lossless decoding processing to lossless-decode the coefficient encoding stream among the multiplexed image encoding streams supplied from the accumulation buffer 251 through the separation unit 281. Details of the lossless decoding processing will be described below with reference to FIG. 44.

In step S263, the inverse quantization unit 253 inversely quantizes the quantized coefficient from the lossless decoding unit 252, and supplies the inverse orthogonal transform unit 254 with the resultant coefficient.

In step S264, the inverse orthogonal transform unit 254 performs the inverse orthogonal transform on the coefficient from the inverse quantization unit 253, and supplies the addition unit 255 with the resultant residual information.

In step S265, the motion compensation unit 261 determines whether the motion information is supplied from the motion information decoding unit 302 of the lossless decoding unit 252 (FIG. 38). When it is determined in step S265 that the motion information has been supplied, the processing proceeds to step S266.

In step S266, the motion compensation unit 261 performs the motion compensation processing by reading the reference image from the frame memory 259, based on the motion information. Since the motion compensation processing is identical to the motion compensation processing of FIG. 34, except that the cost function value is not supplied and is not output, a detailed description thereof will be omitted. The motion compensation unit 261 supplies the predicted image, which is generated as a result of the motion compensation processing, to the addition unit 255 through the switch 262, and the processing proceeds to step S268.

On the other hand, when it is determined in step S265 that the motion information has not been supplied, that is, when the intra-screen prediction information is supplied from the intra-screen prediction information decoding unit 301 (FIG. 38), the processing proceeds to step S267.

In step S267, the intra-screen prediction unit 260 performs the intra-screen prediction processing of the optimal intra prediction mode, which is represented by the intra-screen prediction information, by using the reference image supplied from the addition unit 255. Since the intra-screen prediction processing is identical to the intra-screen prediction processing of FIG. 33, except that only the intra-screen prediction of the optimal intra prediction mode is performed and the optimal intra prediction mode is not determined by calculating the cost function value, a detailed description thereof will be omitted. The intra-screen prediction unit 260 supplies the resultant predicted image to the addition unit 255 through the switch 262, and the processing proceeds to step S268.

In step S268, the addition unit 255 adds the residual information supplied from the inverse orthogonal transform unit 254 to the predicted image supplied from the switch 262. The addition unit 255 supplies the deblocking filter 256 with the resultant multiplexed image, and also supplies the intra-screen prediction unit 260 with the multiplexed image as the reference image.

In step S269, the deblocking filter 256 removes a block distortion by filtering the multiplexed image supplied from the addition unit 255.

In step S270, the deblocking filter 256 supplies the frame memory 259 with the filtered multiplexed image, accumulates the filtered multiplexed image therein, and also supplies the screen arrangement buffer 257 with the filtered multiplexed image. The multiplexed image accumulated in the frame memory 259 is supplied to the motion compensation unit 261 as the reference image.

In step S271, the screen arrangement buffer 257 stores the multiplexed image supplied from the deblocking filter 256 on a frame basis, arranges the stored frame-based multiplexed image of the order for the encoding, in the original display order, and supplies the D/A conversion unit 258 with the arranged frame-based multiplexed image.

In step S272, the D/A conversion unit 258 performs the D/A conversion on the frame-based multiplexed image supplied from the screen arrangement buffer 257, and outputs the D/A-converted frame-based multiplexed image to the image separation unit 232 of FIG. 36 as the multiplexed image of a predetermined view.

FIG. 44 is a flow chart describing details of the lossless decoding processing of step S262 of FIG. 43.

In step S290 of FIG. 44, the significant coefficient determination unit 291 of the coefficient decoding unit 282 determines whether the no_residual_data flag is included in the coefficient encoding stream supplied from the separation unit 281.

In step S290, when it is determined in step S290 that the no_residual_data flag is included in the coefficient encoding stream, the processing proceeds to step S291. In step S291, the significant coefficient determination unit 291 determines whether the significant coefficient is present among the coefficients of all components of the coding unit of the uppermost layer, that is, whether the no_residual_data flag is 0.

When it is determined in step S291 that the significant coefficient is present among the coefficients of all components of the coding unit of the uppermost layer, or when it is determined in step S290 that the no_residual_data flag is not included in the coefficient encoding stream, the significant coefficient determination unit 291 separates the coefficient encoding stream into the depth component, the luma component, and the chroma component. The significant coefficient determination unit 291 supplies the depth significant coefficient determination unit 292 with the depth component of the coefficient encoding stream, supplies the luma significant coefficient determination unit 293 with the luma component, and supplies the chroma significant coefficient determination unit 294 with the chroma component.

In step S292, the luma significant coefficient determination unit 293 determines whether the significant coefficient of the luma component is present, based on the significant coefficient flag of the luma component included in the luma component of the coefficient encoding stream supplied from the significant coefficient determination unit 291.

When the significant coefficient flag of the luma component is 1, the luma significant coefficient determination unit 293 determines in step S292 that the significant coefficient of the luma component is present, and supplies the luma coefficient decoding unit 296 with the lossless-encoded luma component of the coefficient included in the luma component of the coefficient encoding stream.

In step S293, the luma coefficient decoding unit 296 performs the lossless decoding on the lossless-encoded luma component of the coefficient supplied from the luma significant coefficient determination unit 293, and supplies the component combining unit 298 with the lossless-decoded luma component. Then, the processing proceeds to step S294.

On the other hand, when the significant coefficient flag of the luma component is 0, the luma significant coefficient determination unit 293 determines in step S292 that the significant coefficient of the luma component is not present, and the processing proceeds to step S294.

In step S294, the chroma significant coefficient determination unit 294 determines whether the significant coefficient of the chroma component is present, based on the significant coefficient flag of the chroma component included in the chroma component of the coefficient encoding stream supplied from the significant coefficient determination unit 291.

When the significant coefficient flag of the chroma component is 1, the chroma significant coefficient determination unit 294 determines in step S294 that the significant coefficient of the chroma component is present, and supplies the chroma coefficient decoding unit 297 with the lossless-encoded chroma component of the coefficient included in the chroma component of the coefficient encoding stream.

In step S295, the chroma coefficient decoding unit 297 performs the lossless decoding on the lossless-encoded chroma component of the coefficient supplied from the chroma significant coefficient determination unit 294, and supplies the component combining unit 298 with the lossless-decoded chroma component. Then, the processing proceeds to step S296.

On the other hand, when the significant coefficient flag of the chroma component is 0, the chroma significant coefficient determination unit 294 determines in step S294 that the significant coefficient of the chroma component is not present, and the processing proceeds to step S296.

In step S296, the depth significant coefficient determination unit 292 determines whether the significant coefficient of the depth component is present, based on the significant coefficient flag of the depth component included in the depth component of the coefficient encoding stream supplied from the significant coefficient determination unit 291.

When the significant coefficient flag of the depth component is 1, the depth significant coefficient determination unit 292 determines in step S296 that the significant coefficient of the depth component is present, and supplies the depth coefficient decoding unit 295 with the lossless-encoded depth component of the coefficient included in the depth component of the coefficient encoding stream.

In step S297, the depth coefficient decoding unit 295 performs the lossless decoding on the lossless-encoded depth component of the coefficient supplied from the depth significant coefficient determination unit 292, and supplies the component combining unit 298 with the lossless-decoded depth component. Then, the processing proceeds to step S298.

On the other hand, when the significant coefficient flag of the depth component is 0, the depth significant coefficient determination unit 292 determines in step S296 that the significant coefficient of the depth component is not present, and the processing proceeds to step S298.

In step S298, the component combining unit 298 combines the luma component of the coefficient from the luma coefficient decoding unit 296, the chroma component of the coefficient from the chroma coefficient decoding unit 297, and the depth component of the coefficient from the depth coefficient decoding unit 295. In this case, the coefficient of each component, which is not supplied, is 0. The component combining unit 298 supplies the inverse quantization unit 253 of FIG. 37 with the after-synthesis coefficient, and the processing returns to step S262 of FIG. 43. Then, the processing proceeds to step S263.

FIG. 45 is a flow chart describing the separation processing of step S242 of FIG. 42.

In step S311 of FIG. 45, the component separation processing unit 361 of the image separation unit 232 (FIG. 41) separates the luma component, the chroma component, and the depth component of the multiplexed image of a predetermined view from the multiview image decoding unit 231. Also, the component separation processing unit 361 supplies the resolution conversion processing unit 362 with the separated depth component of the multiplexed image of the predetermined view.

In step S312, the component separation processing unit 361 generates the color image of the predetermined view by setting the separated luma component of the multiplexed image of the predetermined view as the luma component and combining the separated chroma component of the multiplexed image as the chroma component. The component separation processing unit 361 supplies the multiview image synthesis unit 53 of FIG. 36 with the color image of the predetermined view.

In step S313, the resolution conversion processing unit 362 performs conversion such that the resolution of the depth component of the multiplexed image of the predetermined view, which is supplied from the component separation processing unit 361, becomes equal to the resolution of the luma component of the color image of the predetermined view. The resolution conversion processing unit 362 supplies the multiview image synthesis unit 53 with the after-resolution-conversion depth component as the depth image of the predetermined view. Then, the processing returns to step S242 of FIG. 42 and proceeds to step S243.

In this manner, the decoding apparatus 230 performs the encoding by sharing the optimal intra prediction mode or the optimal inter prediction mode and the motion vector as the information related to the encoding of the chroma component and the depth component. Therefore, the decoding apparatus 230 can decode the multiplexed image encoding stream with improved coding efficiency.

### Third Embodiment

[Example of Configuration of Encoding Apparatus]

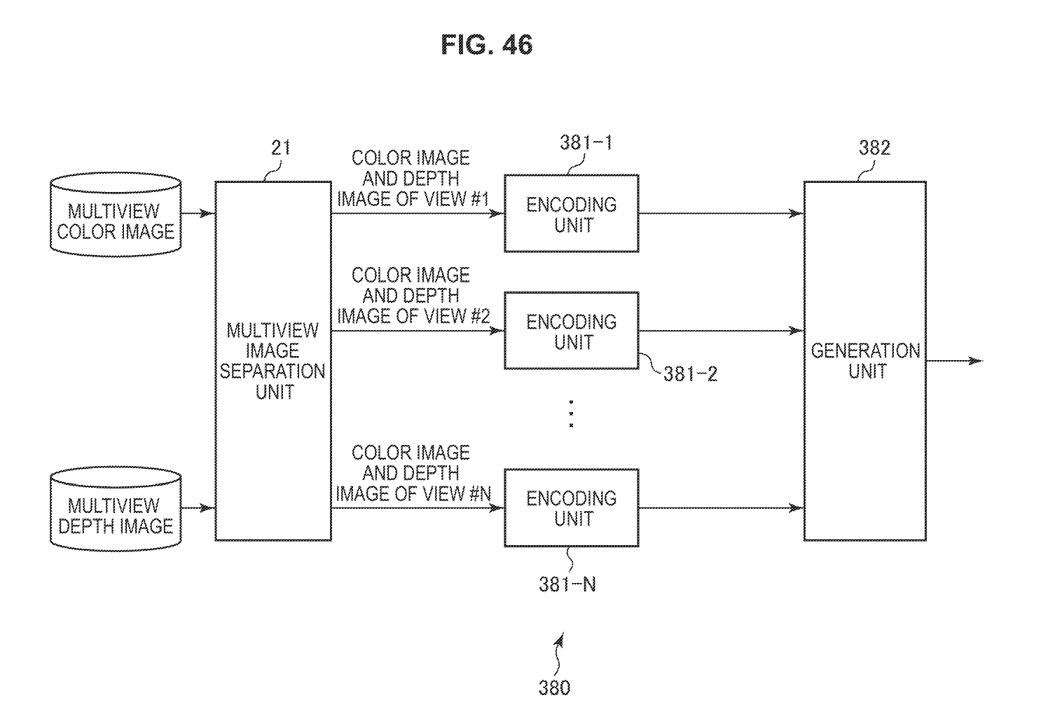

FIG. 46 is a block diagram illustrating an example of a configuration of a third embodiment of an encoding apparatus to which the present technology is applied.

In the configuration illustrated in FIG. 46, the same reference numerals are assigned to the same configuration as that of FIG. 2. A redundant description will be appropriately omitted.

The configuration of the encoding apparatus 380 of FIG. 46 is different from the configuration of FIG. 2 in that, instead of the image multiplexing units 22-1 to 22-N and the multiview image encoding unit 23, image multiplexing units 381-1 to 381-N (N is the number of views of the multiview 3D image, and in the present embodiment, N is an integer equal to or greater than 3), and a generation unit 382 are provided. The encoding apparatus 380 encodes the color image and the depth image by sharing the encoding parameters, and transmits the encoding stream of the color image and the encoding stream of the depth image as separate network abstraction layer (NAL) units.

Specifically, the encoding unit 381-1 of the encoding apparatus 380 encodes the color image of view #1 supplied from the multiview image separation unit 21 as a base image in accordance with the HEVC scheme. Also, the encoding unit 381-1 encodes the depth image of view #1 supplied from the multiview image separation unit 21 in accordance with the scheme corresponding to the HEVC scheme by using the encoding parameter of the luma component or the chroma component of the color image of view #1. The encoding unit 381-1 supplies the generation unit 382 with a slice-based encoding stream of the base image and the depth image obtained as a result of the encoding.

Each of the encoding units 381-2 to 381-N encodes the color image supplied from the multiview image separation unit 21 as a non-base image in accordance with the scheme corresponding to the HEVC scheme. In this case, the base image also is used as the reference image. Also, each of the encoding units 381-2 to 381-N encodes the depth image supplied from the multiview image separation unit 21 in accordance with the scheme corresponding to the HEVC scheme by using the encoding parameter of the luma component or the chroma component of the color image of the corresponding view. In this case, the depth image of the base image also is used as the reference image. The encoding units 381-2 to 381-N supply the generation unit 382 with a slice-based encoding stream of the non-base image and the depth image obtained as a result of the encoding.

Also, in the following, when there is no particular need to distinguish the encoding units 381-1 to 381-N, they will be collectively referred to as the encoding unit 381.

The generation unit 382 generates separate NAL units, respectively, from the slice-based encoding stream of the base image, the non-base image, and the depth image supplied from the encoding unit 381. Specifically, the generation unit 382 generates the NAL units by adding NAL headers, including information representing types of different NAL units (hereinafter, referred to as type information), to the slice-based encoding stream of the base image, the non-base image, and the depth image.

Also, the generation unit 382 generates NAL units of a sequence parameter set (SPS) for the base image, an SPS for the non-base image, an SPS for the depth image, and a picture parameter set (PPS). The generation unit 382 transmits the multiview image encoding stream in which the respective generated NAL units are arranged.

[Example of Configuration of Encoding Unit]

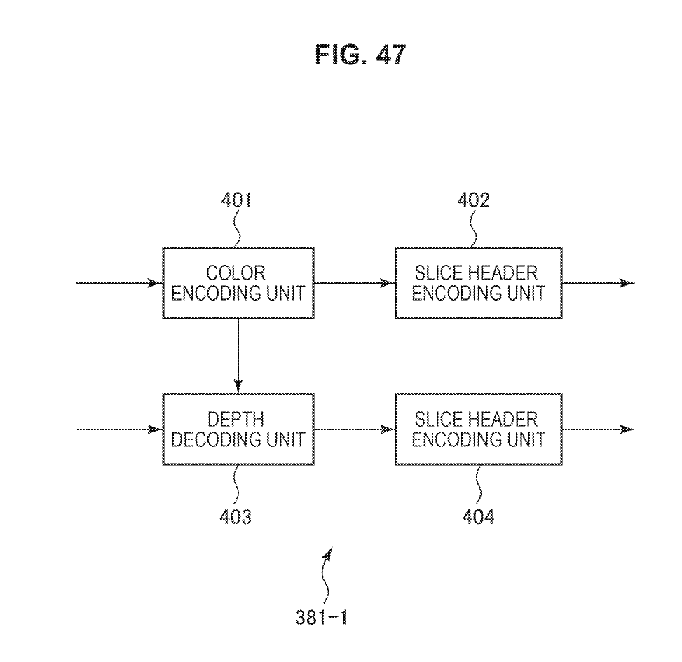

FIG. 47 is a block diagram illustrating an example of a configuration of the encoding unit 381-1 of FIG. 46.

The encoding unit 381-1 of FIG. 47 includes a color encoding unit 401, a slice header encoding unit 402, a depth encoding unit 403, and a slice header encoding unit 404.

The color encoding unit 401 is identical to the encoding unit 120 of FIG. 19, except that the depth component is not present and the motion information and the intra-screen information are supplied to the depth encoding unit 403. Specifically, the color encoding unit 401 encodes the luma component and the chroma component of the base image supplied from the multiview image separation unit 21 of FIG. 46 in accordance with the HEVC scheme. Also, the color encoding unit 401 supplies the depth encoding unit 403 with the motion information or the intra-screen information as the encoding parameters of the luma component and the chroma component used in the encoding.

The slice header encoding unit 402 generates the information related to the slice-based encoding stream of the base image, which is obtained as a result of the encoding by the color encoding unit 401, as the slice header. The slice header encoding unit 402 adds the generated slice header to the slice-based encoding stream of the base image, and supplies the encoding stream to the generation unit 382 of FIG. 46.

The depth encoding unit 403 encodes the depth image of the base image supplied from the multiview image separation unit 21 in accordance with the HEVC scheme by using the motion information or the intra-screen information supplied from the color encoding unit 401. The depth encoding unit 403 supplies the slice header encoding unit 404 with the encoding stream of the depth image of the base image obtained as a result of the encoding.

The slice header encoding unit 404 generates the information related to the slice-based encoding stream of the depth image of the base image, which is supplied from the depth encoding unit 403, as the slice header. The slice header encoding unit 404 adds the generated slice header to the slice-based encoding stream of the depth image of the base image, and supplies the encoding stream to the generation unit 382.

Also, although the illustration is omitted, the configuration of the encoding units 381-2 to 381-N is identical to the configuration of FIG. 47, except that the color encoding unit encodes the non-base image by also referring to the base image and the depth encoding unit encodes the depth image of the non-base image by also referring to the depth image of the base image.

[Example of Configuration of Depth Encoding Unit]

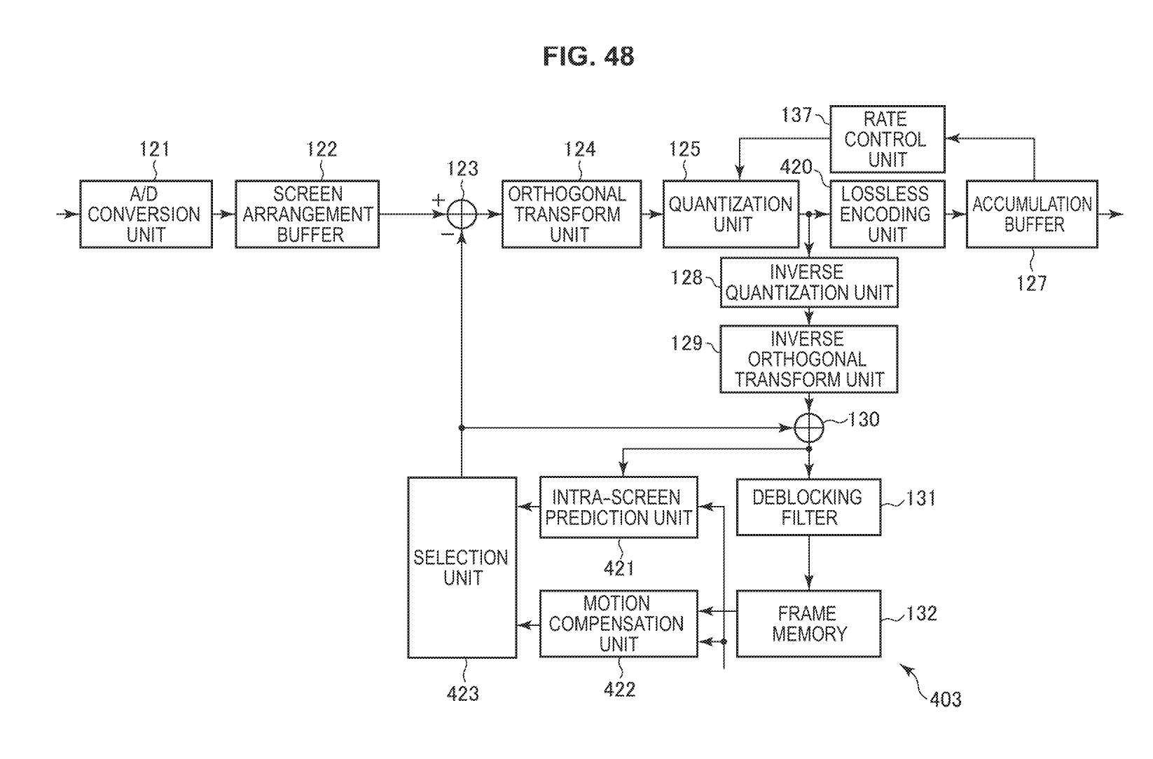

FIG. 48 is a block diagram illustrating an example of a configuration of the depth encoding unit 403 of FIG. 47.

In the configuration illustrated in FIG. 48, the same reference numerals are assigned to the same configuration as that of FIG. 19. A redundant description will be appropriately omitted.

The configuration of the depth encoding unit 403 of FIG. 48 differs from the configuration of FIG. 19 in that, instead of the lossless encoding unit 126, the intra-screen prediction unit 133, the motion compensation unit 134, and the selection unit 136, a lossless encoding unit 420, an intra-screen prediction unit 421, a motion compensation unit 422, and a selection unit 423 are provided, and the motion estimation unit 135 is not provided.

As in the lossless encoding unit 126 of FIG. 19, the lossless encoding unit 420 of the depth encoding unit 403 performs the lossless encoding on the quantized coefficient supplied from the quantization unit 125, supplies the accumulation buffer 127 with the resultant encoding stream, and accumulates the encoding stream in the accumulation buffer 127.

The intra-screen prediction unit 421 selects the intra-screen prediction information of the luma component or the chroma component having the same resolution as the depth image, among pieces of the intra-screen prediction information of the luma component and the chroma component supplied from the color encoding unit 401 of FIG. 47, as the intra-screen prediction information of the depth image. That is, the intra-screen prediction unit 421 functions as a setting unit and sets the intra-screen prediction information to be shared in the luma component or the chroma component of the color image and the depth image.

The intra-screen prediction unit 421 generates the predicted image by performing the intra-screen prediction processing of the optimal intra prediction mode, which is represented by the selected intra-screen prediction information, by using the reference image supplied from the addition unit 130. The intra-screen prediction unit 421 supplies the selection unit 423 with the generated predicted image.

The motion compensation unit 422 selects the motion information of the luma component or the chroma component having the same resolution as the depth image, among pieces of the motion information of the luma component and the chroma component supplied from the color encoding unit 401. That is, the motion compensation unit 422 functions as a setting unit and sets the motion information to be shared in the luma component or the chroma component of the color image and the depth image.

The motion compensation unit 422 performs the motion compensation processing by reading the reference image from the frame memory 132, based on the optimal inter prediction mode and the motion vector represented by the selected motion information. The motion compensation unit 422 supplies the selection unit 136 with the resultant predicted image.

The selection unit 423 supplies the calculation unit 123 and the addition unit 130 with the predicted image supplied from the intra-screen prediction unit 421 or the motion compensation unit 422.

[Example of Configuration of Generation Unit]

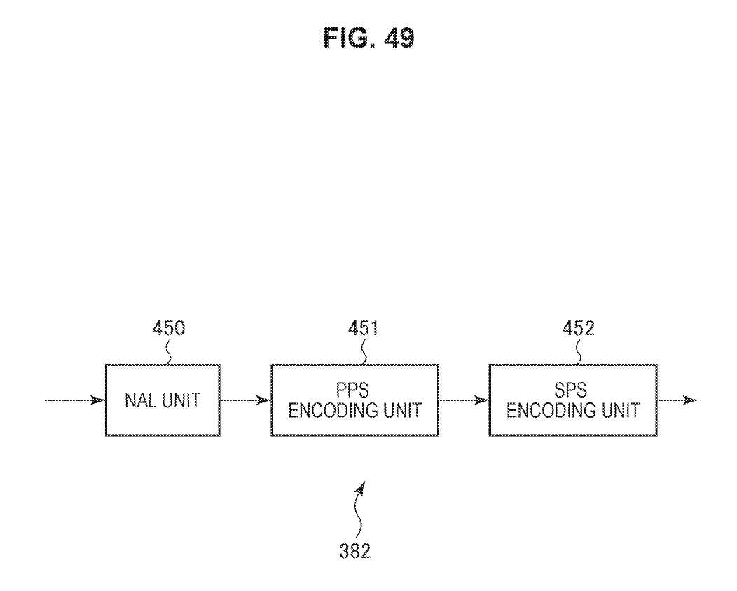

FIG. 49 is a block diagram illustrating an example of a configuration of the generation unit 382 of FIG. 46.

The generation unit 382 of FIG. 49 includes a NAL unit 450, a PPS encoding unit 451, and an SPS encoding unit 452.

The NAL unit 450 of the generation unit 382 functions as a generation unit, generates separate NAL units, respectively, from the slice-based encoding stream of the base image, the non-base image, and the depth image supplied from the encoding unit 381 of FIG. 46, and supplies the PPS encoding unit 451 with the NAL units.

The PPS encoding unit 451 generates the NAL unit of the PPS. The PPS encoding unit 451 adds the NAL unit of the PPS to the NAL unit of the encoding stream supplied from the NAL unit 450, and supplies the SPS encoding unit 452 with the NAL unit.

The SPS encoding unit 452 generates the NAL units of the SPS for the base image, the SPS for the non-base image, and the SPS for the depth image. The SPS encoding unit 452 adds the generated NAL unit of the SPS to the NAL unit supplied from the PPS encoding unit 451, and generates and outputs the multiview image encoding stream.

[Configuration of Multiview Image Encoding Stream]

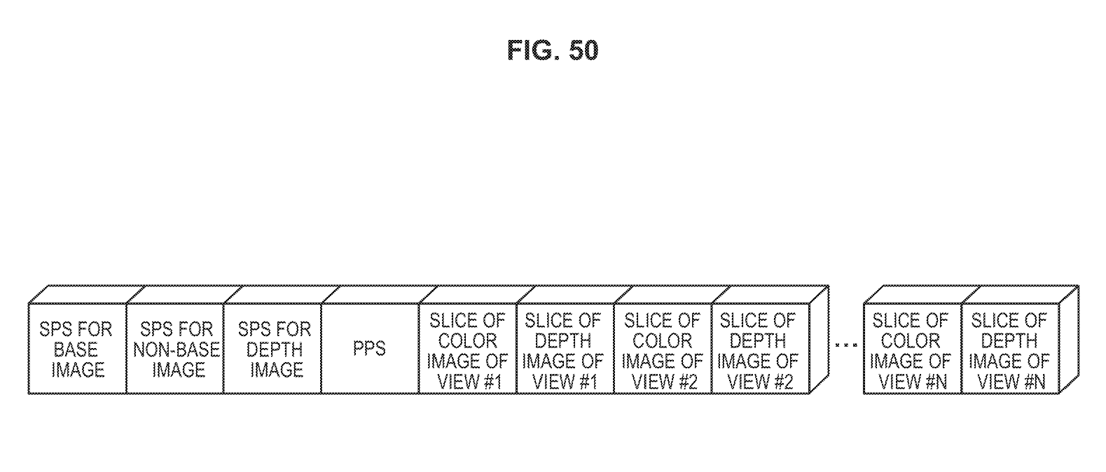

FIG. 50 is a diagram illustrating an example of a configuration of the multiview image encoding stream.

As illustrated in FIG. 50, in the multiview image encoding stream, the NAL units of the SPS for the base image, the SPS for the non-base image, the SPS for the depth image, PPS, the slice-based encoding stream of the color image of view #1, the slice-based encoding stream of the depth image of view #1, the slice-based encoding stream of the color image of view #2, the slice-based encoding stream of the depth image of view #2, . . . , the slice-based encoding stream of the color image of view #N, and the slice-based encoding stream of the depth image of view #N are arranged in order.

[Example of Type Information]

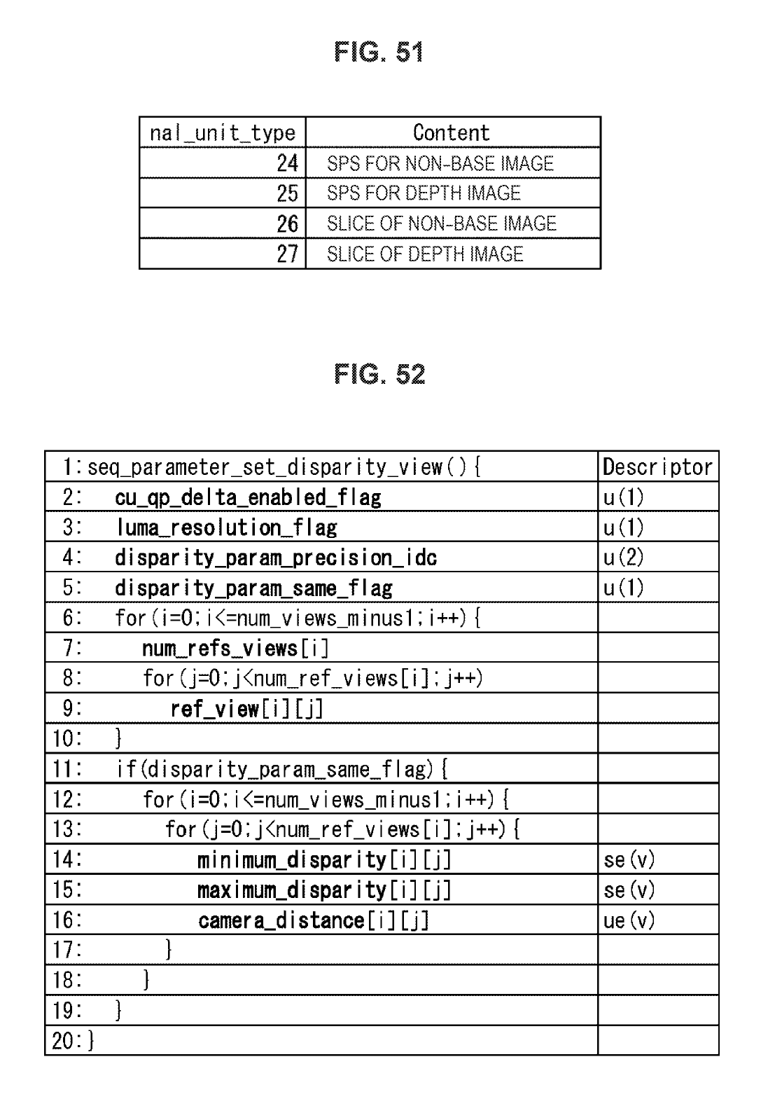

FIG. 51 is a diagram illustrating an example of the type information.

In the example of FIG. 51, the type information included in the NAL header of the SPS for the non-base image is 24, and the type information included in the NAL header of the SPS for the depth image is 25. Also, the type information included in the NAL header of the slice-based encoding stream of the non-base image is 26, and the type information included in the NAL header of the slice-based encoding stream of the depth image is 27.

[Example of Syntax of SPS for Depth Image]

FIG. 52 is a diagram illustrating an example of the syntax of the SPS for the depth image.

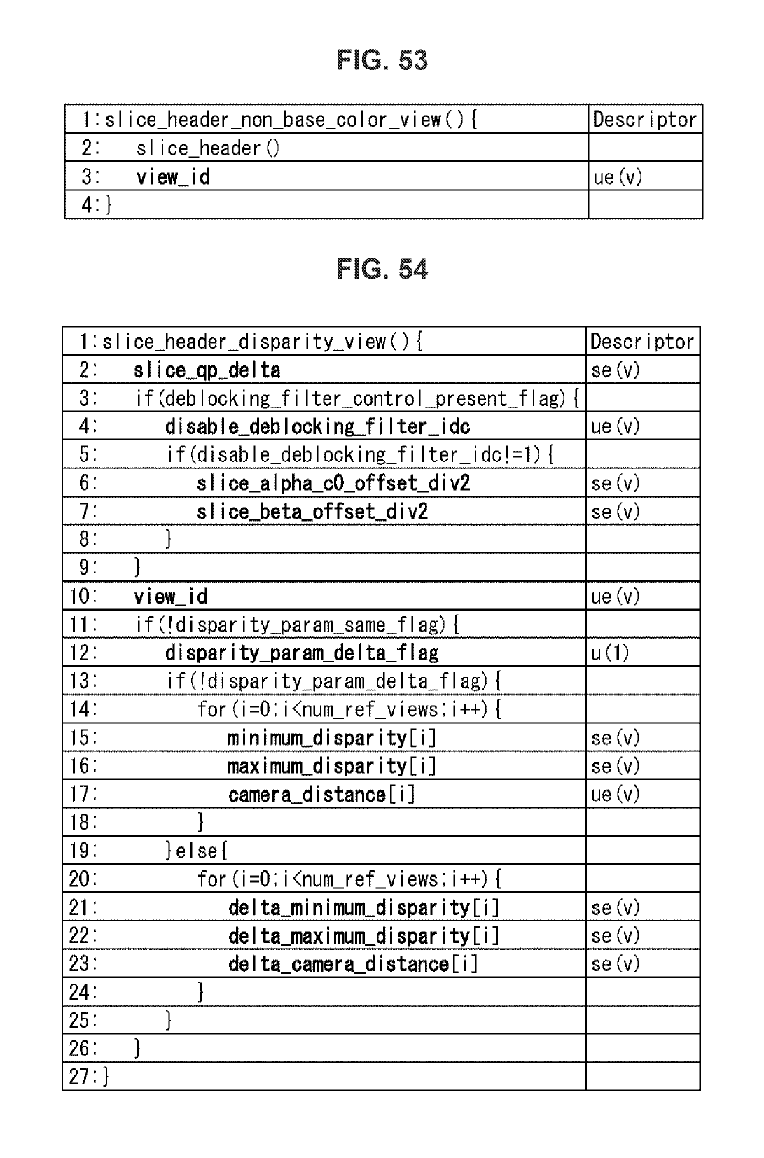

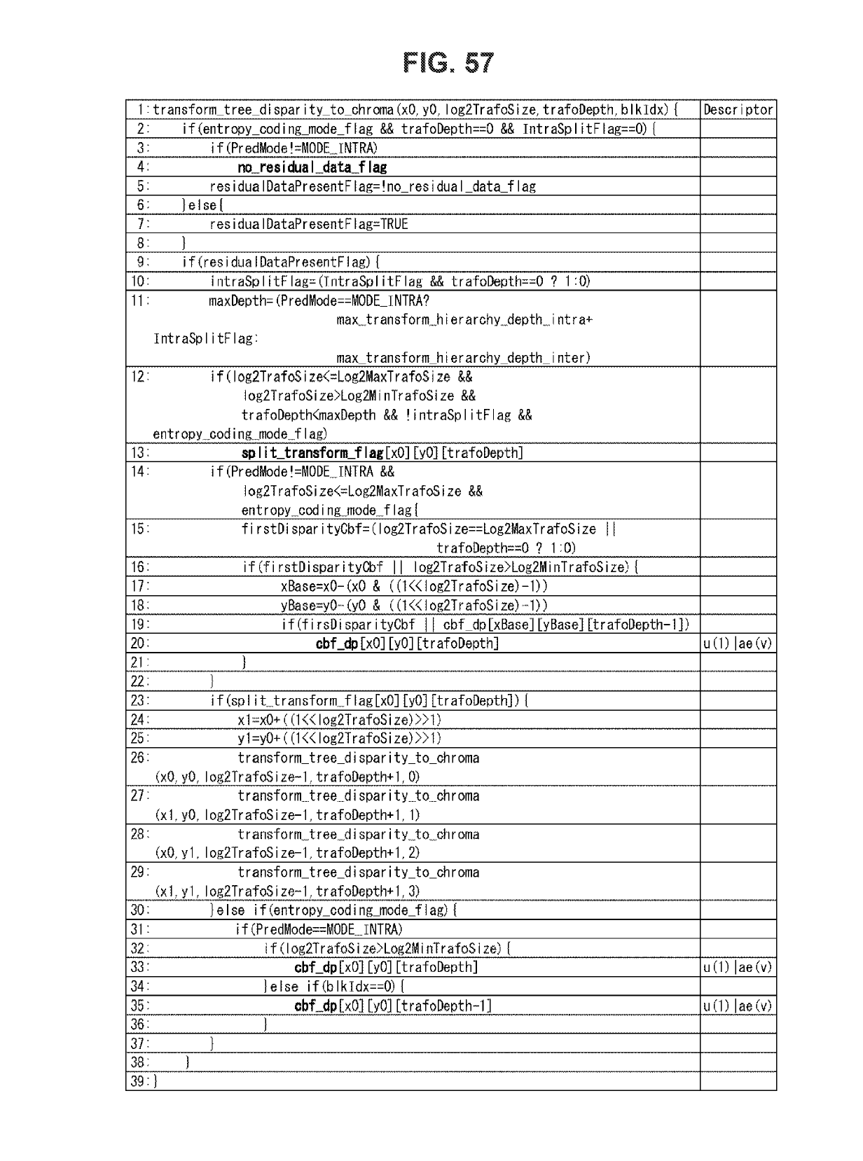

Also, a number on the left side of FIG. 52 represents a line number and is not a part of the syntax. This is the same as in FIGS. 53 and 57, which are to be described below.

As illustrated in the second line of FIG. 52, in the SPS for the depth image, a QP control flag (cu_qp_delta_enabled_flag) representing whether to control a quant parameter (QP) on a coding unit basis is described. In this manner, QPs of the depth image and the color image can be independently controlled.

Also, as illustrated in the third line, in the SPS for the depth image, a resolution flag (luma_resolution_flag) (resolution information) representing whether the resolution of the depth image is equal to the resolution of the luma component of the color image or is equal to the resolution of the chroma component is described. When the resolution of the depth image is equal to the resolution of the luma component of the color image, the resolution flag is assumed as 1, and when the resolution of the depth image is equal to the resolution of the chroma component of the color image, the resolution flag is assumed as 0.

[Example of Syntax of Slice Header of Non-Base Image]

FIG. 53 is a diagram illustrating an example of the syntax of the slice header of the non-base image.

As illustrated in the third line of FIG. 53, in the slice header of the non-base image, a view ID (view_id), which is an ID unique to a corresponding view, is described. The view ID, as described below, is also described in the slice header of the depth image. The non-base image and the depth image, which include the same view ID in the slice header, correspond to each other.

[Example of Syntax of Slice Header of Depth Image]

FIG. 54 is a diagram illustrating an example of the syntax of the slice header of the depth image.

The QPs of the depth image and the color image are independently controlled. Therefore, as illustrated in the second line of FIG. 54, in the slice header of the depth image, a base QP value (slice_qp_delta) representing QP being the base in the slice-based depth image is described.

Also, as illustrated in the third to seventh lines, in the slice header of the depth image, information representing a parameter of the deblocking filter 131 of the depth encoding unit 403 (FIG. 48) is described. In this manner, the deblocking filters of the color image and the depth image can be independently controlled.

Also, in the slice header of the depth image, parameters of in-loop filters, such as an adaptive loop filter (ALF) or a sample adaptive offset (SAO) other than the deblocking filter 131, are described, and the in-loop filters may be independently controlled in the color image and the depth image.

Also, as illustrated in the tenth line, in the slice header of the depth image, view ID is described.

Also, although the illustration is omitted, the view ID is also included in the slice header of the base image. The base image and the depth image, which include the same view ID in the slice header, correspond to each other.

[Example of Syntax of Coding Unit-Based Encoding Stream of Uppermost Layer]

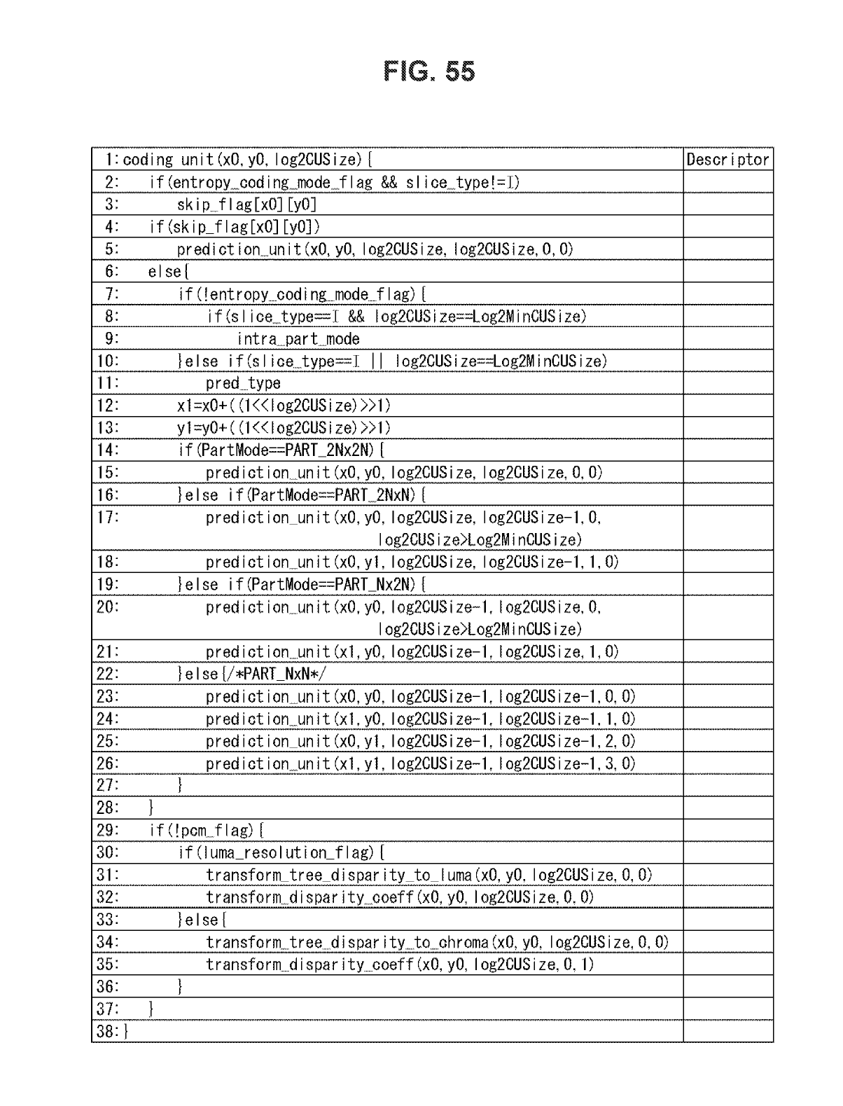

FIG. 55 is a diagram illustrating an example of the syntax of the coding unit (CU)-based encoding stream of the uppermost layer.

As illustrated in the twentieth to thirty-fifth lines of FIG. 55, in the CU-based encoding stream, when the resolution flag (luma_resolution_flag) is 1, information (transform_tree_disparity_to_luma) including the significant coefficient flag of the mode of the significant coefficient flag of the luma component illustrated in FIGS. 23 and 24 (hereinafter, referred to as luma mode significant coefficient information) and CU-based QP (transform_disparity_coeff) are described. On the other hand, when the resolution flag is not 1, information (transform_tree_disparity_to_chroma) including the significant coefficient flag of the mode of the significant coefficient flag of the chroma component illustrated in FIGS. 23 and 24 (hereinafter, referred to as chroma mode significant coefficient information) and CU-based QP (transform_disparity_coeff) are described.

That is, when the resolution of the depth image is equal to the resolution of the luma component, in the CU encoding stream, the luma mode significant coefficient information and the CU-based QP are described. When the resolution of the depth image is equal to the resolution of the chroma component, the chroma mode significant coefficient information and the CU-based QP are described.

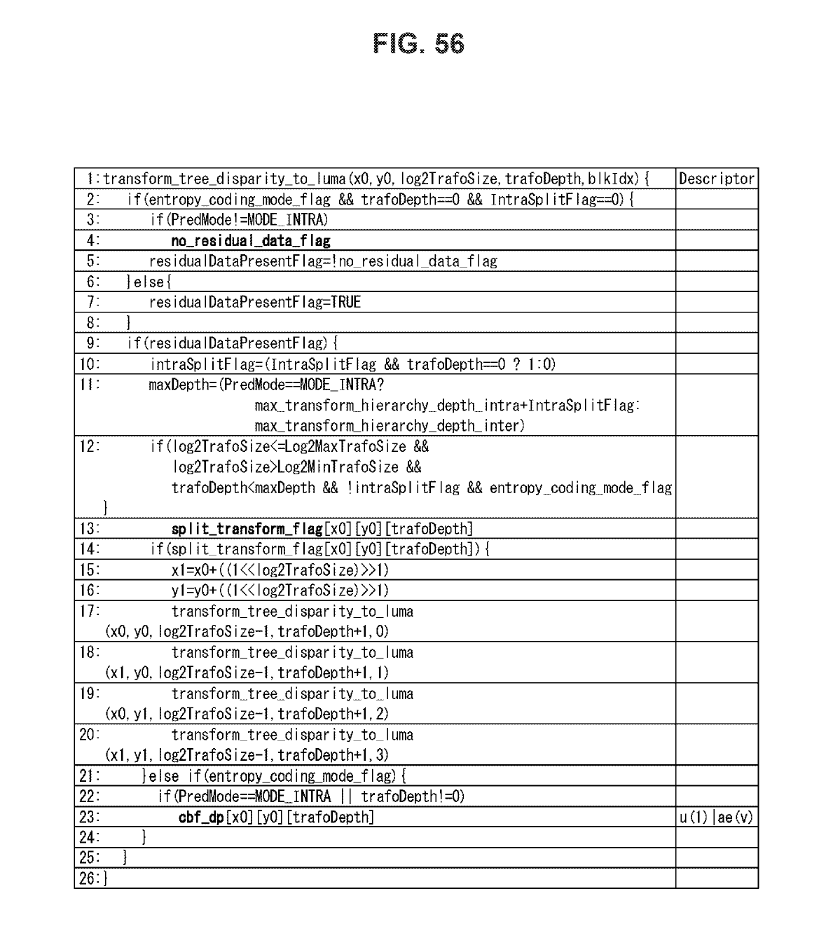

FIG. 56 is a diagram illustrating an example of the syntax of the luma mode significant coefficient information.

As illustrated in the third and fourth lines of FIG. 56, in the luma mode significant coefficient information, when the optimal prediction mode of the luma component of the color image is the optimal inter prediction mode, the no_residual_data flag is described.

Also, as illustrated in the thirteenth to twentieth lines, in the luma mode significant coefficient information, information representing the size of the CU of the lowermost layer is described. Also, as illustrated in the twenty-second and twenty-third lines, when the optimal prediction mode of the luma component of the color image is the intra prediction mode, the significant coefficient flag (cbf_dp) of the CU other than the CU of the uppermost layer of the depth image is described.

FIG. 57 is a diagram illustrating an example of the syntax of the chroma mode significant coefficient information.

As illustrated in the third and fourth lines of FIG. 57, in the chroma mode significant coefficient information, when the optimal prediction mode of the chroma component of the color image is the optimal inter prediction mode, the no_residual_data flag is described.

Also, as illustrated in the fourteenth to twentieth lines, in the chroma mode significant coefficient information, when the optimal prediction mode of the chroma component of the color image is the optimal inter prediction mode, the significant coefficient flag (cbf_dp) of the depth image is described if the significant coefficient flag of the CU of one layer above oneself is 1, or if oneself is the CU of the uppermost layer.

Furthermore, as illustrated in the twenty-third to twenty-ninth lines, in the chroma mode significant coefficient information, information representing the size of the CU of the lowermost layer is described. Also, as illustrated in the thirty-first to thirty-fifth lines, in the chroma mode significant coefficient information, when the optimal prediction mode of the chroma component of the color image is the optimal intra prediction mode, the significant coefficient flag (cbf_dp) of the CU other than the CU of the uppermost layer of the depth image is described.

[Processing of Encoding Apparatus]

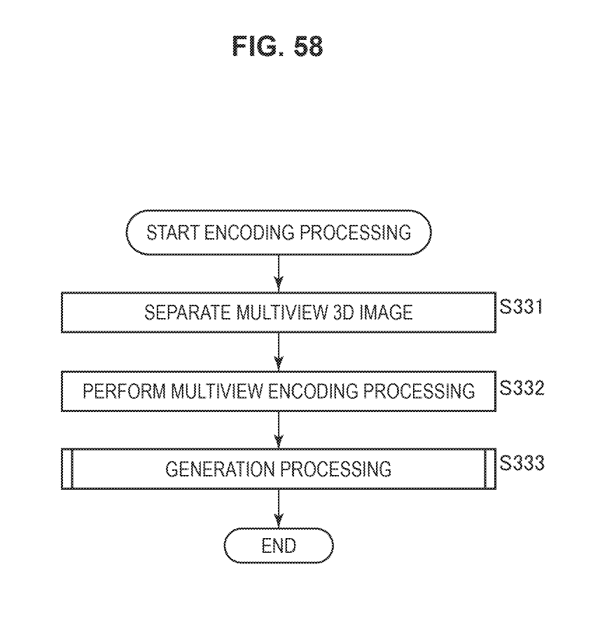

FIG. 58 is a flow chart describing the encoding processing of the encoding apparatus 380 of FIG. 46.

In step S331 of FIG. 58, the multiview image separation unit 21 of the encoding apparatus 380 separates the multiview 3D image input to the encoding apparatus 380, and obtains the color image and the depth image of each view. The multiview image separation unit 21 supplies the encoding unit 381 with the color image and the depth image of each view at each view.

In step S332, the encoding unit 381 performs the multiview encoding processing to encode the color image and the depth image of each view. The encoding unit 381 supplies the generation unit 382 with the slice-based encoding stream of the base image or non-base image, which is obtained as a result of the multiview encoding processing, and the corresponding depth image.

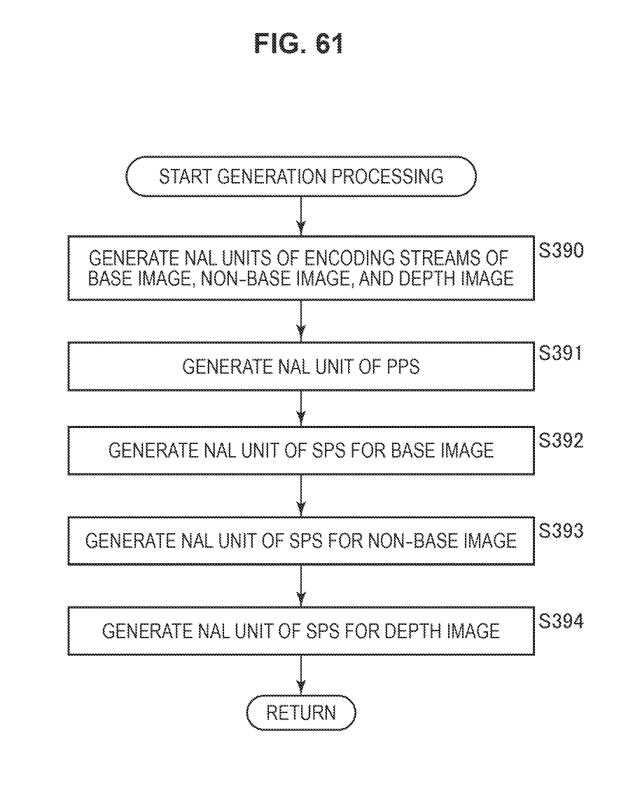

In step S333, the generation unit 382 performs the generation processing to generate the multiview encoding stream from the encoding stream supplied from the encoding unit 381. Details of the generation processing will be described below with reference to FIG. 61. The generation unit 382 outputs the multiview encoding stream, which is obtained as a result of the generation processing, and ends the processing.

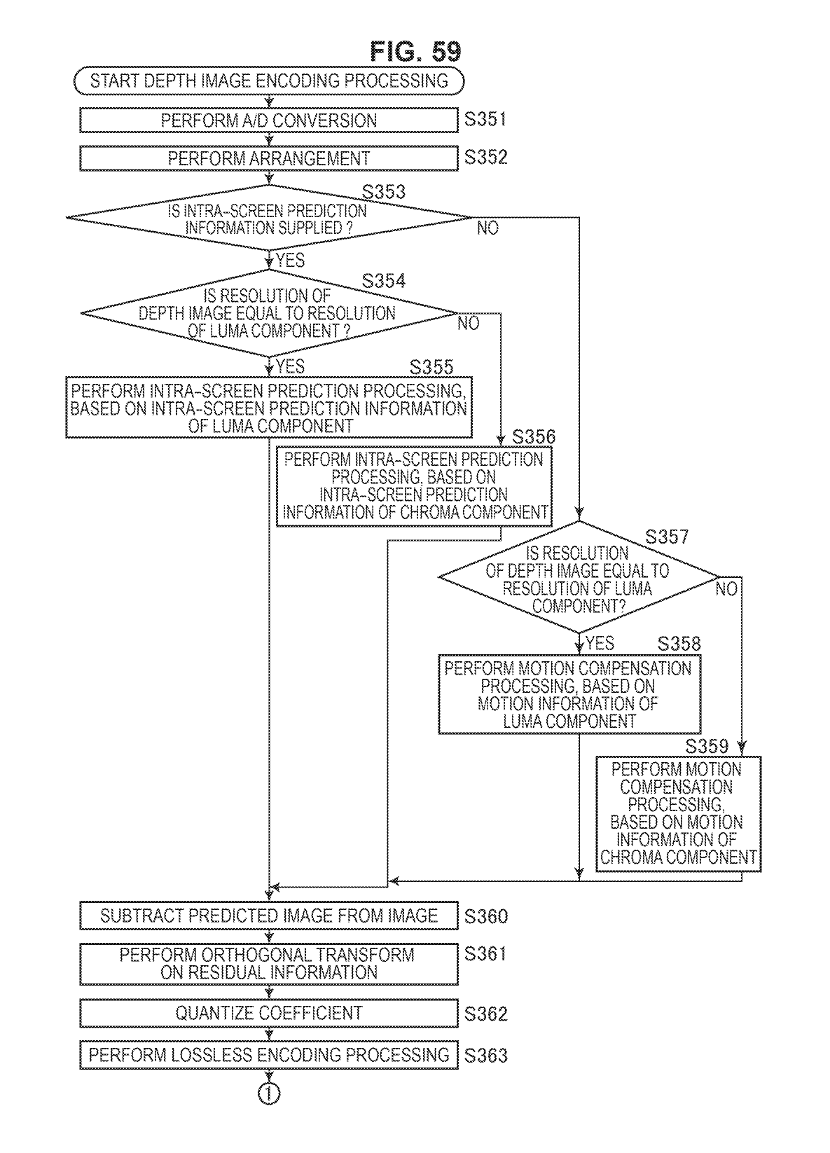

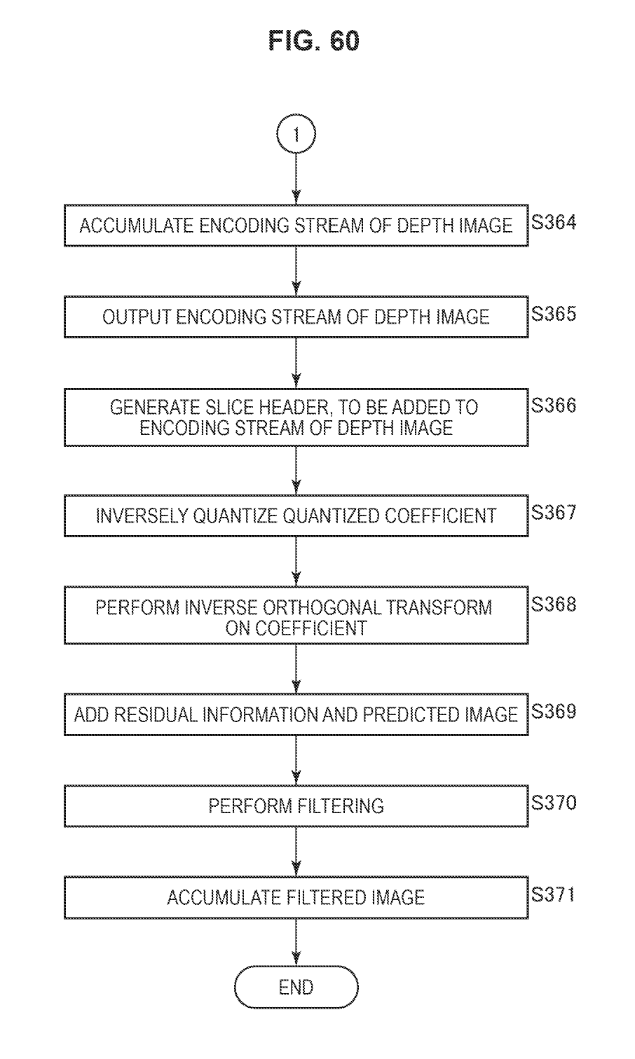

FIGS. 59 and 60 are flow charts describing details of the depth image encoding processing by the encoding unit 381-1 of FIG. 47 in the multiview encoding processing of step S332 of FIG. 58.

In step S351 of FIG. 59, the A/D conversion unit 121 of the depth encoding unit 403 (FIG. 48) performs the A/D conversion on the depth image of the frame-based base image supplied from the multiview image separation unit 21 of FIG. 46, and outputs and stores the depth image to the screen arrangement buffer 122.

In step S352, the screen arrangement buffer 122 arranges the depth image of the base image of the frames of the stored display order in order for the purpose of encoding according to the GOP structure. The screen arrangement buffer 122 supplies the calculation unit 123 with the arranged frame-based depth image.

In step S353, the intra-screen prediction unit 421 determines whether the intra-screen prediction information of the luma component and the chroma component of the color image is supplied from the color encoding unit 401 of FIG. 47. When it is determined in step S353 that the intra-screen prediction information of the luma component and the chroma component of the color image has been supplied, the intra-screen prediction unit 421 determines in step S354 whether the resolution of the depth image is equal to the resolution of the luma component of the color image.

When it is determined in step S354 that the resolution of the depth image is equal to the resolution of the luma component of the color image, the processing proceeds to step S355. In step S355, the intra-screen prediction unit 421 generates the predicted image by performing the intra-screen prediction processing of the optimal intra prediction mode represented by the intra-screen prediction information of the luma component by using the reference image supplied from the addition unit 130, based on the intra-screen prediction information of the luma component. The intra-screen prediction unit 421 supplies the selection unit 423 with the generated predicted image, and the processing proceeds to step S360.

On the other hand, when it is determined in step S354 that the resolution of the depth image is not equal to the resolution of the luma component of the color image, that is, when the resolution of the depth image is equal to the resolution of the chroma component of the color image, the processing proceeds to step S356.

In step S356, the intra-screen prediction unit 421 generates the predicted image by performing the intra-screen prediction processing of the optimal intra prediction mode represented by the intra-screen prediction information of the chroma component by using the reference image supplied from the addition unit 130, based on the intra-screen prediction information of the chroma component. The intra-screen prediction unit 421 supplies the selection unit 423 with the generated predicted image, and the processing proceeds to step S360.

When it is determined in step S353 that the intra-screen prediction information of the luma component and the chroma component of the color image has not been supplied, that is, when the motion information of the luma component and the chroma component of the color image has been supplied from the color encoding unit 401 to the motion compensation unit 422, the processing proceeds to step S357.

In step S357, the motion compensation unit 422 determines whether the resolution of the depth image is equal to the resolution of the luma component of the color image. When it is determined in step S357 that the resolution of the depth image is equal to the resolution of the luma component of the color image, the processing proceeds to step S358.

In step S358, the motion compensation unit 422 performs the motion compensation processing by reading the reference image from the frame memory 132, based on the motion information of the luma component, based on the optimal inter prediction mode and the motion vector represented by the motion information. The motion compensation unit 422 supplies the selection unit 423 with the resultant predicted image, and the processing proceeds to step S360.

On the other hand, when it is determined in step S357 that the resolution of the depth image is not equal to the resolution of the luma component of the color image, the processing proceeds to step S359. In step S359, the motion compensation unit 422 performs the motion compensation processing by reading the reference image from the frame memory 132, based on the motion information of the chroma component, based on the optimal inter prediction mode and the motion vector represented by the motion information. The motion compensation unit 422 supplies the selection unit 423 with the resultant predicted image, and the processing proceeds to step S360.

Since steps S360 to S362 are the same processing as steps S140 to S142 of FIG. 31, their description will be omitted.

In step S363, the lossless encoding unit 420 performs the lossless encoding processing. Specifically, when the resolution of the depth image is equal to the resolution of the luma component of the color image, the lossless encoding unit 420 generates the luma mode significant coefficient information, based on the coefficient from the quantization unit 125. On the other hand, when the resolution of the depth image is equal to the resolution of the chroma component of the color image, the lossless encoding unit 420 generates the chroma mode significant coefficient information, based on the coefficient from the quantization unit 125. Also, when the significant coefficient flag included in the luma mode significant coefficient information or the chroma mode significant coefficient information is 1, the lossless encoding unit 420 lossless-encodes on the coefficient from the quantization unit 125. The lossless encoding unit 420 sets the lossless-encoded coefficient and the luma mode significant coefficient information or the chroma significant coefficient information as the encoding stream of the depth image.

In step S364 of FIG. 60, the lossless encoding unit 420 supplies the accumulation buffer 127 with the encoding stream of the depth image, which is obtained as a result of the lossless encoding processing, and accumulates the encoding stream in the accumulation buffer 127.

In step S365, the accumulation buffer 127 supplies the slice header encoding unit 404 of FIG. 47 with the accumulated encoding stream of the depth image. In step S366, the slice header encoding unit 404 generates the slice header illustrated in FIG. 54, adds the slice header to the slice-based encoding stream of the depth image, and supplies the encoding stream to the generation unit 382 of FIG. 46.

Since the processing of steps S367 to S371 is identical to the processing of steps S146 to S150 of FIG. 32, its description will be omitted.

FIG. 61 is a flow chart describing details of the generation processing of step S333 of FIG. 58.

In step S390 of FIG. 61, the NAL unit 450 of the generation unit 382 (FIG. 49) generates NAL units of the slice-based encoding stream of the base image, the non-base image, and the depth image supplied from the encoding unit 381, and supplies the PPS encoding unit 451 with the NAL units.

In step S391, the PPS encoding unit 451 generates the NAL unit of the PPS. The PPS encoding unit 451 adds the NAL unit of the PPS to the NAL unit of the encoding stream supplied from the NAL unit 450, and supplies the SPS encoding unit 452 with the NAL unit.

In step S392, the SPS encoding unit 452 generates the NAL unit of the SPS for the base image. In step S393, the SPS encoding unit 452 generates the NAL unit of the SPS for the non-base image. In step S394, the SPS encoding unit 452 generates the NAL unit of the SPS for the depth image. The SPS encoding unit 452 adds the generated NAL unit of the SPS to the NAL unit supplied from the PPS encoding unit 451, and generates and outputs the multiview image encoding stream. Then, the processing returns to step S333 of FIG. 58, and the processing is ended.

In this manner, the encoding apparatus 380 encodes the color image and the depth image by sharing the encoding parameters. Therefore, the information quantity of the encoding parameters included in the multiview encoding stream is reduced, resulting in an improvement in the coding efficiency. Also, in the case where the multiview 3D image is a still image or an image in which a depth-direction position of an image of an object shifted in parallel with respect to a camera is not relatively changed, the correlation between the motion vectors of the color image and the depth image is strong. Therefore, the encoding efficiency is further improved.

Furthermore, the encoding apparatus 380 arranges the slice-based encoding stream of the color image and the depth image in separate types of NAL units, respectively. Therefore, in the decoding apparatus that decodes the existing 2D image, which does not correspond to the depth image, or the decoding apparatus that decodes the 2-view 3D image, a part of the multiview encoding stream can be decoded. That is, the multiview encoding stream can have compatibility with the encoding stream of the existing 2D image or the encoding stream of the 2-view 3D image.

[Example of Configuration of Decoding Apparatus]

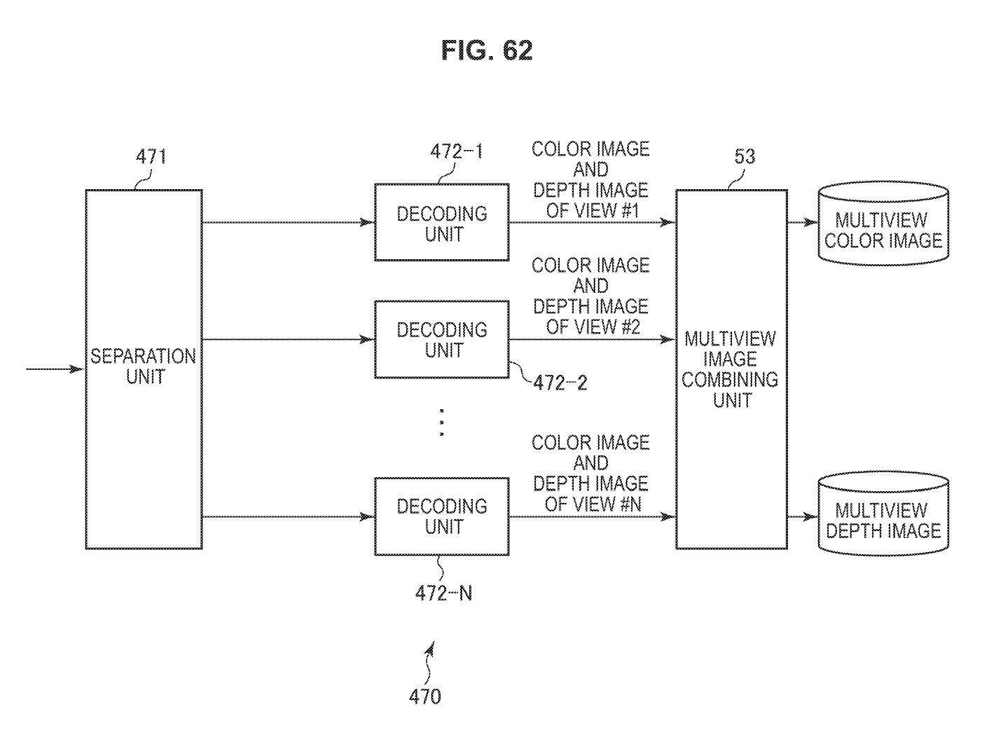

FIG. 62 is a block diagram illustrating an example of a configuration of the decoding apparatus that decodes the multiview image encoding stream output by the encoding apparatus 380 of FIG. 46.

In the configuration illustrated in FIG. 62, the same reference numerals are assigned to the same configuration as that of FIG. 12. A redundant description will be appropriately omitted.

The configuration of the decoding apparatus 470 of FIG. 62 differs from the configuration of FIG. 12 in that, instead of the multiview image decoding unit 51 and the image separation units 52-1 to 52-N, a separation unit 471 and decoding units 472-1 to 472-N are provided. The decoding apparatus 470 decodes the depth image by using the encoding parameters of the color image.

Specifically, the separation unit 471 of the decoding apparatus 470 receives the multiview image encoding stream transmitted from the encoding apparatus 380. The separation unit 471 separates the multiview image encoding stream into the respective NAL units. The separation unit 471 recognizes which NAL unit the separated NAL unit is among the NAL units of the SPS for the base image, the SPS for the non-base image, the SPS for the depth image, the PPS, the slice-based encoding stream of the base image, the slice-based encoding stream of the non-base image, and the slice-based encoding stream of the depth image, based on the type information included in the NAL header of the NAL unit.

The separation unit 471 extracts the slice headers from the NAL units of the slice-based encoding stream of the base image, the slice-based encoding stream of the non-base image, and the slice-based encoding stream of the depth image. The separation unit 471 recognizes a pair of the slice-based encoding stream of the base image and the depth image, or the non-base image and the depth image, at each view, based on the view ID included in the slice header.

The separation unit 471 extracts the SPS for the base image, the PPS, and the slice-based encoding stream of the base image and the depth image from the NAL units of the SPS for the base image, the PPS, the slice-based encoding stream of the base image, and the slice-based encoding stream of the depth image of the base image, and supplies them to the decoding unit 472-1.

Also, the separation unit 471 extracts, at each view, the SPS for the non-base image, the PPS, and the slice-based encoding stream of the non-base image and the depth image from the NAL units of the SPS for the non-base image, the PPS, the slice-based encoding stream of the non-base image of that view, and the slice-based encoding stream of the depth image of the non-base image of that view. The separation unit 471 supplies the decoding units 472-2 to 472-N with the SPS for the non-base image, the PPS, and the slice-based encoding stream of the non-base image and the depth image at each view.

The decoding unit 472-1 decodes the slice-based encoding stream of the base image supplied from the separation unit 471 in accordance with the scheme corresponding to the HEVC scheme, based on the SPS for the base image and the PPS supplied from the separation unit 471. Also, the decoding unit 472-1 decodes the slice-based encoding stream of the depth image of the base image in accordance with the scheme corresponding to the HEVC scheme, based on the SPS for the depth image and the PPS supplied from the separation unit 471 and the encoding parameter of the base image. The decoding unit 472-1 supplies the multiview image synthesis unit 53 with the base image obtained as a result of the decoding and the depth image of the base image.

Each of the decoding units 472-2 to 472-N decodes the slice-based encoding stream of the non-base image in accordance with the scheme corresponding to the HEVC scheme, based on the SPS for the non-base image and the PPS supplied from the separation unit 471. In this case, the base image also is used as the reference image. Each of the decoding units 472-2 to 472-N decodes the slice-based encoding stream of the depth image of the non-base image in accordance with the scheme corresponding to the HEVC scheme, based on the SPS for the depth image and the PPS supplied from the separation unit 471 and the encoding parameter of the non-base image. In this case, the depth image of the base image also is used as the reference image. The decoding units 472-2 to 472-N supply the multiview image synthesis unit 53 with the non-base image obtained as a result of the decoding and the depth image of the non-base image.

Also, in the following, when there is no particular need to distinguish the decoding units 472-1 to 472-N, they will be collectively referred to as the decoding unit 472.

[Example of Configuration of Separation Unit]

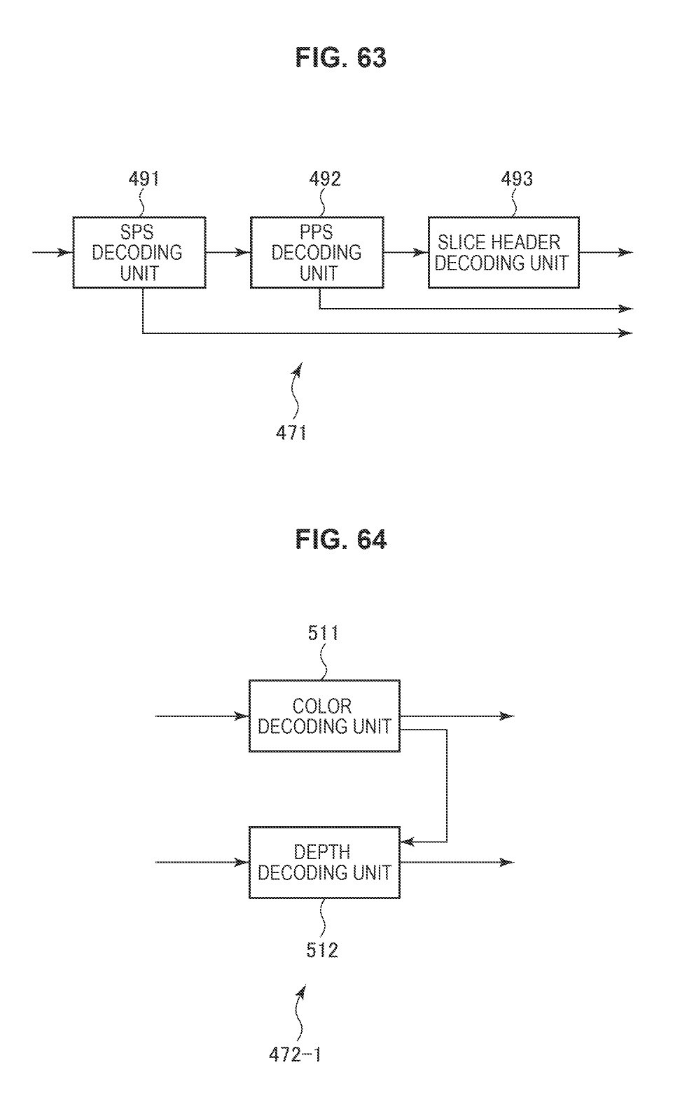

FIG. 63 is a block diagram illustrating an example of a configuration of the separation unit 471 of FIG. 62.

The separation unit 471 of FIG. 63 includes an SPS decoding unit 491, a PPS decoding unit 492, and a slice header decoding unit 493.

The SPS decoding unit 491 of the separation unit 471 functions as a receiving unit and receives the multiview image encoding stream transmitted from the encoding apparatus 380. The SPS decoding unit 491 extracts the NAL units of the SPS for the base image, the SPS for the non-base image, and the SPS for the depth image from the multiview image encoding stream, based on the type information included in the NAL header of each NAL unit of the multiview image encoding stream. For example, the SPS decoding unit 491 extracts the NAL unit having the NAL header, whose type information is 24, as the NAL unit of the SPS for the non-base image. Also, the SPS decoding unit 491 extracts the NAL unit having the NAL header, whose type information is 25, as the NAL unit of the SPS for the non-base image.

The SPS decoding unit 491 extracts the SPS for the base image from the NAL unit of the SPS for the base image, and supplies the decoding unit 472-1 with the extracted SPS. Also, the SPS decoding unit 491 extracts the SPS for the non-base image from the NAL unit of the SPS for the non-base image, and supplies the decoding units 472-2 to 472-N with the extracted SPS. Also, the SPS decoding unit 491 extracts the SPS for the depth image from the NAL unit of the SPS for the depth image, and supplies the decoding units 472-1 to 472-N with the extracted SPS. Also, the SPS decoding unit 491 supplies the PPS decoding unit 492 with the multiview image encoding stream, from which the NAL units of the SPS for the base image, the SPS for the non-base image, and the SPS for the depth image are extracted.

The PPS decoding unit 492 extracts the NAL unit of the PPS, based on the type information included in the NAL header of each NAL unit of the multiview image encoding stream, which is supplied from the SPS decoding unit 491 and from which the NAL units of the SPS for the base image, the SPS for the non-base image, and the SPS for the depth image are extracted. The PPS decoding unit 492 extracts the PPS from the NAL unit of the PPS and supplies the decoding units 472-1 to 472-N with the extracted PPS. Also, the PPS decoding unit 492 supplies the slice header decoding unit 493 with the multiview image encoding stream, from which the NAL unit of the PPS is extracted.

The slice header decoding unit 493 functions as a separation unit and extracts the NAL units of the slice-based encoding stream of the base image, the non-base image, and the depth image, based on the type information included in the NAL header of each NAL unit of the multiview image encoding stream, which is supplied from the PPS decoding unit 492 and from which the NAL unit of the PPS is extracted. For example, the slice header decoding unit 493 extracts the NAL unit having the NAL header, whose type information is 26, as the NAL unit of the slice-based encoding stream of the non-base image. Also, the slice header decoding unit 493 extracts the NAL unit having the NAL header, whose type information is 27, as the NAL unit of the slice-based encoding stream of the depth image.

The slice header decoding unit 493 extracts the slice-based encoding stream of the base image from the NAL unit of the slice-based encoding stream of the base image, and separates the slice header from the encoding stream. The slice header decoding unit 493 supplies the decoding unit 472-1 with the slice-based encoding stream of the base image and the slice header.

Also, the slice header decoding unit 493 extracts the slice-based encoding stream of the non-base image from the NAL unit of the slice-based encoding stream of the non-base image, and separates the slice header from the encoding stream. Based on the view ID included in the slice header, the slice header decoding unit 493 supplies the decoding unit 472 of the view corresponding to the view ID with the slice header and the slice-based encoding stream of the non-base image to which the slice header has been added.

Furthermore, the slice header decoding unit 493 extracts the slice-based encoding stream of the depth image from the NAL unit of the slice-based encoding stream of the depth image, and separates the slice header from the encoding stream. Based on the view ID included in the slice header, the slice header decoding unit 493 supplies the decoding unit 472 of the view corresponding to the view ID with the slice header and the slice-based encoding stream of the depth image to which the slice header has been added.

[Example of Configuration of Decoding Unit]

FIG. 64 is a block diagram illustrating an example of a configuration of the decoding unit 472-1 of FIG. 62.

The decoding unit 472-1 of FIG. 64 includes a color decoding unit 511 and a depth decoding unit 512.

The color decoding unit 511 of the decoding unit 472-1 is identical to the decoding unit 250 of FIG. 37, except that the depth component is not present, and the motion information and the intra-screen information are supplied to the depth decoding unit 512. Specifically, the color decoding unit 511 decodes the slice-based encoding stream of the base image supplied from the separation unit 471 in accordance with the scheme corresponding to the HEVC scheme, based on the SPS for the base image, the PPS, and the slice header supplied from the separation unit 471. Also, the color decoding unit 511 supplies the depth decoding unit 512 with the motion information or the intra-screen information as the encoding parameters of the luma component and the chroma component used in the decoding.

The depth decoding unit 512 decodes the slice-based encoding stream of the depth image of the base image supplied from the separation unit 471 in accordance with the scheme corresponding to the HEVC scheme, based on the motion information or the intra-screen information supplied from the color decoding unit 511, and the SPS for the depth image, the PPS, and the slice header supplied from the separation unit 471. The depth decoding unit 512 supplies the multiview image synthesis unit 53 (FIG. 62) with the base image of the base image obtained as a result of the decoding.

Also, although the illustration is omitted, the configuration of the decoding units 472-2 to 472-N is identical to the configuration of FIG. 64, except that the color decoding unit decodes the slice-based encoding stream of the non-base image by also referring to the base image, and the depth decoding unit decodes the slice-based encoding stream of the depth image of the non-base image by also referring to the depth image of the base image.

[Example of Configuration of Depth Decoding Unit]

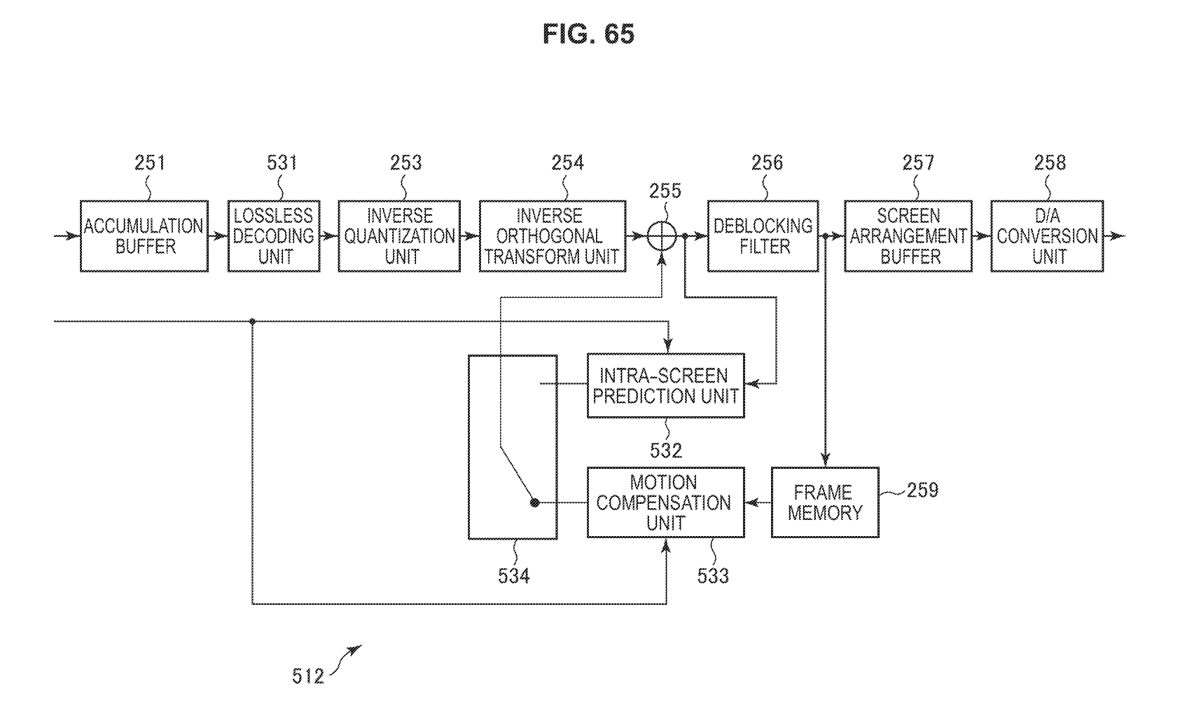

FIG. 65 is a block diagram illustrating an example of a configuration of the depth decoding unit 512 of FIG. 64.

In the configuration illustrated in FIG. 65, the same reference numerals are assigned to the same configuration as that of FIG. 37. A redundant description will be appropriately omitted.

The configuration of the depth decoding unit 512 of FIG. 65 differs from the configuration of FIG. 37 in that, instead of the lossless decoding unit 252, the intra-screen prediction unit 260, the motion compensation unit 261, and the switch 262, a lossless decoding unit 531, an intra-screen prediction unit 532, a motion compensation unit 533, and a switch 534 are provided. Also, in FIG. 65, for convenience of description, supply lines of the SPS for the depth image, the PPS, and the slice header supplied from the separation unit 471 are not described, but, if necessary, these pieces of information are referred to in each unit.

The lossless decoding unit 531 of the depth decoding unit 512 obtains the quantized coefficient by performing the lossless decoding on the encoding stream of the depth image from the accumulation buffer 251. The lossless decoding unit 531 supplies the inverse quantization unit 253 with the quantized coefficient.

The intra-screen prediction unit 532 determines whether the resolution of the depth image is equal to the resolution of the luma component of the color image or is equal to the resolution of the chroma component, based on the resolution flag included in the SPS for the depth image. When it is determined that the resolution of the depth image is equal to the resolution of the luma component of the color image, the intra-screen prediction unit 532 selects the intra-screen prediction information of the luma component among pieces of the intra-screen prediction information of the luma component and the chroma component supplied from the color decoding unit 511 of FIG. 64. The intra-screen prediction unit 532 generates the predicted image by performing the intra-screen prediction of the optimal intra prediction mode represented by the intra-screen prediction information of the luma component by using the reference image supplied from the addition unit 255, based on the intra-screen prediction information of the luma component.

On the other hand, when it is determined that the resolution of the depth image is equal to the resolution of the chroma component of the color image, the intra-screen prediction information of the chroma component is selected among pieces of the intra-screen prediction information of the luma component and the chroma component supplied from the color decoding unit 511. The intra-screen prediction unit 532 generates the predicted image by performing the intra-screen prediction of the optimal intra prediction mode represented by the intra-screen prediction information of the luma component by using the reference image supplied from the addition unit 255, based on the intra-screen prediction information of the luma component. The intra-screen prediction unit 532 supplies the switch 534 with the generated predicted image.

The motion compensation unit 533 determines whether the resolution of the depth image is equal to the resolution of the luma component of the color image or is equal to the resolution of the chroma component, based on the resolution flag included in the SPS for the depth image. When it is determined that the resolution of the depth image is equal to the resolution of the luma component of the color image, the motion compensation unit 533 selects the motion information of the luma component among pieces of the motion information of the luma component and the chroma component supplied from the color decoding unit 511. The motion compensation unit 533 perform the motion compensation processing by reading the reference image from the frame memory 259, based on the optimal inter prediction mode and the motion vector represented by the selected motion information.

On the other hand, when it is determined that the resolution of the depth image is equal to the resolution of the chroma component of the color image, the motion information of the chroma component is selected among pieces of the motion information of the luma component and the chroma component supplied from the color decoding unit 511. The motion compensation unit 533 performs the motion compensation processing by reading the reference image from the frame memory 259, based on the optimal inter prediction mode and the motion vector represented by the selected motion information. The motion compensation unit 533 supplies the switch 534 with the generated predicted image.

When the predicted image has been supplied from the intra-screen prediction unit 532, the switch 534 supplies the addition unit 255 with the predicted image. Also, when the predicted image has been supplied from the motion compensation unit 533, the switch 534 supplies the addition unit 255 with the predicted image.

[Description of Processing of Decoding Apparatus]

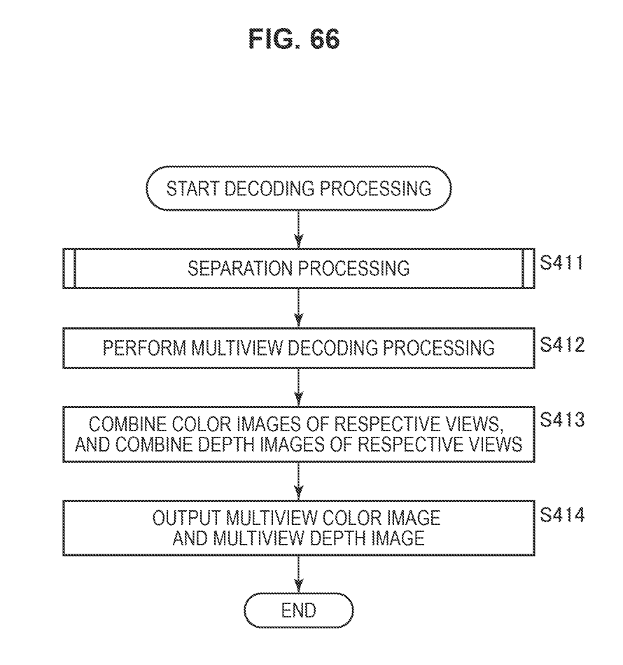

FIG. 66 is a flow chart describing the decoding processing by the decoding apparatus 470 of FIG. 62. The decoding processing is started, for example, when the multiview image encoding stream is input from the encoding apparatus 380 of FIG. 46.

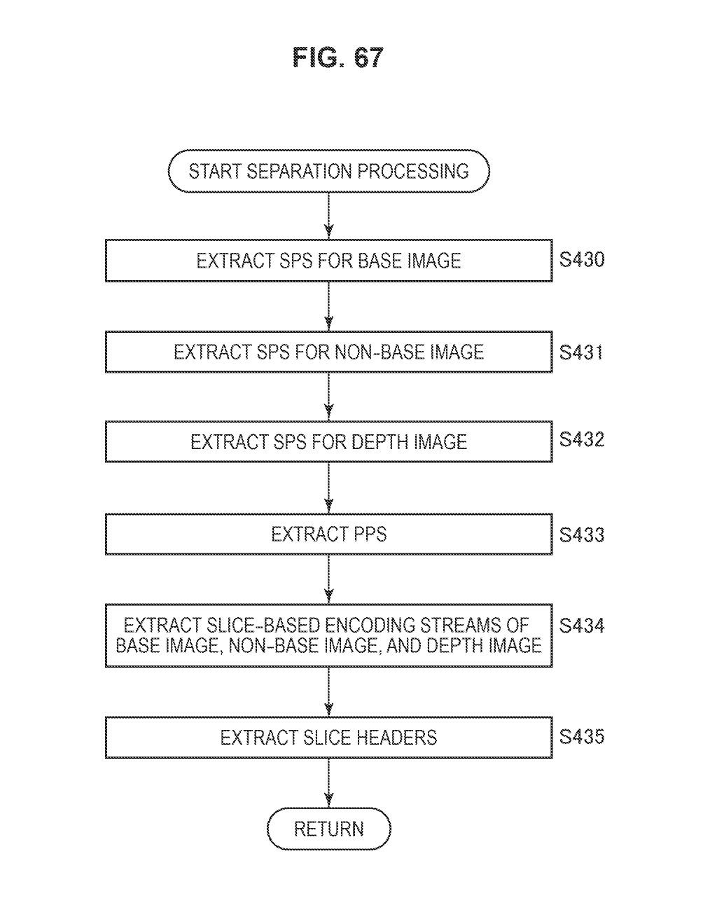

In step S411 of FIG. 66, the separation unit 471 of the decoding apparatus 470 performs the separation processing to separate each NAL unit of the multiview image encoding stream. Details of the separation processing will be described below with reference to FIG. 67.

In step S412, the decoding unit 472 performs the multiview decoding processing to decode the slice-based encoding stream of the color image and the depth image of each view supplied from the separation unit 471. The decoding unit 472 supplies the multiview image synthesis unit 53 with the color image and the depth image of each view, which are obtained as a result of the multiview decoding processing.

Since the processing of steps S413 and S414 is identical to the processing of steps S243 and S244 of FIG. 42, its description will be omitted.

FIG. 67 is a flow chart describing details of the separation processing of step S411 of FIG. 66.

In step S430 of FIG. 67, the SPS decoding unit 491 of the separation unit 471 (FIG. 63) extracts the SPS for the base image from the multiview image encoding stream transmitted from the encoding apparatus 380. Specifically, the SPS decoding unit 491 extracts the NAL unit of the SPS for the base image from the multiview image encoding stream, based on the type information included in the NAL header of each NAL unit of the multiview image encoding stream. The SPS decoding unit 491 extracts the SPS for the base image from the NAL unit. The SPS decoding unit 491 supplies the decoding unit 472-1 with the SPS for the base image.

In step S431, as in the SPS for the base image, the SPS decoding unit 491 extracts the SPS for the non-base image from the multiview image encoding stream, and supplies the decoding units 472-2 to 472-N with the SPS for the non-base image.

In step S432, as in the SPS for the base image, the SPS decoding unit 491 extracts the SPS for the depth image from the multiview image encoding stream, and supplies the decoding units 472-1 to 472-N with the SPS for the depth image. Also, the SPS decoding unit 491 supplies the PPS decoding unit 492 with the multiview image encoding stream, from which the NAL units of the SPS for the base image, the SPS for the non-base image, and the SPS for the depth image are extracted.

In step S433, the PPS decoding unit 492 extracts the PPS from the multiview image encoding stream, which is supplied from the SPS decoding unit 491 and from which the NAL units of the SPS for the base image, the SPS for the non-base image, and the SPS for the depth image are extracted. Specifically, the PPS decoding unit 492 extracts the NAL unit of the PPS, based on the type information included in the NAL header of each NAL unit of the multiview image encoding stream, from which the NAL units of the SPS for the base image, the SPS for the non-base image, and the SPS for the depth image are extracted. The PPS decoding unit 492 extracts the PPS from the NAL unit of the PPS. The PPS decoding unit 492 supplies the decoding units 472-1 to 472-N with the PPS, and supplies the slice header decoding unit 493 with the multiview image encoding stream, from which the NAL unit of the PPS is extracted.

In step S434, the slice header decoding unit 493 extracts the slice-based encoding stream of the base image, the non-base image, and the depth image from the multiview image encoding stream, which is supplied from the PPS decoding unit 492 and from which the NAL unit of the PPS is extracted.

Specifically, the slice header decoding unit 493 extracts the NAL units of the slice-based encoding stream of the base image, the non-base image, and the depth image, based on the type information included in the NAL header of each NAL unit of the multiview image encoding stream, from which the NAL unit of the PPS is extracted. The slice header decoding unit 493 extracts the slice-based encoding stream of the base image, the non-base image, and the depth image from the NAL units of the slice-based encoding stream of the base image, the non-base image, and the depth image.

In step S435, the slice header decoding unit 493 extracts the slice header from the slice-based encoding stream of the base image, the non-base image, and the depth image. The slice header decoding unit 493 supplies the decoding unit 472-1 with the slice-based encoding stream of the base image and the slice header. Also, based on the view ID included in the slice header of the slice-based encoding stream of the non-base image, the slice header decoding unit 493 supplies the decoding unit 472 of the view corresponding to the view ID with the slice header and the slice-based encoding stream of the non-base image to which the slice header has been added.

Furthermore, based on the view ID included in the slice header of the slice-based encoding stream of the depth image, the slice header decoding unit 493 supplies the decoding unit 472 of the view corresponding to the view ID with the slice header and the slice-based encoding stream of the depth image to which the slice header has been added. Then, the processing returns to step S411 of FIG. 66 and proceeds to step S412.

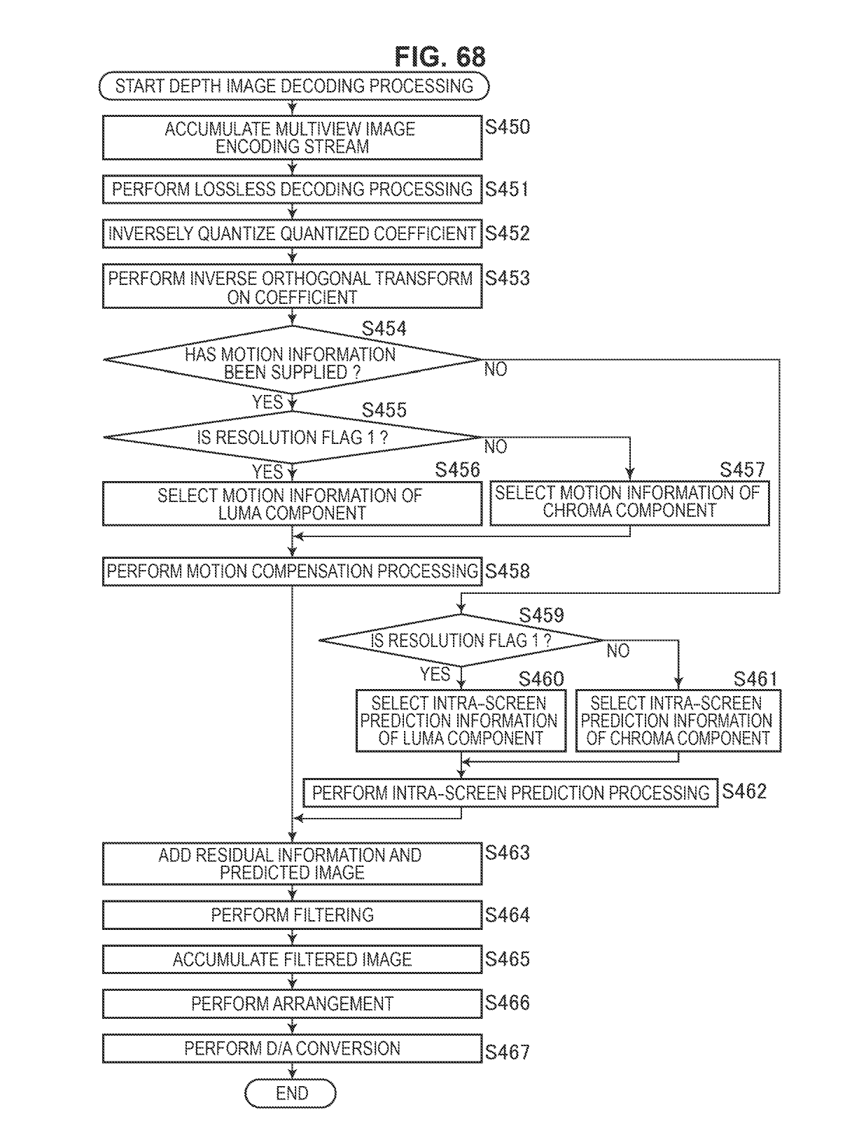

FIG. 68 is a flow chart describing details of the depth decoding processing by the depth decoding unit 512 of FIG. 65 in the multiview decoding processing of step S412 of FIG. 66.

In step S450 of FIG. 68, the accumulation buffer 251 of the depth decoding unit 512 receives and accumulates the multiview image encoding stream transmitted from the encoding apparatus 380 of FIG. 46. The accumulation buffer 251 supplies the lossless decoding unit 531 with the accumulated multiview image encoding stream.

In step S451, the lossless decoding unit 531 performs the lossless decoding processing to lossless-decode the multiview image encoding stream supplied from the accumulation buffer 251. The lossless decoding processing is identical to the processing of steps S290 to S295 and S298 of FIG. 44, except that the depth component of the coefficient is not present.

In step S452, the inverse quantization unit 253 inversely quantizes the quantized coefficient from the lossless decoding unit 252, and supplies the inverse orthogonal transform unit 254 with the resultant coefficient.

In step S453, the inverse orthogonal transform unit 254 performs the inverse orthogonal transform on the coefficient from the inverse quantization unit 253, and supplies the addition unit 255 with the resultant residual information.

In step S454, the motion compensation unit 533 determines whether the motion information of the luma component and the chroma component has been supplied from the color decoding unit 511 of FIG. 64. When it is determined in step S454 that the motion information of the luma component and the chroma component has been supplied, the motion compensation unit 533, in step S455, determines whether the resolution flag included in the SPS for the depth image is 1.

When it is determined in step S455 that the resolution flag included in the SPS for the depth image is 1, the motion compensation unit 533, in step S456, selects the motion information of the luma component among pieces of the motion information of the luma component and the chroma component supplied from the color decoding unit 511. Then, the processing proceeds to step S458.

On the other hand, when it is determined in step S455 that the resolution flag included in the SPS for the depth image is not 1, that is, when the resolution flag included in the SPS for the depth image is 0, the motion compensation unit 533, in step S457, selects the motion information of the chroma component among pieces of the motion information of the luma component and the chroma component supplied from the color decoding unit 511. Then, the processing proceeds to step S458.

In step S458, the motion compensation unit 533 performs the motion compensation processing by reading the reference image from the frame memory 259, based on the selected motion information of the luma component or the chroma component. The motion compensation unit 261 supplies the predicted image, which is generated as a result of the motion compensation processing, to the addition unit 255 through the switch 534, and the processing proceeds to step S463.

On the other hand, when it is determined in step S454 that the motion information of the luma component and the chroma component is not supplied, that is, when the intra-screen prediction information of the luma component and the chroma component is supplied from the color decoding unit 511 to the intra-screen prediction unit 532, the processing proceeds to step S459. In step S459, the intra-screen prediction unit 532 determines whether the resolution flag included in the SPS for the depth image is 1.

When it is determined in step S459 that the resolution flag included in the SPS for the depth image is 1, the intra-screen prediction unit 532, in step S460, selects the intra-screen prediction information of the luma component among pieces of the intra-screen prediction information of the luma component and the chroma component supplied from the color decoding unit 511. Then, the processing proceeds to step S462.

On the other hand, when it is determined in step S459 that the resolution flag included in the SPS for the depth image is not 1, the intra-screen prediction unit 532, in step S461, selects the intra-screen prediction information of the chroma component among pieces of the intra-screen prediction information of the luma component and the chroma component supplied from the color decoding unit 511. Then, the processing proceeds to step S462.

In step S462, the intra-screen prediction unit 532 performs the intra-screen prediction processing of the optimal intra prediction mode, which is represented by the selected intra-screen prediction information of the luma component or the chroma component, by using the reference image supplied from the addition unit 255. The intra-screen prediction unit 260 supplies the resultant predicted image to the addition unit 255 through the switch 534, and the processing proceeds to step S463.

Since the processing of steps S463 to S467 is identical to the processing of steps S268 to S272 of FIG. 43, its description will be omitted.

[Description of Decodable Image]

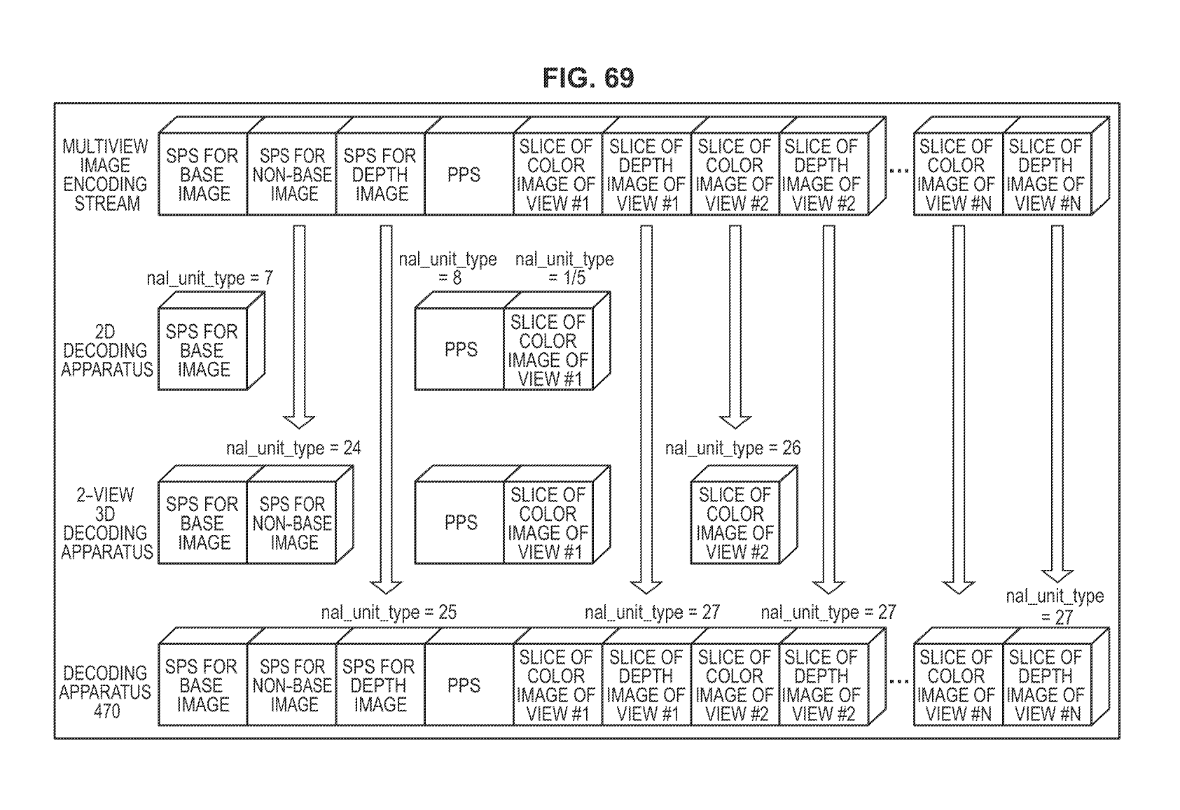

FIG. 69 is a diagram describing the multiview image encoding stream that is decodable by the decoding apparatus decoding the existing 2D image, the decoding apparatus decoding the existing 2-view 3D image, and the decoding apparatus 470 of FIG. 62.

The decoding apparatus decoding the existing 2D image (hereinafter, referred to as the 2D decoding apparatus) recognizes the type information of the NAL units of the SPS for the base image, the PPS, and the slice-based encoding stream of the base image. Therefore, as illustrated in FIG. 69, the 2D decoding apparatus can obtain the NAL units in which 7 being the type information of the NAL unit of the SPS for the base image, 8 being the type information of the NAL unit of the PPS, or 1 or 5 being the type information of the NAL unit of the slice-based encoding stream of the base image is included in the NAL header. Therefore, the 2D decoding apparatus can decode the slice-based encoding stream of the base image, based on the SPS for the base image and the PPS.

On the other hand, the decoding apparatus decoding the existing 2-view 3D image (hereinafter, referred to as the 2-view 3D decoding apparatus) recognizes the type information of the NAL units of the SPS for the non-base image and the slice-based encoding stream of the non-base image, as well as the SPS for the base image, the PPS, and the slice-based encoding stream of the base image.

Therefore, as illustrated in FIG. 69, as in the 2D decoding apparatus, the 2-view 3D decoding apparatus can obtain the NAL units of the SPS for the base image, the PPS, and the slice-based encoding stream of the base image. Also, the 2-view 3D decoding apparatus can obtain the NAL units in which 24 being the type information of the NAL unit of the SPS for the non-base image, or 26 being the type information of the NAL unit of the slice-based encoding stream of the non-base image is included in the NAL header.

Therefore, as in the 2D decoding apparatus, the 2-view 3D decoding apparatus can decode the slice-based encoding stream of the base image, based on the SPS for the base image and the PPS. Also, the 2-view 3D decoding apparatus can decode the slice-based encoding stream of the non-base image of one view (view #2 in the example of FIG. 69), including a predetermined view ID in the slice header, among the slice-based encoding streams of the non-base image, based on the SPS for the non-base image and the PPS.

Also, the decoding apparatus 470, as described above, recognizes the type information representing the NAL units of the SPS for the base image, the SPS for the non-base image, the SPS for the depth image, the PPS, and the slice-based encoding stream of the base image, the non-base image, and the depth image.

Therefore, as illustrated in FIG. 69, as in the 2-view 3D decoding apparatus, the decoding apparatus 470 can obtain the NAL units of the SPS for the base image, the SPS for the non-base image, the PPS, and the slice-based encoding stream of the base image and the non-base image. Also, the decoding apparatus 470 can obtain the NAL units in which 25 being the type information of the NAL unit of the SPS for the depth image, or 27 being the type information of the NAL unit of the slice-based encoding stream of the depth image is included in the NAL header.

Therefore, as in the 2D decoding apparatus, the decoding apparatus 470 can decode the slice-based encoding stream of the base image, based on the SPS for the base image and the PPS. Therefore, the decoding apparatus 470 can decode the slice-based encoding stream of the non-base image of N−1 views, based on the SPS for the non-base image and the PPS. Also, the decoding apparatus 470 can decode the slice-based encoding stream of the depth image, based on the SPS for the depth image and the PPS.

As described above, the 2D decoding apparatus and the 2-view 3D decoding apparatus can decode a part of the multiview encoding stream. Therefore, the multiview image encoding stream has compatibility with the encoding stream of the existing 2D image or the encoding stream of the 2-view 3D image.

Also, since the decoding apparatus 470 decodes the color image and the depth image by sharing the encoding parameter, the decoding apparatus 470 can decode the multiview encoding stream in which the encoding is performed by sharing the encoding parameter to improve the coding efficiency.

### Fourth Embodiment

[Description of Computer to which Present Technology is Applicable]

Next, the above-described series of processing can also be performed by hardware and can also be performed by software. When the series of processing is performed by software, a program constituting the software is installed on a general-purpose computer or the like.

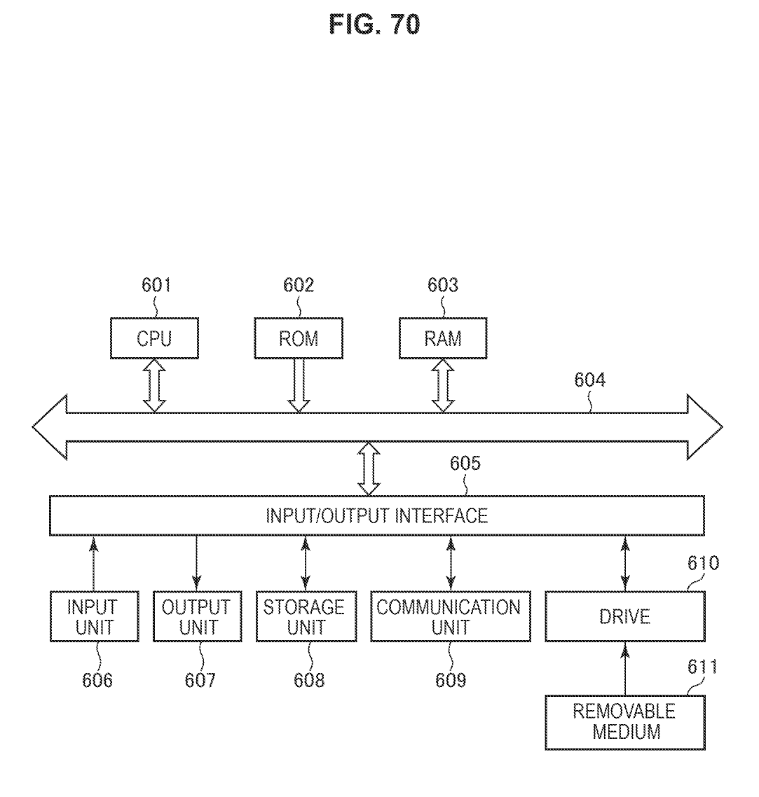

FIG. 70 illustrates an example of a configuration of an embodiment of a computer on which a program for performing the above-described series of processing is installed.

The program may be previously recorded in a storage unit 608 or a read only memory (ROM) 602 as a recording medium embedded into the computer.

Also, the program may be stored (recorded) in a removable medium 611. The removable medium 611 may be provided as so-called package software. Examples of the removable medium 611 include a flexible disc, a compact disc read only memory (CD-ROM), a magneto optical (MO) disc, a digital versatile disc (DVD), a magnetic disc, and a semiconductor memory.

Also, instead of installing the program on the computer from the removable medium 611 through a drive 610 as described above, the program may be downloaded on the computer through a communication network or broadcasting network and be installed on the embedded storage unit 608. That is, the program, for example, can be transmitted from a download site through an artificial satellite for digital satellite broadcasting to a computer by wireless, or may be transmitted through a network, such as a local area network (LAN) or Internet, to a computer by wire.

The computer is embedded with a central processing unit (CPU) 601, and an input/output interface 605 is connected to the CPU 601 through a bus 604.

When the user inputs an instruction through the input/output interface 605 by a manipulation of an input unit 606, the CPU 601 executes the program stored in the ROM 602. Alternatively, the CPU 601 loads the program stored in the storage unit 608 on a random access memory (RAM) 603 and executes the program.

In this manner, the CPU 601 executes the processing according to the above-described flow charts or the processing performed by the above-described configurations of the block diagrams. If necessary, for example, the CPU 601 outputs the processing result from the output unit 607 through the input/output interface 605, or records the processing result from the communication unit 609 to the storage unit 608.

Also, the input unit 606 includes a keyboard, a mouse, a microphone, and the like. Also, the output unit 607 includes a liquid crystal display (LCD) or a speaker, and the like.

In this specification, the processing the computer performs according to the program may not be necessarily performed in time series according to the sequence described in the flow chart. That is, the processing the computer performs according to the program includes processing performed in parallel or individually (for example, parallel processing or processing by objects).

Also, the program may be executed by one computer or may be distributed by a plurality of computers. Furthermore, the program may be transmitted to a remote computer and executed therein.

The present technology can be applied to the encoding apparatus and the decoding apparatus used when receiving through a network media such as a satellite broadcasting, a cable TV (television), Internet, and a mobile phone, or when processing on a storage media such as an optimal disc, a magnetic disc, and a flash memory.

Also, the encoding apparatus and the decoding apparatus described above can be applied to any electronic devices. Examples will be described below.

[Example of Configuration of Television Apparatus]

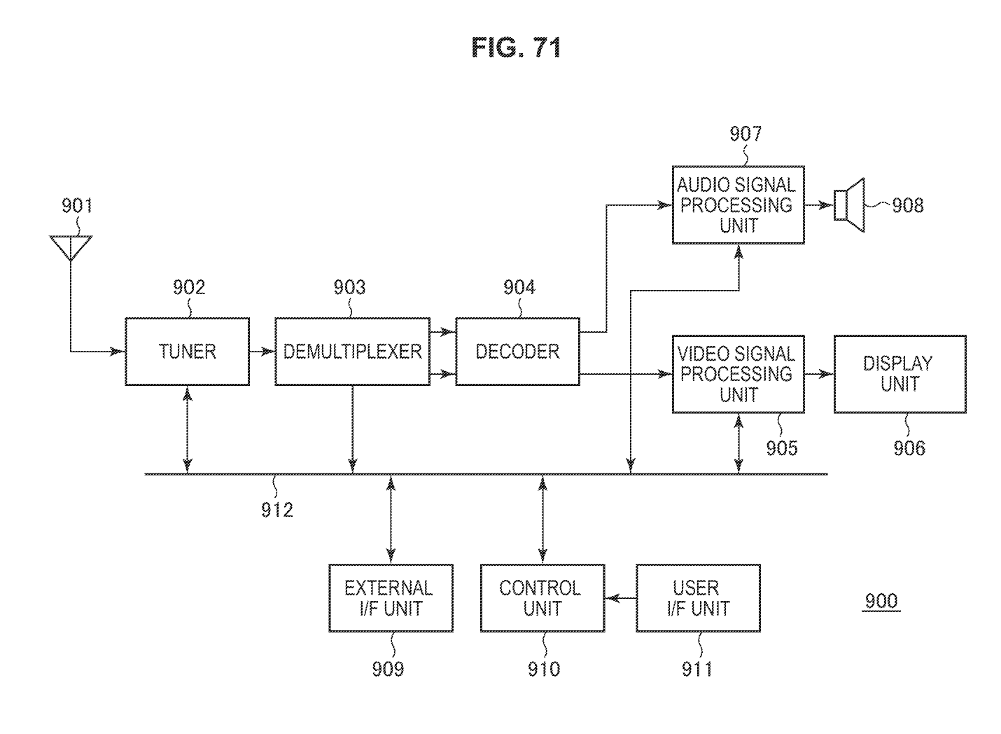

FIG. 71 illustrates a schematic configuration of a television apparatus to which the present technology is applied. The television apparatus 900 includes an antenna 901, a tuner 902, a demultiplexer 903, a decoder 904, a video signal processing unit 905, a display unit 906, an audio signal processing unit 907, a speaker 908, and an external interface unit 909. Furthermore, the television apparatus 900 includes a control unit 910 and a user interface unit 911.

The tuner 902 selects a desired channel from a broadcast wave signal received in the antenna 901, performs demodulation, and outputs the obtained encoding bitstream to the demultiplexer 903.

The demultiplexer 903 extracts a video or audio packet of a program to be viewed from the encoding bitstream, and outputs data of the extracted packet to the decoder 904. Also, the demultiplexer 903 supplies the control unit 910 with packets of data, such as an electronic program guide (EPG) or the like. Also, when a scramble is performed, a descramble is performed in the demultiplexer or the like.

The decoder 904 performs decoding processing on packets, outputs video data generated by the decoding processing to the video signal processing unit 905, and outputs audio data to the audio signal processing unit 907.

The video signal processing unit 905 removes noise from video data or performs video processing on video data according to user setting. The video signal processing unit 905 generates video data of a program to be displayed on the display unit 906, or generates video data by processing based on an application supplied through a network. Also, the video signal processing unit 905 generates video data for displaying a menu screen such as item selection or the like, and superimposes it on video data of the program. The video signal processing unit 905 generates a driving signal, based on the video data generated in this manner, and drives the display unit 906.

The display unit 906 displays the video of the program or the like by driving the display device (for example, liquid crystal display device or the like), based on the driving signal from the video signal processing unit 905.

The audio signal processing unit 907 performs predetermined processing, such as noise removal, on audio data, performs D/A conversion processing or amplification processing on the processed audio data, and supplies the audio data to the speaker 908 to output audio.

The external interface unit 909 is an interface for connection to an external device or network, and performs data transmission/reception of video data or audio data.

The user interface unit 911 is connected to the control unit 910. The user interface unit 911 includes an operating switch or a remote control signal receiving unit, and the like, and supplies the control unit 910 with an operation signal according to user manipulation.

The control unit 910 is configured using a central processing unit (CPU) or a memory, and the like. The memory stores a program to be executed by the CPU, various data required when the CPU performs processing, EPG data, data obtained through the network, and the like. The program stored in the memory is read and executed by the CPU at a predetermined timing, such as the starting of the television apparatus 900. By executing the program, the CPU controls each unit such that the television apparatus 900 is operated according to the user manipulation.

Also, in the television apparatus 900, a bus 912 is provided for connecting the control unit 910 to the tuner 902, the demultiplexer 903, the video signal processing unit 905, the audio signal processing unit 907, and the external interface unit 909.

In the television apparatus configured as above, the function of the decoding apparatus (decoding method) of the present invention is provided in the decoder 904. Therefore, it is possible to decode the encoding bitstream of the multiview 3D image of the desired channel, which is encoded so as to improve the coding efficiency.

[Example of Configuration of Mobile Phone]

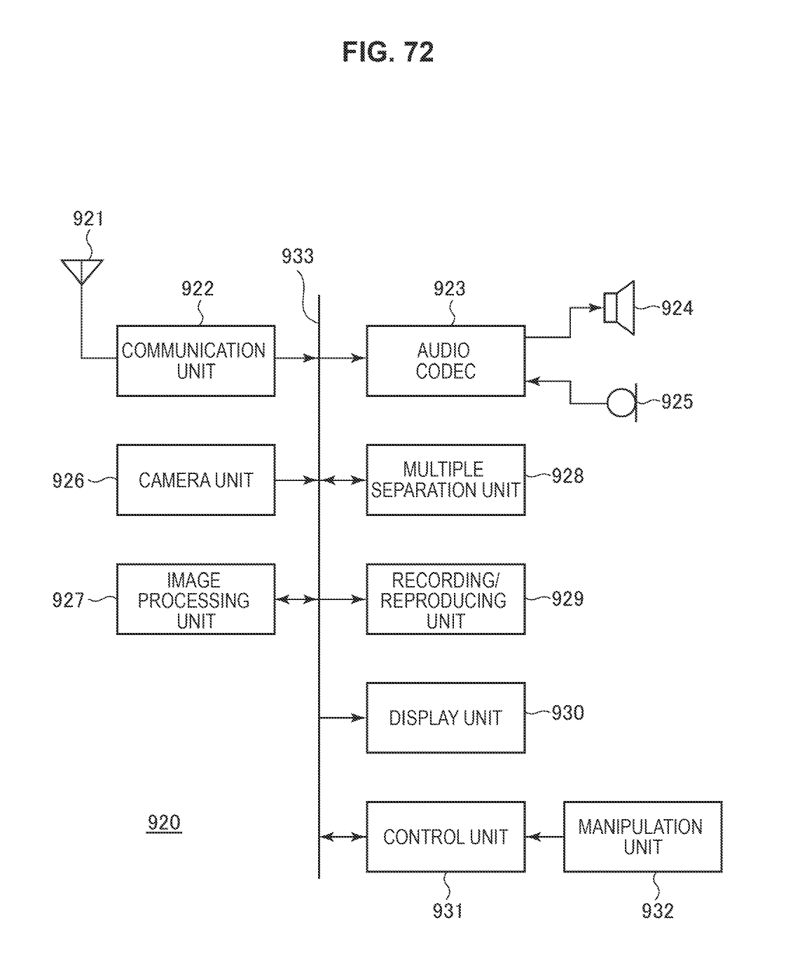

FIG. 72 illustrates a schematic configuration of a mobile phone to which the present technology is applied. The mobile phone 920 includes a communication unit 922, an audio codec 923, a camera unit 926, an image processing unit 927, a multiple separation unit 928, a recording/reproducing unit 929, a display unit 930, and a control unit 931. These are mutually connected through a bus 933.

Also, an antenna 921 is connected to the communication unit 922, and a speaker 924 and a microphone 925 are connected to the audio codec 923. Furthermore, a manipulation unit 932 is connected to the control unit 931.

The mobile phone 920 performs various operations, such as transmission/reception of audio signals, transmission/reception of e-mail or image data, image pickup, or data recording, in various modes, such as a voice call mode or a data communication mode.

In the voice call mode, the audio signal generated by the microphone 925 is converted into audio data by the audio codec 923 or is data-compressed, and is supplied to the communication unit 922. The communication unit 922 performs modulation processing or frequency conversion processing of the audio data, and generates a transmission signal. Also, the communication unit 922 supplies the transmission signal to the antenna 921 and transmits the transmission signal to a base station that is not illustrated. Also, the communication unit 922 performs amplification or frequency conversion processing and demodulation processing of a reception signal received in the antenna 921, and supplies the audio codec 923 with the obtained audio data. The audio codec 923 performs data decompression of audio data or conversion into an analog audio signal, and outputs the resulting data or signal to the speaker 924.

Also, in the data communication mode, when e-mail is transmitted, the control unit 931 receives character data input by the manipulation of the manipulation unit 932, and displays the input characters on the display unit 930. Also, the control unit 931 generates e-mail data based on user instruction in the manipulation unit 932 and supplies the communication unit 922 with the e-mail data. The communication unit 922 performs modulation processing or frequency conversion processing of the e-mail data, and transmits the obtained transmission signal to the antenna 921. Also, the communication unit 922 performs amplification or frequency conversion processing and demodulation processing of a reception signal received in the antenna 921, and restores e-mail data. The e-mail data is supplied to the display unit 930 to display the content of the e-mail.

Also, the mobile phone 920 can store the received e-mail data in the recording medium by the recording/reproducing unit 929. The recording medium is any rewritable storage medium. For example, the storage medium is a removable media, such as a semiconductor memory such as a RAM or an internal flash memory, a hard disk, a magnetic disc, a magneto optical disc, an optical disc, a USB memory, or a memory card.

When image data is transmitted in the data communication mode, image data generated in the camera unit 926 is supplied to the image processing unit 927. The image processing unit 927 performs encoding processing of the image data, and generates the encoding data.

The multiple separation unit 928 multiplexes the encoding data generated in the image processing unit 927 and the audio data supplied from the audio codec 923 in accordance with a predetermined scheme, and supplies the communication unit 922 with the multiplexed data. The communication unit 922 performs modulation processing or frequency conversion processing of the multiplexing data, and transmits the obtained transmission signal to the antenna 921. Also, the communication unit 922 performs amplification or frequency conversion processing and demodulation processing of a reception signal received in the antenna 921, and restores the multiplexing data. The multiplexing data is supplied to the multiple separation unit 928. The multiple separation unit 928 performs the separation of the multiplexing data, supplies the image processing unit 927 with the encoding data, and supplies the audio codec 923 with the audio data. The image processing unit 927 performs decoding processing of the image data, and generates the image data. The image data is supplied to the display unit 930 to display the content of the received image. The audio codec 923 converts the audio data into the analog audio signal and supplies the analog audio signal to the speaker 924 to output the received audio.

In the mobile phone configured as above, the function of the encoding apparatus (encoding method) and the function of the decoding apparatus (decoding method) of the present invention are provided in the image processing unit 927. Therefore, it is possible to improve the coding efficiency of the image data of the multiview 3D image generated in the camera unit 926, and it is possible to receive and decode the encoding data of the multiview 3D image encoded to improve the coding efficiency.

[Example of Configuration of Recording/Reproducing Apparatus]

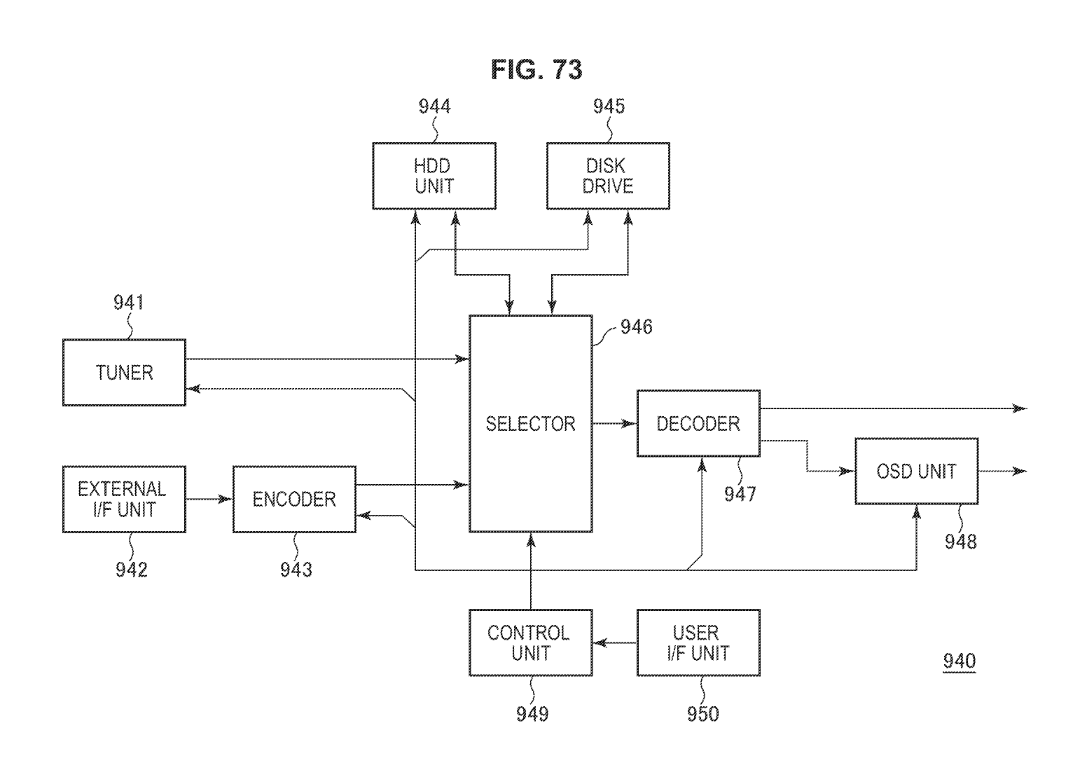

FIG. 73 illustrates a schematic configuration of a recording/reproducing apparatus to which the present technology is applied. For example, the recording/reproducing apparatus 940 records audio data and video data of a received broadcast program in the recording medium, and provides the user with the recorded data at a timing according to user instruction. Also, for example, the recording/reproducing apparatus 940 can also obtain audio data or video data from other device and record them in the recording medium. Furthermore, the recording/reproducing apparatus 940 can perform image display or audio output in a monitor device or the like by decoding the audio data or video data recorded in the recording medium and outputting the decoded audio data or video data.

The recording/reproducing apparatus 940 includes a tuner 941, an external interface unit 942, an encoder 943, a hard disk drive (HDD) unit 944, a disk drive 945, a selector 946, a decoder 947, an on-screen display (OSD) unit 948, a control unit 949, and a user interface unit 950.

The tuner 941 selects a desired channel from a broadcast signal received in an antenna that is not illustrated. The tuner 941 outputs the encoding bitstream, which is obtained by demodulating the reception signal of the desired channel, to the selector 946.

The external interface unit 942 is configured by at least one of an IEEE 1394 interface, a network interface unit, a USB interface, and a flash memory interface. The external interface unit 942 is an interface for connection to an external device or network, a memory card, and the like, and performs data reception of video data or audio data to be recorded.

When the video data or audio data supplied from the external interface unit 942 is not encoded, the encoder 943 performs encoding in accordance with a predetermined scheme, and outputs the encoding bitstream to the selector 946.

The HDD unit 944 records content data such as video or audio, various programs, or other data in an internal hard disk, and reads them from the corresponding hard disk at the time of reproduction.

The disk drive 945 performs recording and reproduction of the signal with respect to the mounted optical disk. Examples of the optimal disk include a DVD disk ((DVD-Video, DVD-RAM, DVD-R, DVD-RW, DVD+R, DVD+RW, or the like) or a Blu-ray disk.

At the time of recording video or audio, the selector 946 selects the encoding bitstream from the tuner 941 or the encoder 943, and supplies the encoding bitstream to the HDD unit 944 or the disk drive 945. Also, at the time of reproducing video or audio, the selector 946 supplies the decoder 947 with the encoding bitstream output from the HDD unit 944 or the disk drive 945.

The decoder 947 performs decoding processing on the encoding bitstream. The decoder 947 supplies the OSD unit 948 with the video data generated by performing the decoding processing. Also, the decoder 947 outputs the audio data generated by performing the decoding processing.

The OSD unit 948 generates the video data for displaying a menu screen such as item selection, and outputs the image data while superimposing it on the video data output from the decoder 947.

The user interface unit 950 is connected to the control unit 949. The user interface unit 950 includes an operating switch or a remote control signal receiving unit, and the like, and supplies the control unit 949 with an operation signal according to user manipulation.

The control unit 949 is configured using a CPU or a memory, and the like. The memory stores the program to be executed by the CPU, or various data required when the CPU performs processing. The program stored in the memory is read and executed by the CPU at a predetermined timing, such as the starting of the recording/reproducing apparatus 940. By executing the program, the CPU controls each unit such that the recording/reproducing apparatus 940 is operated according to the user manipulation.

In the recording/reproducing apparatus configured as above, the function of the encoding apparatus (encoding method) of the present invention is provided in the encoder 943. Therefore, it is possible to receive the image data of the multiview 3D image and encode the image data to improve the coding efficiency. Also, the function of the decoding apparatus (decoding method) of the present invention is provided to the decoder 947. Therefore, it is possible to decode and output the encoding bitstream of the multiview 3D image, which is encoded so as to improve the coding efficiency.

[Example of Configuration of Image Pickup Apparatus]

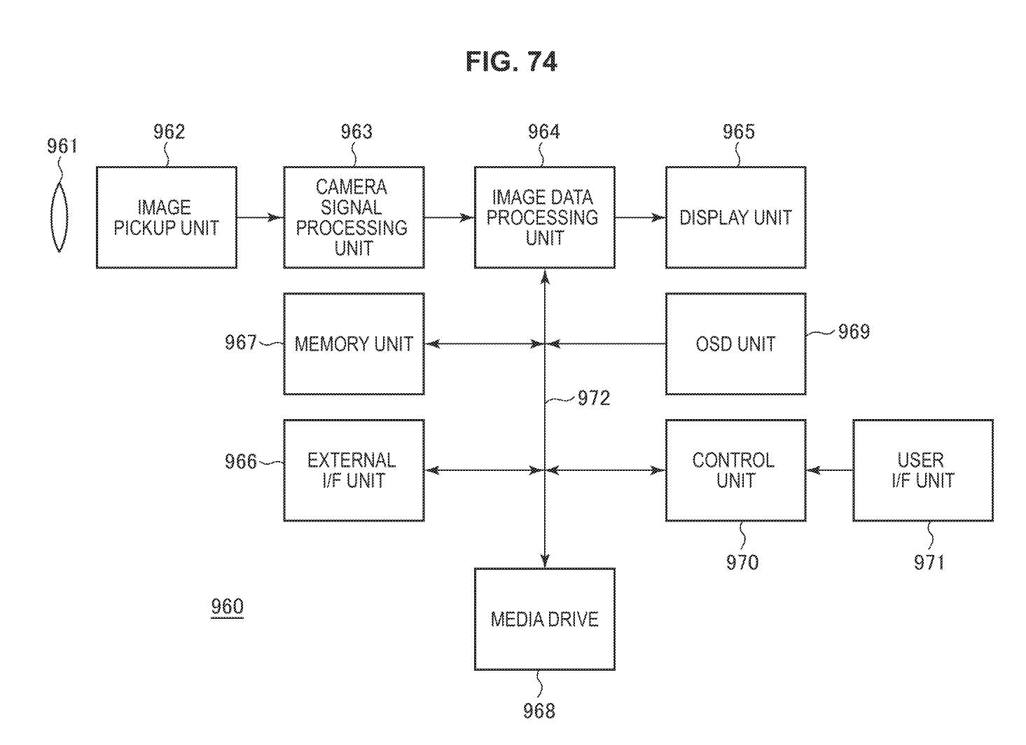

FIG. 74 illustrates a schematic configuration of an image pickup apparatus to which the present technology is applied. The image pickup apparatus 960 captures an object, displays the image of the object on a display unit, or records it in a recording medium as image data.

The image pickup apparatus 960 includes an optical block 961, an image pickup unit 962, a camera signal processing unit 963, an image data processing unit 964, a display unit 965, an external interface unit 966, a memory unit 967, a media drive 968, an OSD unit 969, and a control unit 970. Also, the user interface unit 971 is connected to the control unit 970. Furthermore, the image data processing unit 964, the external interface unit 966, the memory unit 967, the media drive 968, the OSD unit 969, and the control unit 970 are connected through a bus 972.

The optical block 961 is configured using a focus lens or an aperture mechanism. The optical block 961 forms an optical image of an object on an imaging plane of the image pickup unit 962. The image pickup unit 962 is configured using a CCD or CMOS image sensor, generates an electric signal according to an optical image by photoelectric conversion, and supplies the electric signal to the camera signal processing unit 963.

The camera signal processing unit 963 processes various camera signals, such as knee corrector, gamma correction, or color correction, with respect to the electric signal supplied from the image pickup unit 962. The camera signal processing unit 963 supplies the image data processing unit 964 with the image data, on which the camera signal processing is performed.

The image data processing unit 964 performs encoding processing on the image data supplied from the camera signal processing unit 963. The image data processing unit 964 supplies the external interface unit 966 or the media drive 968 with the encoding data generated by performing the encoding processing. Also, the image data processing unit 964 performs decoding processing on the encoding data supplied from the external interface unit 966 or the media drive 968. The image data processing unit 964 supplies the display unit 965 with the image data generated by performing the decoding processing. Also, the image data processing unit 964 supplies the display unit 965 with the image data supplied from the camera signal processing unit 963, or supplies the display unit 965 with the data for display, which is obtained from the OSD unit 969, while superimposing on the image data.

The OSD unit 969 generates data for display, such as menu screens or icons including symbols, characters, or figures, and outputs the data to the image data processing unit 964.

For example, the external interface unit 966 includes a USB input/output port, and is connected to a printer when printing an image. Also, if necessary, a drive is connected to the external interface unit 966, and a removable media such as a magnetic disk or an optical disk is appropriately mounted. Therefore, if necessary, a computer program read therefrom is installed. Furthermore, the external interface unit 966 includes a network interface to be connected to a predetermined network, such as a LAN or Internet. For example, the control unit 970 can read the encoding data from the memory unit 967 according to an instruction from the user interface unit 971, and supply it from the external interface unit 966 to other device connected through the network. Also, the control unit 970 can obtain encoding data or image data, which is supplied from other device through the network, through the external interface unit 966, and supply it to the image data processing unit 964.

As the recording media driven in the media drive 968, for example, any rewritable removable media, such as a magnetic disc, a magneto optical disc, or a semiconductor memory, is used. Also, the recording media may be any type of a removable media, a tape device, a disk, or a memory card. Of course, the media drive 968 may also be a contactless IC card or the like.

Also, the media drive 968 and the recording media may be integrated, and for example, may be configured by a non-portable recording medium such as an internal hard disk drive or a solid state drive (SSD).

The control unit 970 is configured using a CPU or a memory, and the like. The memory stores the program to be executed by the CPU, or various data required when the CPU performs processing. The program stored in the memory is read and executed by the CPU at a predetermined timing, such as the starting of the image pickup apparatus 960. By executing the program, the CPU controls each unit such the image pickup apparatus 960 is operated according to the user manipulation.

In the image pickup apparatus configured as above, the function of the encoding apparatus (encoding method) and the function of the decoding apparatus (decoding method) of the present invention are provided in the image data processing unit 964. Therefore, it is possible to encode the image data of the multiview 3D image captured by the image pickup unit 962 to improve the coding efficiency, or it is possible to decode the encoded encoding data recorded in the memory unit 967 or the recording media to improve the coding efficiency.

Also, the present technology can be applied to the encoding apparatus that encodes images related to color images other than depth images and color images, as well as the encoding apparatus that encodes color images and depth images.

Also, in this specification, the system refers to the entire apparatus configured by a plurality of apparatuses.

Furthermore, the embodiments of the present technology are not limited to the above-described embodiments, and various modifications can be made without departing from the scope of the present technology.

Additionally, the present technology may also be configured as below.

(1)

An encoding apparatus including:

a setting unit configured to perform setting in a manner that encoding parameter used when encoding a color image of a multiview 3D image and a depth image of the multiview 3D image is shared in the color image and the depth image; and

an encoding unit configured to encode the color image of the multiview 3D image and the depth image of the multiview 3D image by using the encoding parameter set by the setting unit.

(2)

The encoding apparatus according to (1), further including:

an intra-component multiplexing unit configured to generate an intra-component multiplexed image by multiplexing a chroma component of the color image and the depth image as a chroma component of one screen; and

an inter-component multiplexing unit configured to set a luma component of the color image as a luma component of an inter-component multiplexed image, set the intra-component multiplexed image as a chroma component of the inter-component multiplexed image, and generate the inter-component multiplexed image,

wherein the setting unit performs setting in a manner that the encoding parameter is shared in the chroma component and the luma component of the inter-component multiplexed image generated by the inter-component multiplexing unit, and

wherein the encoding unit encodes the inter-component multiplexed image generated by the inter-component multiplexing unit, by using the encoding parameter set by the setting unit.

(3)

The encoding apparatus according to (2), wherein a resolution of the luma component of the color image is equal to or greater than a resolution of the intra-component multiplexed image, and a resolution of the depth image after multiplexing is equal to or greater than a resolution of the chroma component of the color image after multiplexing.

(4)

The encoding apparatus according to (2) or (3), further including:

a pixel arrangement unit configured to arrange each pixel of the luma component of the color image in a manner that a position of each pixel of the luma component of the color image corresponds to a before-multiplexing position of each pixel of the intra-component multiplexed image,

wherein the inter-component multiplexing unit sets the luma component of the color image, in which each pixel is arranged by the pixel arrangement unit, as the luma component of the inter-component multiplexed image, and sets the intra-component multiplexed image as the chroma component of the inter-component multiplexed image.

(5)

The encoding apparatus according to any one of (2) to (4),

wherein the intra-component multiplexing unit performs multiplexing by arranging the chroma component of the color image in a half area of the intra-component multiplexed image, and arranging the depth image in another half area of the intra-component multiplexed image, and

wherein the encoding unit outputs position information indicating positions of chroma components of the color images inside the encoded inter-component multiplexed image and the intra-component multiplexed image, and pixel position information indicating a before-multiplexing position of each pixel of the chroma component of the color image included in the intra-component multiplexed image.

(6)

The encoding apparatus according to any one of (2) to (5),

wherein types of the chroma components are two types,

wherein the intra-component multiplexing unit generates a first intra-component multiplexed image by multiplexing a chroma component of one of the two types of chroma component of the color image and an image in the half area of the depth image as one type of chroma component of one screen, and generates a second intra-component multiplexed image by multiplexing another type of chroma component of the color image and an image in another half area of the depth image as the other type of chroma component of the one screen, and

wherein the inter-component multiplexing unit generates the inter-component multiplexed image by setting the luma component of the color image as the luma component of the inter-component multiplexed image and setting the first and second intra-component multiplexed images as the chroma component of the inter-component multiplexed image.

(7)

The encoding apparatus according to any one of (2) to (5),

wherein types of the chroma components are two types,

wherein the intra-component multiplexing unit generates a first intra-component multiplexed image by multiplexing a chroma component of one of the two types of chroma component of the color image and the depth image as one type of chroma component of one screen, and generates a second intra-component multiplexed image by multiplexing another type of chroma component of the color image and the depth image as the other type of chroma component of one screen, and

wherein the inter-component multiplexing unit generates the inter-component multiplexed image by setting the luma component of the color image as the luma component of the inter-component multiplexed image and setting the first and second intra-component multiplexed images as the chroma component of the inter-component multiplexed image.

(8)

The encoding apparatus according to any one of (2) to (7), wherein a resolution of the intra-component multiplexed image is equal to a resolution of the chroma component of the color image before multiplexing.

(9)

The encoding apparatus according to (1), further including:

an inter-component multiplexing unit configured to generate the inter-component multiplexed image by setting the chroma component and the luma component of the color image, and the depth image, respectively, as a chroma component, a luma component, and the depth component of the inter-component multiplexed image,

wherein the setting unit performs setting in a manner that the encoding parameter is shared in the chroma component and a depth component of the inter-component multiplexed image generated by the inter-component multiplexing unit, and

wherein the encoding unit encodes the inter-component multiplexed image generated by the inter-component multiplexing unit, by using the encoding parameter set by the setting unit.

(10)

The encoding apparatus according to (9),

wherein the setting unit performs setting in a manner that the encoding parameter is shared in the luma component, the chroma component and the depth component of the inter-component multiplexed image, and

wherein the encoding unit encodes the inter-component multiplexed image generated by the inter-component multiplexing unit, by using the encoding parameter set by the setting unit.

(11)

The encoding apparatus according to (1), further including:

a generation unit configured to generate a first unit including an encoding stream of the color image of the multiview 3D image, which is obtained as a result of encoding performed by the encoding unit, and information indicating a first type, and a second unit including an encoding stream of the depth image of the multiview 3D image, which is obtained as a result of encoding performed by the encoding unit, and information indicating a second type different from the first type.

(12)

The encoding apparatus according to (11), further including:

a transmission unit configured to transmit the first unit and the second unit generated by the generation unit,

wherein the setting unit performs setting in a manner that the encoding parameter is shared in the depth image and the luma component or the chroma component of the color image having a resolution identical with the depth image, and

wherein the transmission unit transmits resolution information indicating whether the resolution of the depth image is equal to a resolution of a luma component of the color image or is equal to a resolution of the chroma component of the color image.

(13)

The encoding apparatus according to any one of (1) to (12), wherein the encoding parameter is a prediction mode or a motion vector.

(14)

The encoding apparatus according to any one of (1) to (11), further including:

a transmission unit configured to transmit the encoding parameter set by the setting unit and an encoding stream generated as a result of encoding performed by the encoding unit.

(15)

The encoding apparatus according to (14), wherein the transmission unit transmits the encoding parameter set by the setting unit as a header of the encoding stream.

(16)

An encoding method for an encoding apparatus, including:

a setting step of performing setting in a manner that encoding parameter used when encoding a color image of a multiview 3D image and a depth image of the multiview 3D image are shared in the color image and the depth image; and

an encoding step of encoding the color image of the multiview 3D image and the depth image of the multiview 3D image by using the encoding parameter set in a process of the setting step.

(17)

A decoding apparatus including:

a reception unit configured to receive encoding parameter, which is set to be shared in a color image of a multiview 3D image and a depth image of the multiview 3D image, and is used when encoding the color image of the multiview 3D image and the depth image of the multiview 3D image, and an encoding stream in which the color image of the multiview 3D image and the depth image of the multiview 3D image are encoded; and

a decoding unit configured to decode the encoding stream received by the reception unit by using the encoding parameter received by the reception unit.

(18)

The decoding apparatus according to (17), further including:

a separation unit configured to separate the color image of the multiview 3D image obtained as a result of decoding performed by the decoding unit from the depth image of the multiview 3D image obtained as a result of decoding performed by the decoding unit,

wherein the encoding stream is obtained by encoding the inter-component multiplexed image generated by setting an intra-component multiplexed image, which is generated by multiplexing a chroma component of the color image and the depth image as a chroma component of one screen, as a chroma component of an inter-component multiplexed image, and setting a luma component of the color image as a luma component of the inter-component multiplexed image,

wherein the encoding parameter is set to be shared in a chroma component and a luma component of the inter-component multiplexed image, and

wherein the separation unit separates the luma component and the chroma component of the inter-component multiplexed image obtained as a result of decoding performed by the decoding unit, and separates the chroma component of the color image and the depth image from the chroma component of the inter-component multiplexed image.

(19)

The decoding apparatus according to (18), wherein a resolution of the luma component of the color image is equal to or greater than a resolution of the intra-component multiplexed image, and a resolution of the depth image after multiplexing is equal to or greater than a resolution of the chroma component of the color image after multiplexing.

(20)

The decoding apparatus according to (18) or (19), further including:

a pixel arrangement unit configured to arrange each pixel of the luma component of the inter-component multiplexed image separated by the separation unit,

wherein each pixel of the luma component of the inter-component multiplexed image is arranged in a manner that a position of each pixel corresponds to a before-multiplexing position of each pixel of the intra-component multiplexed image, and

wherein the separation unit arranges each pixel of the luma component of the inter-component multiplexed image in a manner that a position of each pixel of the luma component of the inter-component multiplexed image becomes a before-arrangement position.

(21)

The decoding apparatus according to any one of (18) to (20),

wherein the chroma component of the color image is arranged in a half area of the intra-component multiplexed image,

wherein the depth image is arranged in another half area of the intra-component multiplexed image, and

wherein the reception unit receives the encoding parameter, the encoding stream, position information indicating a position of the chroma component of the color image of the intra-component multiplexed image, and pixel position information indicating a before-multiplexing position of each pixel of the chroma component of the color image included in the intra-component multiplexed image.

(22)

The decoding apparatus according to any one of (18) to (21),

wherein types of the chroma components are two types, and

wherein the chroma component of the inter-component multiplexed image is a first intra-component multiplexed image obtained by multiplexing a chroma component of one of the two types of chroma component of the color image and an image in a half area of the depth image as one type of chroma component of one screen, and a second intra-component multiplexed image obtained by multiplexing another type of chroma component of the color image and an image in another half area of the depth image as the other type of chroma component of one screen.

(23)

The decoding apparatus according to any one of (18) to (21),

wherein types of the chroma components are two types, and

wherein the chroma component of the inter-component multiplexed image is a first intra-component multiplexed image obtained by multiplexing a chroma component of one of the two types of chroma component of the color image and the depth image as one type of chroma component of one screen, and a second intra-component multiplexed image obtained by multiplexing another type of chroma component of the color image and the depth image as the other type of chroma component of one screen.

(24)

The decoding apparatus according to any one of (18) to (23), wherein the resolution of the intra-component multiplexed image is equal to the resolution of the chroma component of the color image before multiplexing.

(25)

The decoding apparatus according to (17), further including:

a separation unit configured to separate the color image of the multiview 3D image obtained as a result of the decoding by the decoding unit, and the depth image of the multiview 3D image,

wherein the encoding stream is obtained by encoding the inter-component multiplexed image generated by setting a chroma component and a luma component of the color image and the depth image, respectively, as a chroma component, a luma component, and a depth component of the inter-component multiplexed image,

wherein the encoding parameter is set to be shared in the chroma component and the depth component of the inter-component multiplexed image, and

wherein the separation unit separates the luma component, the chroma component, and the depth component of the inter-component multiplexed image obtained as a result of decoding performed by the decoding unit, and generates the color image, which includes the luma component and the chroma component of the inter-component multiplexed image as a luma component and a chroma component, and the depth image, which includes the depth component of the inter-component multiplexed image.

(26)

The decoding apparatus according to (25), wherein the encoding parameter is set to be shared in the luma component, the chroma component, and the depth component of the inter-component multiplexed image.

(27)

The decoding apparatus according to (17), further including:

a separation unit configured to separate an encoding stream of the color image of the multiview 3D image and an encoding stream of the depth image of the multiview 3D image from the encoding stream received by the reception unit,

wherein the reception unit receives a first unit including the encoding parameter, the encoding stream of the color image of the multiview 3D image, and information indicating a first type, and a second unit including the encoding stream of the depth image of the multiview 3D image and information indicating a second type different from the first type,

wherein the separation unit separates the first unit, based on the information indicating the first type, and separates the second unit, based on the information indicating the second type, and

wherein the decoding unit decodes the encoding stream of the color image of the multiview 3D image, which is included in the first unit separated by the separation unit, by using the encoding parameter, and decodes the encoding stream of the depth image of the multiview 3D image, which is included in the second unit separated by the separation unit, by using the encoding parameter.

(28)

The decoding apparatus according to (17),

wherein the reception unit receives resolution information indicating whether a resolution of the depth image is equal to a resolution of a luma component of the color image or is equal to a resolution of a chroma component, and

wherein the decoding unit decodes the encoding stream of the depth image of the multiview 3D image among the encoding streams, by using the encoding parameter of a luma component or a chroma component of the color image having a resolution identical with the depth image, based on the resolution information received by the reception unit.

(29)

The decoding apparatus according to any one of (17) to (28), wherein the encoding parameter is a prediction mode or a motion vector.

(30)

The decoding apparatus according to any one of (17) to (29), wherein the reception unit receives the encoding parameter as a header of the encoding stream.

(31)

A decoding method for a decoding apparatus, including:

a receiving step of receiving encoding parameter, which is set to be shared in a color image of a multiview 3D image and a depth image of the multiview 3D image, and is used when encoding the color image of the multiview 3D image and the depth image of the multiview 3D image, and an encoding stream in which the color image of the multiview 3D image and the depth image of the multiview 3D image are encoded; and

a decoding step of decoding the encoding stream received in a process of the receiving step, by using the encoding parameter received in the process of the receiving step.

### REFERENCE SIGNS LIST

20 Encoding apparatus
22-1 to 22-N Image multiplexing unit
23 Multiview image encoding unit
35 Pixel arrangement processing unit
50 Decoding apparatus
51 Multiview image decoding unit
52-1 to 52-N Image separation unit
65 Pixel inverse-arrangement processing unit
380 Encoding apparatus
382 Generation unit
421 Intra-screen prediction unit
422 Motion compensation unit
470 Decoding apparatus
472-1 to 472-N Decoding unit
491 SPS decoding unit
493 Slice header decoding unit

1. An encoding apparatus comprising:
a setting unit configured to perform setting in a manner that encoding parameter used when encoding a color image of a multiview 3D image and a depth image of the multiview 3D image is shared in the color image and the depth image; and
an encoding unit configured to encode the color image of the multiview 3D image and the depth image of the multiview 3D image by using the encoding parameter set by the setting unit.

2. The encoding apparatus according to claim 1, further comprising:
an intra-component multiplexing unit configured to generate an intra-component multiplexed image by multiplexing a chroma component of the color image and the depth image as a chroma component of one screen; and
an inter-component multiplexing unit configured to set a luma component of the color image as a luma component of an inter-component multiplexed image, set the intra-component multiplexed image as a chroma component of the inter-component multiplexed image, and generate the inter-component multiplexed image,
wherein the setting unit performs setting in a manner that the encoding parameter is shared in the chroma component and the luma component of the inter-component multiplexed image generated by the inter-component multiplexing unit, and
wherein the encoding unit encodes the inter-component multiplexed image generated by the inter-component multiplexing unit, by using the encoding parameter set by the setting unit.

3. The encoding apparatus according to claim 2, wherein a resolution of the luma component of the color image is equal to or greater than a resolution of the intra-component multiplexed image, and a resolution of the depth image after multiplexing is equal to or greater than a resolution of the chroma component of the color image after multiplexing.

4. The encoding apparatus according to claim 3, further comprising:
a pixel arrangement unit configured to arrange each pixel of the luma component of the color image in a manner that a position of each pixel of the luma component of the color image corresponds to a before-multiplexing position of each pixel of the intra-component multiplexed image,
wherein the inter-component multiplexing unit sets the luma component of the color image, in which each pixel is arranged by the pixel arrangement unit, as the luma component of the inter-component multiplexed image, and sets the intra-component multiplexed image as the chroma component of the inter-component multiplexed image.

5. The encoding apparatus according to claim 3,
wherein the intra-component multiplexing unit performs multiplexing by arranging the chroma component of the color image in a half area of the intra-component multiplexed image, and arranging the depth image in another half area of the intra-component multiplexed image, and
wherein the encoding unit outputs position information indicating positions of chroma components of the color images inside the encoded inter-component multiplexed image and the intra-component multiplexed image, and pixel position information indicating a before-multiplexing position of each pixel of the chroma component of the color image included in the intra-component multiplexed image.

6. The encoding apparatus according to claim 3,
wherein types of the chroma components are two types,
wherein the intra-component multiplexing unit generates a first intra-component multiplexed image by multiplexing a chroma component of one of the two types of chroma component of the color image and an image in the half area of the depth image as one type of chroma component of one screen, and generates a second intra-component multiplexed image by multiplexing another type of chroma component of the color image and an image in another half area of the depth image as the other type of chroma component of the one screen, and
wherein the inter-component multiplexing unit generates the inter-component multiplexed image by setting the luma component of the color image as the luma component of the inter-component multiplexed image and setting the first and second intra-component multiplexed images as the chroma component of the inter-component multiplexed image.

7. The encoding apparatus according to claim 3,
wherein types of the chroma components are two types,
wherein the intra-component multiplexing unit generates a first intra-component multiplexed image by multiplexing a chroma component of one of the two types of chroma component of the color image and the depth image as one type of chroma component of one screen, and generates a second intra-component multiplexed image by multiplexing another type of chroma component of the color image and the depth image as the other type of chroma component of one screen, and
wherein the inter-component multiplexing unit generates the inter-component multiplexed image by setting the luma component of the color image as the luma component of the inter-component multiplexed image and setting the first and second intra-component multiplexed images as the chroma component of the inter-component multiplexed image.

8. The encoding apparatus according to claim 3, wherein a resolution of the intra-component multiplexed image is equal to a resolution of the chroma component of the color image before multiplexing.

9. The encoding apparatus according to claim 1, further comprising:
an inter-component multiplexing unit configured to generate the inter-component multiplexed image by setting the chroma component and the luma component of the color image, and the depth image, respectively, as a chroma component, a luma component, and the depth component of the inter-component multiplexed image,
wherein the setting unit performs setting in a manner that the encoding parameter is shared in the chroma component and a depth component of the inter-component multiplexed image generated by the inter-component multiplexing unit, and
wherein the encoding unit encodes the inter-component multiplexed image generated by the inter-component multiplexing unit, by using the encoding parameter set by the setting unit.

10. The encoding apparatus according to claim 9,
wherein the setting unit performs setting in a manner that the encoding parameter is shared in the luma component, the chroma component and the depth component of the inter-component multiplexed image, and
wherein the encoding unit encodes the inter-component multiplexed image generated by the inter-component multiplexing unit, by using the encoding parameter set by the setting unit.

11. The encoding apparatus according to claim 1, further comprising:
a generation unit configured to generate a first unit including an encoding stream of the color image of the multiview 3D image, which is obtained as a result of encoding performed by the encoding unit, and information indicating a first type, and a second unit including an encoding stream of the depth image of the multiview 3D image, which is obtained as a result of encoding performed by the encoding unit, and information indicating a second type different from the first type.

12. The encoding apparatus according to claim 11, further comprising:
a transmission unit configured to transmit the first unit and the second unit generated by the generation unit,
wherein the setting unit performs setting in a manner that the encoding parameter is shared in the depth image and the luma component or the chroma component of the color image having a resolution identical with the depth image, and
wherein the transmission unit transmits resolution information indicating whether the resolution of the depth image is equal to a resolution of a luma component of the color image or is equal to a resolution of the chroma component of the color image.

13. The encoding apparatus according to claim 1, wherein the encoding parameter is a prediction mode or a motion vector.

14. The encoding apparatus according to claim 1, further comprising:
a transmission unit configured to transmit the encoding parameter set by the setting unit and an encoding stream generated as a result of encoding performed by the encoding unit.

15. The encoding apparatus according to claim 14, wherein the transmission unit transmits the encoding parameter set by the setting unit as a header of the encoding stream.

16. An encoding method for an encoding apparatus, comprising:
a setting step of performing setting in a manner that encoding parameter used when encoding a color image of a multiview 3D image and a depth image of the multiview 3D image are shared in the color image and the depth image; and
an encoding step of encoding the color image of the multiview 3D image and the depth image of the multiview 3D image by using the encoding parameter set in a process of the setting step.

17. A decoding apparatus comprising:
a reception unit configured to receive encoding parameter, which is set to be shared in a color image of a multiview 3D image and a depth image of the multiview 3D image, and is used when encoding the color image of the multiview 3D image and the depth image of the multiview 3D image, and an encoding stream in which the color image of the multiview 3D image and the depth image of the multiview 3D image are encoded; and
a decoding unit configured to decode the encoding stream received by the reception unit by using the encoding parameter received by the reception unit.

18. The decoding apparatus according to claim 17, further comprising:
a separation unit configured to separate the color image of the multiview 3D image obtained as a result of decoding performed by the decoding unit from the depth image of the multiview 3D image obtained as a result of decoding performed by the decoding unit,
wherein the encoding stream is obtained by encoding the inter-component multiplexed image generated by setting an intra-component multiplexed image, which is generated by multiplexing a chroma component of the color image and the depth image as a chroma component of one screen, as a chroma component of an inter-component multiplexed image, and setting a luma component of the color image as a luma component of the inter-component multiplexed image,
wherein the encoding parameter is set to be shared in a chroma component and a luma component of the inter-component multiplexed image, and
wherein the separation unit separates the luma component and the chroma component of the inter-component multiplexed image obtained as a result of decoding performed by the decoding unit, and separates the chroma component of the color image and the depth image from the chroma component of the inter-component multiplexed image.

19. The decoding apparatus according to claim 18, wherein a resolution of the luma component of the color image is equal to or greater than a resolution of the intra-component multiplexed image, and a resolution of the depth image after multiplexing is equal to or greater than a resolution of the chroma component of the color image after multiplexing.

20. The decoding apparatus according to claim 19, further comprising:
a pixel arrangement unit configured to arrange each pixel of the luma component of the inter-component multiplexed image separated by the separation unit,
wherein each pixel of the luma component of the inter-component multiplexed image is arranged in a manner that a position of each pixel corresponds to a before-multiplexing position of each pixel of the intra-component multiplexed image, and
wherein the separation unit arranges each pixel of the luma component of the inter-component multiplexed image in a manner that a position of each pixel of the luma component of the inter-component multiplexed image becomes a before-arrangement position.

21. The decoding apparatus according to claim 19,
wherein the chroma component of the color image is arranged in a half area of the intra-component multiplexed image,
wherein the depth image is arranged in another half area of the intra-component multiplexed image, and
wherein the reception unit receives the encoding parameter, the encoding stream, position information indicating a position of the chroma component of the color image of the intra-component multiplexed image, and pixel position information indicating a before-multiplexing position of each pixel of the chroma component of the color image included in the intra-component multiplexed image.

22. The decoding apparatus according to claim 19,
wherein types of the chroma components are two types, and
wherein the chroma component of the inter-component multiplexed image is a first intra-component multiplexed image obtained by multiplexing a chroma component of one of the two types of chroma component of the color image and an image in a half area of the depth image as one type of chroma component of one screen, and a second intra-component multiplexed image obtained by multiplexing another type of chroma component of the color image and an image in another half area of the depth image as the other type of chroma component of one screen.

23. The decoding apparatus according to claim 19,
wherein types of the chroma components are two types, and
wherein the chroma component of the inter-component multiplexed image is a first intra-component multiplexed image obtained by multiplexing a chroma component of one of the two types of chroma component of the color image and the depth image as one type of chroma component of one screen, and a second intra-component multiplexed image obtained by multiplexing another type of chroma component of the color image and the depth image as the other type of chroma component of one screen.

24. The decoding apparatus according to claim 19, wherein the resolution of the intra-component multiplexed image is equal to the resolution of the chroma component of the color image before multiplexing.

25. The decoding apparatus according to claim 17, further comprising:
a separation unit configured to separate the color image of the multiview 3D image obtained as a result of the decoding by the decoding unit, and the depth image of the multiview 3D image,
wherein the encoding stream is obtained by encoding the inter-component multiplexed image generated by setting a chroma component and a luma component of the color image and the depth image, respectively, as a chroma component, a luma component, and a depth component of the inter-component multiplexed image,
wherein the encoding parameter is set to be shared in the chroma component and the depth component of the inter-component multiplexed image, and
wherein the separation unit separates the luma component, the chroma component, and the depth component of the inter-component multiplexed image obtained as a result of decoding performed by the decoding unit, and generates the color image, which includes the luma component and the chroma component of the inter-component multiplexed image as a luma component and a chroma component, and the depth image, which includes the depth component of the inter-component multiplexed image.

26. The decoding apparatus according to claim 25, wherein the encoding parameter is set to be shared in the luma component, the chroma component, and the depth component of the inter-component multiplexed image.

27. The decoding apparatus according to claim 17, further comprising:
a separation unit configured to separate an encoding stream of the color image of the multiview 3D image and an encoding stream of the depth image of the multiview 3D image from the encoding stream received by the reception unit,
wherein the reception unit receives a first unit including the encoding parameter, the encoding stream of the color image of the multiview 3D image, and information indicating a first type, and a second unit including the encoding stream of the depth image of the multiview 3D image and information indicating a second type different from the first type,
wherein the separation unit separates the first unit, based on the information indicating the first type, and separates the second unit, based on the information indicating the second type, and
wherein the decoding unit decodes the encoding stream of the color image of the multiview 3D image, which is included in the first unit separated by the separation unit, by using the encoding parameter, and decodes the encoding stream of the depth image of the multiview 3D image, which is included in the second unit separated by the separation unit, by using the encoding parameter.

28. The decoding apparatus according to claim 17,
wherein the reception unit receives resolution information indicating whether a resolution of the depth image is equal to a resolution of a luma component of the color image or is equal to a resolution of a chroma component, and
wherein the decoding unit decodes the encoding stream of the depth image of the multiview 3D image among the encoding streams, by using the encoding parameter of a luma component or a chroma component of the color image having a resolution identical with the depth image, based on the resolution information received by the reception unit.

29. The decoding apparatus according to claim 17, wherein the encoding parameter is a prediction mode or a motion vector.

30. The decoding apparatus according to claim 17, wherein the reception unit receives the encoding parameter as a header of the encoding stream.

31. A decoding method for a decoding apparatus, comprising:
a receiving step of receiving encoding parameter, which is set to be shared in a color image of a multiview 3D image and a depth image of the multiview 3D image, and is used when encoding the color image of the multiview 3D image and the depth image of the multiview 3D image, and an encoding stream in which the color image of the multiview 3D image and the depth image of the multiview 3D image are encoded; and
a decoding step of decoding the encoding stream received in a process of the receiving step, by using the encoding parameter received in the process of the receiving step.
